(19) United States
(12) Patent Application Publication
(10) Pub. No.: US 2015/0353732 A1
(43) Pub. Date: Dec. 10, 2015

(54) IMPACT IMPROVED FILLED POLYCARBONATE OR POLYESTER COMPOSITIONS

(71) Applicant: SABIC Global Technologies B.V., Bergen op Zoom (NL)

(72) Inventor: Huanbing Wang, Shanghai (CN)

(21) Appl. No.: 14/299,817

(22) Filed: Jun. 9, 2014

(51) Int. Cl. C08L 83/04; C08L 67/02; C08L 69/00

(52) U.S. Cl. CPC C08L 83/04; C08L 69/00; C08L 67/02

(57) ABSTRACT

In various aspects, the disclosure relates to blended polymer compositions (e.g., polycarbonate, polycarbonate-polysiloxane copolymer, polyester compositions, etc.) comprising a polycarbonate component, a polyester component, or both; optional impact modifier(s); optional flame retardant; copolymer compatibilizer; and filler. The presence of the polymer compatibilizer improves the impact performance of the polymer blend.

### BACKGROUND

Polycarbonate materials have garnered significant commercial interest typically for their temperature resistance, durability, and impact performance. Often these materials are blended with other polymers which function as impact modifiers, such as acrylonitrile-butadiene-styrene (ABS) or methacrylate-butadiene-styrene (MBS) or another acrylic polymer to produce a more resilient polycarbonate material. Fillers may also be added to enhance the stiffness and produce a high modulus or tough material. Flame retardant additives are also incorporated to improve the fire resistance of the material. Unfortunately, the addition of fillers and flame retardants to polycarbonate blends which feature impact modifiers tends to deteriorate the impact performance of these polycarbonate blends. Polyesters blends, such as polyethylene terephthalate (“PET”), polybutylene terephthalate (“PBT”) blends, or their blends with polycarbonate also face the same challenges.

These and other shortcomings are addressed by the present disclosure.

### SUMMARY

The present disclosure, in an aspect, provides filled polycarbonate blends, polyesters blends, or polycarbonate and polyesters blends compositions which can include impact modifiers and flame retardant additives and further comprise polymer compatibilizers. As an example, provided are polycarbonate blends, polyesters blends, or polycarbonate and polyesters blends that maintain fire resistance and high modulus without diminished impact performance or even with improved impact performance, so-called FR (“fire resistant”) or non-FR high modulus ductile (HMD) materials.

This disclosure, in one aspect, relates to polymer blend compositions comprising: (a) from about 0.1 wt. % to about 90 wt. % of a polycarbonate or from about 0.1 wt. % to about 90 wt. % of a polyester, or a combination of both polycarbonate and polyester polymers within these limits; (b) optional flame retardant(s) from about 0 wt. % to about 25 wt.; (c) filler(s) (e.g., inorganic filler(s)) from about 2 wt. % to about 50 wt. %; (d) optional impact modifier(s) from about 0 wt. % to about 25 wt. %; and (e) a polymer is compatibilizer polymer from about 0.5 wt. % to about 8 wt. %; wherein the combined weight percent of components (a) through (e) does not exceed 100 wt. %, and wherein all weight percent values are based on the total weight of the blended polycarbonate and/or polyesters composition comprises exhibits an impact performance measured at 23° C. measured accordingly to notched Izod impact (NII) that is greater than that of an identical reference blended polycarbonate and/or polyesters composition in the absence of the polymer compatibilizer. In an aspect, unnotched Izod impact and tensile elongation at break value of the composition with compatibilizer can be greater than the composition in the absence of polymer compatibilizer.

In another aspect, polymer blend compositions can comprise: (a) from about 0.1 wt. % to about 90 wt. % of a polycarbonate/polyester blend or from about 0.1 wt. % to about 90 wt. % of a polyester, or a combination of both polycarbonate and polyester polymers within these limits; (b) optional flame retardant(s) and its synergist from about 0 wt. % to about 25 wt. %; (c) inorganic filler(s) from about 2 wt. % to about 50 wt. %; (d) acrylic impact modifier(s) from about 0 wt. % to about 25 wt. %; and (e) a polymer compatibilizer from about 0.5 wt. % to about 8 wt. %; wherein the combined weight percent of components (a) through (e) does not exceed 100 wt. %, and wherein all weight percent values are based on the total weight of the polymer blend composition

Also disclosed are methods of forming the disclosed polymer blend compositions. The method can comprise: (a) mixing (i) a polymer compatibilizer in an amount in the range from about 0.5 wt. % to about 8 wt. %; (ii) the impact modifier in an amount in the range from about 0 wt. % to about 25 wt. %; (iii) polycarbonate in a range from about 0.1 wt. % to 90 wt. % or a polyester in a range of from about 0.1 wt. % to about 90 wt. % of, or a combination of both; (iv) inorganic filler in a range from about 2 wt. % to about 50 wt. %; and (v) other additives in a range from about 0 wt. % to 15 wt. %; (b) compounding the resulting mixture through a twin screw at 250° C. (e.g., between about 230° C. and about 350° C.) and (d) feeding the flame retardant in the front or middle zone of the twin screw mixer to form a polymer blend composition wherein a sample of the blended polymer composition has flame resistance and impact performance, exhibited by mechanical properties, compared to a substantially identical reference composition in the absence polymer compatibilizer.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

The present disclosure can be understood more readily by reference to the following detailed description of the disclosure and the Examples included therein. However, before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are necessarily to be limited to a specific order, it is no way intended that an order be inferred, in any respect. Having said this, the presentation of steps in a given order may be considered to represent one aspect or embodiment of such a method. This holds for any possible non-express basis for interpretation, including: matters of logic with respect to arrangement of steps or operational flow; plain meaning derived from grammatical organization or punctuation; and the number or type of embodiments described in the specification.

### DEFINITIONS

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

As used herein, the term “effective amount” refers to an amount that is sufficient to achieve the desired modification of a physical property of the composition or material. For example, an “effective amount” of a filler refers to an amount that is sufficient to achieve the desired improvement in the property modulated by the formulation component, e.g. achieving the desired level of modulus. The specific level in terms of wt. % in a composition required as an effective amount will depend upon a variety of factors including the amount and type of polycarbonate, amount and type of polycarbonate, amount and type of thermally conductive filler, and end use of the article made using the composition.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt. %,” and “wt. %” of a component, which can be used interchangeably, unless specifically stated to the contrary, are based on the total weight of the formulation or composition in which the component is included. For example if a particular element or component in a composition or article is said to have 8% by weight, it is understood that this percentage is relative to a total compositional percentage of 100% by weight.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

The term “alkyl group” as used herein is a branched or unbranched saturated hydrocarbon group of 1 to 24 carbon atoms, such as methyl, ethyl, n propyl, isopropyl, n butyl, isobutyl, t butyl, pentyl, hexyl, heptyl, octyl, decyl, tetradecyl, hexadecyl, eicosyl, tetracosyl and the like. A “lower alkyl” group is an alkyl group containing from one to six carbon atoms.

The term “aryl group” as used herein is any carbon-based aromatic group including, but not limited to, benzene, naphthalene, etc. The term “aromatic” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy.

The term “aralkyl” as used herein is an aryl group having an alkyl, alkynyl, or alkenyl group as defined above attached to the aromatic group. An example of an aralkyl group is a benzyl group.

The term “carbonate group” as used herein is represented by the formula OC(O)OR, where R can be hydrogen, an alkyl, alkenyl, alkynyl, aryl, aralkyl, cycloalkyl, halogenated alkyl, or heterocycloalkyl group described above. The term “ester group” as used herein is represented by —OC(O)R (or OC(O)R), where R can be hydrogen, an alkyl, alkenyl, alkynyl, aryl, aralkyl, cycloalkyl, halogenated alkyl, or heterocycloalkyl group described above.

The term “carboxylic acid” as used herein is represented by the formula —C(O)OH

The term “aldehyde” as used herein is represented by the formula —C(O)H

The term “keto group” as used herein is represented by the formula —C(O)R, where R is an alkyl, alkenyl, alkynyl, aryl, aralkyl, cycloalkyl, halogenated alkyl, or heterocycloalkyl group described above.

The term “carbonyl group” as used herein is represented by the formula C═O

As used herein, the terms “number average molecular weight” or “Mₙ” can be used interchangeably, and refer to the statistical average molecular weight of all the polymer chains in the sample and is defined by the formula:

$${M}_{n} = \frac{Σ {N}_{i} {M}_{i}}{Σ {N}_{i}} ,$$

where Mᵢ is the molecular weight of a chain and Nᵢ is the number of chains of that molecular weight. Mₙ can be determined for polymers, e.g. polycarbonate polymers, by methods well known to a person having ordinary skill in the art using molecular weight standards, e.g. polycarbonate standards or polystyrene standards, preferably certified or traceable molecular weight standards.

As used herein, the terms “weight average molecular weight” or “Mw” can be used interchangeably, and are defined by the formula:

$${M}_{w} = \frac{Σ {N}_{i} {M}_{i}^{2}}{Σ {N}_{i} {M}_{i}} ,$$

where Mᵢ is the molecular weight of a chain and Nᵢ is the number of chains of that molecular weight. Compared to Mₙ, M_{w} takes into account the molecular weight of a given chain in determining contributions to the molecular weight average. Thus, the greater the molecular weight of a given chain, the more the chain contributes to the M_{w}. M_{w} can be determined for polymers, e.g. polycarbonate polymers, by methods well known to a person having ordinary skill in the art using molecular weight standards, e.g. polycarbonate standards or polystyrene standards, preferably certified or traceable molecular weight standards.

As used herein, the terms “polydispersity index” or “PDI” can be used interchangeably, and are defined by the formula:

$$PDI = \frac{{M}_{w}}{{M}_{n}} .$$

The PDI has a value equal to or greater than 1, but as the polymer chains approach uniform chain length, the PDI approaches unity.

As used herein, the terms “mean” or “statistical mean”, can be used interchangeably, and are defined by the formula:

$$\overline{x} = \frac{1}{n} \cdot {\sum }_{i = 1}^{n} {x}_{i} ,$$

wherein xᵢ is the measured value, and n is the number of values.

As used herein, the term “variance” refers to a numerical value that is used to indicate how widely the measured values in a group vary, and is defined by the formula:

$${σ}^{2} = \frac{Σ ( {x}_{i} - {x}_{i}^{2}}{n} ,$$

wherein σ² is a variance, xᵢ is the measured value, x̅ is the mean value, and n is the number of values.

The index “n” as used herein in connection with polymer structures, refers to a number of repeating units in a polymer composition. According to aspects, the value of “n” can be any integer greater than 1

The terms “BisA” or “bisphenol A,” which can be used interchangeably, as used herein refers to a compound having a structure represented by the formula:

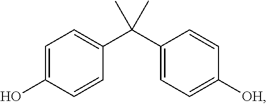 [SMILES: CC(C)(c1ccc(O)cc1)c1ccc(O)cc1]

BisA can also be referred to by the name 4,4′-(propane-2,2-diyl)diphenol; p,p′-isopropylidenebisphenol; or 2,2-bis(4-hydroxyphenyl)propane. BisA has the CAS #80-05-7.

As used herein, “polycarbonate” refers to an oligomer or polymer comprising residues of one or more dihydroxy compounds, e.g. dihydroxy aromatic compounds, joined by carbonate linkages; it also encompasses homopolycarbonates, copolycarbonates, and (co)polyester carbonates.

As used herein, the terms “PC-PS,” “polycarbonate-siloxane copolymer,” “poly(carbonate-siloxane) copolymer,” and “polycarbonate-polysiloxane copolymer,” which can be used interchangeably, refer to a copolymer comprising repeating carbonate and siloxane units. The terms are inclusive of block copolymers having polysiloxane and polycarbonate blocks.

Representative polyesters include, for example including polyethylene terephthalate (“PET”), polybutylene terephthalate (“PBT”), polyethylene naphthalate (PEN), polytrimethylene terephthalate (PTT), poly(1,4-cyclohexanedimethyl-1,4-cyclohexanedicarboxylate) (PCCD), copolymers of TPA, EG, and a secondary diol, cyclohexanedimethanol (e.g., PCTG and PETG), and TRITAN™ copolyesters.

The term “PET” refers to poly(ethylene terephthalate). As used herein the terms “poly(ethylene terephthalate)” and “PET” include PET homopolymers, PET copolymers and PETG. As used herein the term PET copolymer refers to PET that has been modified by up to 10 mole percent with one or more added co-monomers. For example the term PET copolymer includes PET modified with up to 10 mole percent isophthalic acid on a 100 mole percent carboxylic acid basis. In another example the term PET copolymer includes PET modified with up to 10 mole percent 1,4 cyclohexane dimethanol (CHDM) on a 100 mole percent diol basis. As used herein the term PETG refers to PET modified with 10 to 50 percent CHDM on a 100 mole percent diol basis. The term “PCTG” refers to PET modified with 50 to 95 percent CHDM on a 100 mole percent diol basis.

The term “PBT” is used herein to mean a crystallizable poly(alkylene terephthalate), i.e. a polyester of terephthalic acid and butanediol, or prepared by transesterification.

The term “talc” is used herein to mean a mineral composed of hydrated magnesium silicate. The term “surface treated talc” (or “surface modified talc” or “coated talc”) is used herein to mean particles of talc, whose surface has been fully or partially, physically or chemically, modified using a surface treating agent. Such agents can be of organic or inorganic nature. These agents can include fatty acids, fatty acid esters, silicones, Teflon, silanes, silane coupling agents, metal salts of fatty acid, or polyethylene glycol.

The term “impact modifier” as used herein refers to a component of the disclosed thermoplastic compositions wherein the impact modifier is a polymeric material effective in improving the impact properties of the disclosed thermoplastic compositions, e.g. the notched Izod impact strength of the composition. As used herein, an impact modifier can be a one or more polymers such as acrylonitrile-butadiene-styrene copolymer (ABS), methacrylate butadiene styrene copolymer (MBS), and/or bulk polymerized ABS (BABS)

The term “ABS” or “acrylonitrile-butadiene-styrene copolymer” as used herein refers to an acrylonitrile-butadiene-styrene polymer which can be an acrylonitrile-butadiene-styrene terpolymer or a blend of styrene-butadiene rubber and styrene-acrylonitrile copolymer.

As used herein, “compatibilizer” refers to an additive used to improve the miscibility of copolymers or to improve the miscibility between polymers or polymer phase and fillers. As used herein, a compatibilizer may be one or more polymers or copolymers such as a maleic anhydride grafting polyethylene copolymer or glycidyl grafting polyethylene copolymer.

As used herein, the term “blended polycarbonate composition” refers to a polycarbonate composition comprising a polycarbonate or polycarbonate/polyester blend component; an impact modifier or copolymer component, a flame retardant component, and a filler component. The blended polycarbonate composition may also include a compatibilizer component or additional additives. As used herein, the term “blended polyester composition” refers to a polyester composition comprising a polyester or polyester/polycarbonate blend component; an impact modifier or copolymer component, a flame retardant component, and a filler component. The blended polyester composition may also include a compatibilizer component or additional additives.

The terms “residues” and “structural units”, used in reference to the constituents of the polymers, are synonymous throughout the specification.

As used herein, the term “identical reference blended polycarbonate composition” refers to a composition that is identical to the inventive composition by comprising essentially the same proportions and components as the inventive composition but in the absence of a stated component.

As used herein, the term “substantially identical reference composition” refers to a composition that is substantially identical to the inventive composition by consisting essentially of substantially the same proportions and components but in the absence of a stated component. For example and without limitation, in some aspects of the disclosure, for purposes of comparison to a corresponding reference composition, as used herein, corresponding reference composition consists essentially of the same component materials in the same component amounts as the inventive composition but for the absence of the mold release composition

As used herein, the term “mechanical and physical properties” refers to any properties that describe desired polymer performance in rest and under stress. In one aspect, mechanical and physical properties can include without limitation density, toughness, viscoelasticity, impact properties, and modulus. In another aspect, the mechanical and physical properties can be defined by any standard test known to one of ordinary skills in the art. In one aspect standard tests can include but are not limited to measurements of heat deflection temperature (HDT), notched and unnotched Izod impact (NII, UII), ductility, flexural capabilities (modulus and strength), melt volume rate (MVR), ejection forces, toughness, elongation and the like.

As used herein, the term “impact performance” refers to the strength, toughness, rigidity, thermal and dimensional stability on impact of the polycarbonate material or resin.

As used herein, flame retardance (FR) can be characterized by any conventionally accepted standard or testing method. However, in an aspect, flame retardance as referred to herein is characterized by the Underwriter's Laboratories UL-94 test. This standard classifies plastics according to how they burn in various orientations and thicknesses. From lowest (least flame-retardant) to highest (most flame-retardant), the classifications are: HB: slow burning on a horizontal specimen; burning rate less than 76 mm/min for thickness less than 3 mm; V2: burning stops within 30 seconds on a vertical specimen; drips of flaming particles are allowed; V1: burning stops within 30 seconds on a vertical specimen; drips of particles allowed as long as they are not inflamed; and V0: burning stops within 10 seconds on a vertical specimen; drips of particles allowed as long as they are not inflamed. In a preferred aspect of the present disclosure, the flame retardant blended polycarbonate compositions of the present disclosure are characterized by the above-described UL-94 test as passing or satisfying the V0 standard.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### Blended Polycarbonate/Polyester Compositions

As briefly described above, the present disclosure generally relates to a blended polycarbonate composition, a blended polyester composition, or a polycarbonate/polyester blend composition, a flame retardant, inorganic filler, impact modifiers, and a polymer compatibilizers. Conventionally, the addition of flame retardant to filled polycarbonate and/or polyester blends results in deterioration of impact performance as evidenced a decrease in notched or unnotched Izod when compared to a similar composition comprising a virgin plastic component. Higher filler loading, typically above 15 wt. %, and flame retardant loading, is particularly susceptible to loss of impact performance. To combat this, impact modifier is loaded high as well. The present disclosure provides for increased impact performance of polycarbonate and/or polyester resins through the addition of a polymer compatibilizer rather than through higher impact modifier loading.

As described more fully below, the incorporation of a compatibilizer in a polycarbonate and/or polyester blend comprising flame retardant, inorganic filler, and acrylic impact modifiers has been found to reduce or even prevent the deterioration impact performance of such blended thermoplastic compositions comprising these components. Accordingly, aspects of the present disclosure generally provide a polycarbonate, a polyester, or polycarbonate/polyester blend; a flame retardant; inorganic filler; impact modifiers, a polymer compatibilizer, and other additives wherein the thermoplastic polymer blend composition demonstrates an increased notched Izod impact and unnotched Izod impact at 23° C. that that of an identical blended polycarbonate composition in the absence of the polymer compatibilizer.

In one aspect, the disclosed disclosure relates to polymer blend compositions comprising: (a) from about 0.1 wt. % to about 90 wt. % polycarbonate component or from about 0.1 wt. % to about 90 wt. % of a polyester, or a combination of both polycarbonate and polyester polymers within these limits; (b) from 0 wt. % to about 20 wt. % of the optional flame retardant component; (c) from about 2 wt. % to about 50 wt. % filler(s), preferably inorganic filler(s) (d) from about 0 wt. % to about 25 wt. % impact modifier(s); and (e) from about 0.5 wt. % to about 8 wt. % maleic anhydride or glycidyl compatibilizer; (f) from greater than 0 wt. % to about 15 wt. % other additives wherein the combined weight percent value of all components does not exceed about 100 wt. %; and wherein all weight percent values are based on the total weight of the composition.

In various aspects, molded samples may comprise the disclosed blended polycarbonate compositions. In a further aspect, the molded sample comprising the blended thermoplastic composition has a notched Izod impact strength greater than or equal to about 436 J/m at 23° C. when tested in accordance with ASTM D256. In a still further aspect, the molded sample comprising the blended polycarbonate composition has a notched Izod impact strength greater than or equal to about 60 J/m when tested in accordance with ASTM D256. In yet a further aspect, the molded sample comprising the blended polycarbonate composition has a notched Izod impact strength of from about 60 J/m to about 400 J/m when tested in accordance with ASTM D256. In an even further aspect, the molded sample comprising the blended polycarbonate composition has a notched Izod impact strength of from about 60 J/m to about 200 J/m when tested in accordance with ASTM D256. In a still further aspect, the molded sample comprising the blended polycarbonate composition has a notched Izod impact strength of from about 60 J/m to about 170 J/m when tested in accordance with ASTM D256. In yet a further aspect, the molded sample comprising the blended polycarbonate composition has a notched Izod impact strength of from about 60 J/m to about 150 J/m when tested in accordance with ASTM D256.

In one aspect, the blended polycarbonate composition exhibits a notched Izod impact that is greater than at least 5% that of an identical reference polymer blend composition formed in the absence of the copolymer compatibilizer. In another aspect a notched Izod impact of the molded article from the disclosed composition is greater than at least 10%, including exemplarily values that are greater than at least 20%, 30%, 40%, 50%, 60%, 70%, 80%, 90%, 100%, 110%, 120%, 130%, 140%, 150%, 160%, 170%, 180%, 190%, or at least 200% that of an identical reference polymer blend composition formed in the absence of the copolymer compatibilizer.

### Polyester Polymer Component

As described, according to aspects, various polyesters can be used as polyester polymer component. As an exmapel, polyesters that are obtained by polymerizing bifunctional carboxylic acids and diol ingredients can be used.

Polyester resins can include crystalline polyester resins such as polyester resins derived from at least one diol, and at least one dicarboxylic acid. Preferred polyesters have repeating units according to structural formula (A)

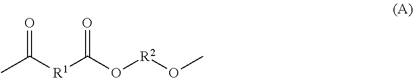

wherein, R1 and R2 are independently at each occurrence a aliphatic, aromatic and cycloaliphatic radical. In one embodiment R2 is an alkyl radical compromising a dehydroxylated residue derived from an aliphatic or cycloaliphatic diol, or mixtures thereof, containing from 2 to about 20 carbon atoms and R1 is an aromatic radical comprising a decarboxylated residue derived from an aromatic dicarboxylic acid. The polyester is a condensation product where R2 is the residue of an aromatic, aliphatic or cycloaliphatic radical containing diol having C1 to C30 carbon atoms or chemical equivalent thereof, and R1 is the decarboxylated residue derived from an aromatic, aliphatic or cycloaliphatic radical containing diacid of C1 to C30 carbon atoms or chemical equivalent thereof. The polyester resins are typically obtained through the condensation or ester interchange polymerization of the diol or diol equivalent component with the diacid or diacid chemical equivalent component.

Aromatic dicarboxylic acids, for example, terephthalic acid, isophthalic acid, naphthalene dicarboxylic acid and the like, can be used as these bifunctional carboxylic acids, and mixtures of these can be used as needed. Among these, terephthalic acid is particularly preferred from the standpoint of cost. Also, to the extent that the effects of this invention are not lost, other bifunctional carboxylic acids such as aliphatic dicarboxylic acids such as oxalic acid, malonic acid, adipic acid, suberic acid, azelaic acid, sebacic acid, decane dicarboxylic acid, and cyclohexane dicarboxylic acid; and their ester-modified derivatives can also be used.

As diol ingredients the commonly used ones can be used without difficulty, for example, straight chain aliphatic and cycloaliphatic diols having 2 to 15 carbon atoms, for example, ethylene glycol, propylene glycol, 1,4-butanediol, trimethylene glycol, tetramethylene glycol, neopentyl glycol, diethylene glycol, cyclohexane dimethanol, heptane-1,7-diol, octane-1,8-diol, neopentyl glycol, decane-1,10-diol, etc.; polyethylene glycol; bivalent phenols such as dihydroxydiarylalkanes such as 2,2-bis(4-hydroxylphenyl)propane that can be called bisphenol-A, bis(4-hydroxyphenyl) methane, bis(4-hydroxyphenyl)naphthylmethane, bis(4-hydroxyphenyl)phenylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1-bis(4-hydroxyphenyl)ethane, 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3-chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, 1,10-bis(4-hydroxyphenyl)decane, 1,1-bis(4-hydroxyphenyl)-3,3,5-trimethylcyclohexane, and 2,2-bis(4-hydroxyphenyl)-1,1,1,3,3,3-hexafluoropropane; dihyroxydiarylcycloalkanes such as 1,1-bis(4-hydroxyphenyl)cyclohexane, 1,1-bis(3,5-dichloro-4-hydroxyphenyl)cyclohexane, and 1,1-bis(4-hydroxyphenyl)cyclodecane; dihydroxydiarylsulfones such as bis(4-hydroxyphenyl)sulfone, and bis(3,5-dimethyl-4-hydroxyphenyl)sulfone, bis(3-chloro-4-hydroxyphenyl)sulfone; dihydroxydiarylethers such as bis(4-hydroxyphenyl)ether, and bis(3-5-dimethyl-4-hydroxyphenyl)ether; dihydroxydiaryl ketones such as 4,4′-dihydroxybenzophenone, and 3,3′,5,5′-tetramethyl-4,4-diydroxybenzophenone; dihydroxydiaryl sulfides such as bis(4-hydroxyphenyl)sulfide, bis(3-methyl-4-hydroxyphenyl)sulfide, and bis(3,5-dimethyl-4-hydroxyphenyl)sulfide; dihydroxydiaryl sulfoxides such as bis(4-hydroxyphenyl)sulfoxide; dihydroxydiphenyls such as 4,4′-dihydroxyphenyl; dihydroxyarylfluorenes such as 9,9-bis(4-hydroxyphenyl)fluorene; dihydroxybenzenes such as hydroxyquinone, resorcinol, and methylhydroxyquinone; and dihydroxynaphthalenes such as 1,5-dihydroxynaphthalene and 2,6-dihydroxynaphthalene. Also, two or more kinds of diols can be combined as needed.

In a specific embodiment, the polyester is polyethylene terephthalate, polybutylene terephthalate, polyethylene naphthalate, polybutylene naphthalate, polytrimethylene terephthalate, poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), or a combination comprising at least one of the foregoing polyesters. Polyethylene terephthalate (PET) and polybutylene terephthalate (PBT) are particularly suitable as polyesters that are obtained by the polymerization of these kinds of bifunctional carboxylic acid and diol ingredients.

These polyesters can be produced in the presence or absence of common polymerization catalysts represented by titanium, germanium, antimony or the like; and can be produced by interfacial polymerization, melt polymerization or the like. Polyester resin compositions of this invention can be a single kind of polyester used alone, or two or more kinds used in combination. Furthermore, copolyesters can also be used as needed.

### Polycarbonate Polymer Component

As described, according to aspects the polycarbonate component of a disclosed blended polycarbonate composition can comprise a polycarbonate or a polycarbonate/polyester blend.

“Polycarbonate” as used herein means a polymer having repeating structural carbonate units of formula (1)

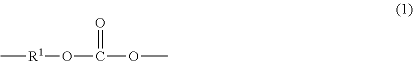

in which at least 60 percent of the total number of R¹ groups contain aromatic moieties and the balance thereof are aliphatic, alicyclic, or aromatic. In an embodiment, each R¹ is a C₆₋₃₀ aromatic group, that is, contains at least one aromatic moiety. R¹ can be derived from an aromatic dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an embodiment, one atom separates A¹ from A². Specifically, each R¹ can be derived from a bisphenol of formula (3)

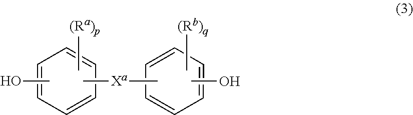

wherein R^{a} and R^{b} are each independently a halogen, C₁₋₁₂ alkoxy, or C₁₋₁₂ alkyl, and p and q are each independently integers of 0 to 4. It will be understood that when p or q is less than 4, the valence of each carbon of the ring is filled by hydrogen. Also in formula (3), X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In an embodiment, p and q is each 1, and R^{a} and R^{b} are each a C₁₋₃ alkyl group, specifically methyl, disposed meta to the hydroxy group on each arylene group.

In an embodiment, X^{a} is a substituted or unsubstituted C₃₋₁₈ cycloalkylidene, a C₁₋₂₅ alkylidene of formula —C(R^{e})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene.

In another embodiment, X^{a} is a C₁₋₁₈ alkylene, a C₃₋₁₈ cycloalkylene, a fused C₆₋₁₈ cycloalkylene, or a group of the formula —B¹-G-B²— wherein B¹ and B² are the same or different C₁₋₆ alkylene and G is a C₃₋₁₂ cycloalkylidene or a C₆₋₁₆ arylene. For example, X^{a} can be a substituted C₃₋₁₈ cycloalkylidene of formula (4)

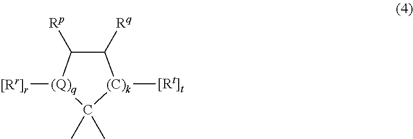

wherein R^{r}, R^{p}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)— where Z is hydrogen, halogen, hydroxy, C₁₋₁₂ alkyl, C₁₋₁₂ alkoxy, or C₁₋₁₂ acyl; r is 0 to 2, t is 1 or 2, q is 0 or 1, and k is 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (4) will have an unsaturated carbon-carbon linkage where the ring is fused. When k is one and i is 0, the ring as shown in formula (4) contains 4 carbon atoms, when k is 2, the ring as shown in formula (4) contains 5 carbon atoms, and when k is 3, the ring contains 6 carbon atoms. In an embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone.

Bisphenols wherein X^{a} is a cycloalkylidene of formula (4) can be used in the manufacture of polycarbonates containing phthalimidine carbonate units of formula (1a)

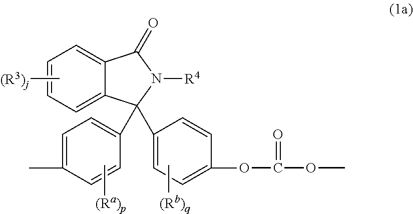

wherein R^{a}, R^{b}, p, and q are as in formula (3), R³ is each independently a C₁₋₆ alkyl, j is 0 to 4, and R₄ is hydrogen, C₁₋₆ alkyl, or a substituted or unsubstituted phenyl, for example a phenyl substituted with up to five C₁₋₆ alkyls. For example, the phthalimidine carbonate units are of formula (1b)

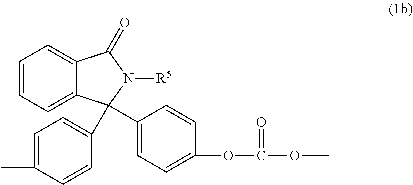

wherein R⁵ is hydrogen, phenyl optionally substituted with up to five 5 C₁₋₆ alkyls, or C₁₋₄ alkyl. In an embodiment in formula (1b), R⁵ is hydrogen, methyl, or phenyl, specifically phenyl. Carbonate units (1b) wherein R⁵ is phenyl can be derived from 2-phenyl-3,3′-bis(4-hydroxy phenyl)phthalimidine (also known as 3,3-bis(4-hydroxyphenyl)-2-phenylisoindolin-1-one, or N-phenyl phenolphthalein bisphenol (“PPPBP”)).

Other bisphenol carbonate repeating units of this type are the isatin carbonate units of formula (1c) and (1d)

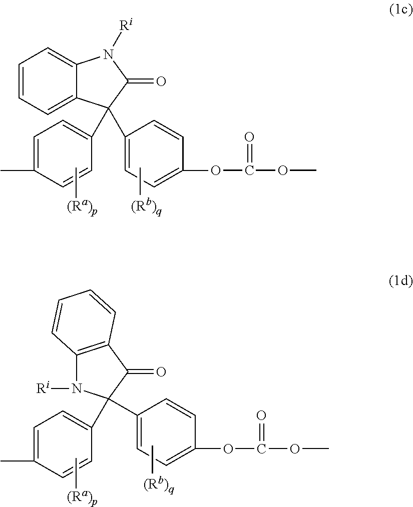

wherein R^{a} and R^{b} are each independently a halogen, C₁₋₁₂ alkoxy, or C₁₋₁₂ alkyl, p and q are each independently 0 to 4, and Rⁱ is C₁₋₁₂ alkyl, phenyl optionally substituted with 1 to 5 C₁₋₁₀ alkyl, or benzyl optionally substituted with 1 to 5 C₁₋₁₀ alkyl. In an embodiment, R^{a} and R^{b} are each methyl, p and q are each independently 0 or 1, and Rⁱ is C₁₋₄ alkyl or phenyl.

Other examples of bisphenol carbonate units derived from of bisphenols (3) wherein X^{a} is a substituted or unsubstituted C₃₋₁₈ cycloalkylidene (4) include the cyclohexylidene-bridged, alkyl-substituted bisphenol of formula (1e)

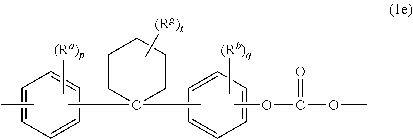

wherein R^{a} and R^{b} are each independently C₁₋₁₂ alkyl, R^{g} is C₁₋₁₂ alkyl, p and q are each independently 0 to 4, and t is 0 to 10. In a specific embodiment, at least one of each of R^{a} and R^{b} are disposed meta to the cyclohexylidene bridging group. In an embodiment, R^{a} and R^{b} are each independently C₁₋₄ alkyl, R^{g} is C₁₋₄ alkyl, p and q are each 0 or 1, and t is 0 to 5. In another specific embodiment, R^{a}, R^{b}, and R^{g} are each methyl, p and q are each 0 or 1, and t is 0 or 3, specifically 0.

Examples of other bisphenol carbonate units derived from bisphenol (3) wherein X^{a} is a substituted or unsubstituted C₃₋₁₈ cycloalkylidene include adamantyl units of formula (1f) and fluorenyl units of formula (1g)

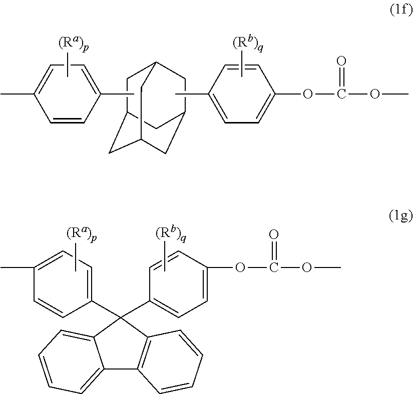

wherein R^{a} and R^{b} are each independently C₁₋₁₂ alkyl, and p and q are each independently 1 to 4. In a specific embodiment, at least one of each of R^{a} and R^{b} are disposed meta to the cycloalkylidene bridging group. In an embodiment, R^{a} and R^{b} are each independently C₁₋₃ alkyl, and p and q are each 0 or 1; specifically, R^{a}, R^{b} are each methyl, p and q are each 0 or 1, and when p and q are 1, the methyl group is disposed meta to the cycloalkylidene bridging group. Carbonates containing units (1a) to (1g) are useful for making polycarbonates with high glass transition temperatures (Tg) and high heat distortion temperatures.

Other useful dihydroxy compounds of the formula HO—R¹—OH include aromatic dihydroxy compounds of formula (6)

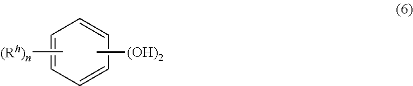

wherein each R^{h} is independently a halogen atom, C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4. The halogen is usually bromine.

Some illustrative examples of specific dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In a specific embodiment, the polycarbonate is a linear homopolymer derived from bisphenol A, in which each of A¹ and A² is p-phenylene and Y¹ is isopropylidene in formula (3).

“Polycarbonates” includes homopolycarbonates (wherein each R¹ in the polymer is the same), copolymers comprising different R¹ moieties in the carbonate (“copolycarbonates”), and copolymers comprising carbonate units and other types of polymer units, such as ester units or siloxane units.

A specific type of copolymer is a poly(ester-carbonate), also known as a polyester-polycarbonate. Such copolymers further contain, in addition to recurring carbonate units of formula (1), repeating units of formula (7)

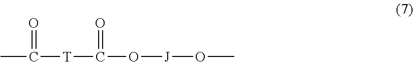

wherein J is a divalent group derived from a dihydroxy compound (including a reactive derivative thereof), and can be, for example, a C₂₋₁₀ alkylene, a C₆₋₂₀ cycloalkylene, a C₆₋₂₀ arylene, or a polyoxyalkylene in which the alkylene groups contain 2 to 6 carbon atoms, specifically 2, 3, or 4 carbon atoms; and T is a divalent group derived from a dicarboxylic acid (including a reactive derivative thereof), and can be, for example, a C₂₋₂₀ alkylene, a C₆₋₂₀ cycloalkylene, or a C₆₋₂₀ arylene. Copolyesters containing a combination of different T and/or J groups can be used. The polyester units can be branched or linear.

In an embodiment, J is a C₂₋₃₀ alkylene group having a straight chain, branched chain, or cyclic (including polycyclic) structure, for example ethylene, n-propylene, proplyene, 1,4-butylene, 1,6-cyclohexylene, or 1,4-methylenecyclohexane. In another embodiment, J is derived from a bisphenol of formula (3), e.g., bisphenol A. In another embodiment, J is derived from an aromatic dihydroxy compound of formula (6), e.g, resorcinol.

Aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, or a combination comprising at least one of the foregoing acids. Acids containing fused rings can also be present, such as in 1,4-, 1,5-, or 2,6-naphthalenedicarboxylic acids. Specific dicarboxylic acids include terephthalic acid, isophthalic acid, naphthalene dicarboxylic acid, 1,4-cyclohexane dicarboxylic acid, or a combination comprising at least one of the foregoing acids. A specific dicarboxylic acid comprises a combination of isophthalic acid and terephthalic acid wherein the weight ratio of isophthalic acid to terephthalic acid is 91:9 to 2:98.

Specific ester units include ethylene terephthalate, n-propylene terephthalate, n-butylene terephthalate, 1,4-cyclohexanedimethylene terephthalate, and ester units derived from isophthalic acid, terephthalic acid, and resorcinol (ITR)). The molar ratio of ester units to carbonate units in the copolymers can vary broadly, for example 1:99 to 99:1, specifically 10:90 to 90:10, more specifically 25:75 to 75:25, or 2:98 to 15:85, depending on the desired properties of the final composition. Specific poly(ester-carbonate)s are those including bisphenol A carbonate units and isophthalate-terephthalate-bisphenol A ester units, also commonly referred to as poly(carbonate-ester)s (PCE) poly(phthalate-carbonate)s (PPC) depending on the molar ratio of carbonate units and ester units.

In a further aspect, the thermoplastic composition comprises a polyester-polycarbonate copolymer, or a mixture of polyester-polycarbonate polymers or copolymer, and specifically a polyester-polycarbonate copolymer in which the ester units of formula (8) comprise soft block ester units, also referred to herein as aliphatic dicarboxylic acid ester units. Such a polyester-polycarbonate copolymer comprising soft block ester units is also referred to herein as a poly(aliphatic ester)-polycarbonate. The soft block ester unit can be a C₆₋₂₀ aliphatic dicarboxylic acid ester unit (where C₆₋₂₀ includes the terminal carboxyl groups), and can be straight chain (i.e., unbranched) or branched chain dicarboxylic acids, cycloalkyl or cycloalkylidene-containing dicarboxylic acids units, or combinations of these structural units. In a still further aspect, the C₆₋₂₀ aliphatic dicarboxylic acid ester unit includes a straight chain alkylene group comprising methylene (—CH₂—) repeating units. In a yet further aspect, a useful soft block ester unit comprises units of formula (8a):

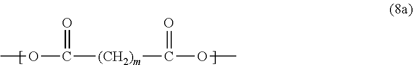

where m is 4 to 18. In a further aspect of formula (8a), m is 8 to 10. The poly(aliphatic ester)-polycarbonate can include less than or equal to 25 wt. % of the soft block unit. In a still further aspect, a poly(aliphatic ester)-polycarbonate comprises units of formula (8a) in an amount of 0.5 to 10 wt. %, specifically 1 to 9 wt. %, and more specifically 3 to 8 wt. %, based on the total weight of the poly(aliphatic ester)-polycarbonate.

The poly(aliphatic ester)-polycarbonate is a copolymer of soft block ester units and carbonate units. The poly(aliphatic ester)-polycarbonate is shown in formula (8b):

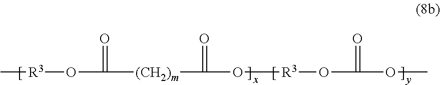

where each R³ is independently derived from a dihydroxyaromatic compound of formula (4) or (7), m is 4 to 18, and x and y each represent average weight percentages of the poly(aliphatic ester)-polycarbonate where the average weight percentage ratio x:y is 10:90 to 0.5:99.5, specifically 9:91 to 1:99, and more specifically 8:92 to 3:97, where x+y is 100.

Soft block ester units, as defined herein, can be derived from an alpha, omega C₆₋₂₀ aliphatic dicarboxylic acid or a reactive derivative thereof. In a further aspect, the soft block ester units can be derived from an alpha, omega C₁₀₋₁₂ aliphatic dicarboxylic acid or a reactive derivative thereof. In a still further aspect, the carboxylate portion of the aliphatic ester unit of formula (8a), in which the terminal carboxylate groups are connected by a chain of repeating methylene (—CH₂—) units (where m is as defined for formula (8a)), is derived from the corresponding dicarboxylic acid or reactive derivative thereof, such as the acid halide (specifically, the acid chloride), an ester, or the like. Exemplary alpha, omega dicarboxylic acids (from which the corresponding acid chlorides can be derived) include alpha, omega C₆ dicarboxylic acids such as hexanedioic acid (also referred to as adipic acid); alpha, omega C₁₀ dicarboxylic acids such as decanedioic acid (also referred to as sebacic acid); and alpha, omega C₁₂ dicarboxylic acids such as dodecanedioic acid (sometimes abbreviated as DDDA). It will be appreciated that the aliphatic dicarboxylic acid is not limited to these exemplary carbon chain lengths, and that other chain lengths within the C₆₋₂₀ limitation can be used. In various further aspects, the poly(aliphatic ester)-polycarbonate having soft block ester units comprising a straight chain methylene group and a bisphenol A polycarbonate group is shown in formula (8c):

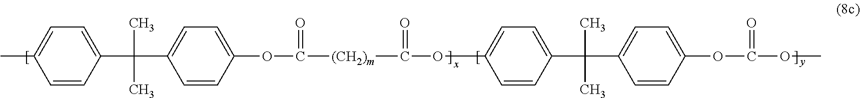

where m is 4 to 18 and x and y are as defined for formula (8b). In a specific exemplary aspect, a useful poly(aliphatic ester)-polycarbonate copolymer comprises sebacic acid ester units and bisphenol A carbonate units (formula (8c), where m is 8, and the average weight ratio of x:y is 6:94).

Desirably, the poly(aliphatic ester)-polycarbonate has a glass transition temperature (Tg) of from about 50° C. to about 220° C., for example, from about 60 to about 150° C., or from about 80 to about 150° C., or from about 110 to about 150° C., or from about 128 to about 139° C., and still more specifically 130 to 139° C. In other embodiments, the glass transition temperature (Tg) of the product is in a range of from about 50° C. to about 220° C., or from about 115 to about 220° C., or from about 120 to about 200° C. For example, Tg for polycarbonate (PC) is about 151° C., for XHT PC copolymer is about 200° C. and can be up to 220° C., for polyesters are in a range of about 50 to about 110° C., wherein PET is about 70 to about 80° C., PBT is from about 45 to about 60° C., PCCD is about 65° C., PETG is about 81° C., PCTG is about 84° C., and Tritan is about 110° C.

In one aspect, polycarbonates and/or polyesters, including polyester-polycarbonates, can be manufactured by processes such as interfacial polymerization and melt polymerization.

The polycarbonate and/or polyester compounds and polymers disclosed herein can, in various aspects, be prepared by a melt polymerization process. Generally, in the melt polymerization process, polycarbonates are prepared by co-reacting, in a molten state, the dihydroxy reactant(s) (i.e., isosorbide, aliphatic diol and/or aliphatic diacid, and any additional dihydroxy compound) and a diaryl carbonate ester, such as diphenyl carbonate, or more specifically in an aspect, an activated carbonate such as bis(methyl salicyl)carbonate, in the presence of a transesterification catalyst. The reaction can be carried out in typical polymerization equipment, such as one or more continuously stirred reactors (CSTRs), plug flow reactors, wire wetting fall polymerizers, free fall polymerizers, wiped film polymerizers, BANBURY® mixers, single or twin screw extruders, or combinations of the foregoing. In one aspect, volatile monohydric phenol can be removed from the molten reactants by distillation and the polymer is isolated as a molten residue.

The melt polymerization can include a transesterification catalyst comprising a first catalyst, also referred to herein as an alpha catalyst, comprising a metal cation and an anion. In an aspect, the cation is an alkali or alkaline earth metal comprising Li, Na, K, Cs, Rb, Mg, Ca, Ba, Sr, or a combination comprising at least one of the foregoing. The anion is hydroxide (OH⁻), superoxide (O²⁻), thiolate (HS), sulfide (S²⁻), a C₁₋₂₀ alkoxide, a C₆₋₂₀ aryloxide, a C₁₋₂₀ carboxylate, a phosphate including biphosphate, a C₁₋₂₀ phosphonate, a sulfate including bisulfate, sulfites including bisulfites and metabisulfites, a C₁₋₂₀ sulfonate, a carbonate including bicarbonate, or a combination comprising at least one of the foregoing. In another aspect, salts of an organic acid comprising both alkaline earth metal ions and alkali metal ions can also be used. Salts of organic acids useful as catalysts are illustrated by alkali metal and alkaline earth metal salts of formic acid, acetic acid, stearic acid and ethyelenediaminetetraacetic acid. The catalyst can also comprise the salt of a non-volatile inorganic acid. By “nonvolatile”, it is meant that the referenced compounds have no appreciable vapor pressure at ambient temperature and pressure. In particular, these compounds are not volatile at temperatures at which melt polymerizations of polycarbonate are typically conducted. The salts of nonvolatile acids are alkali metal salts of phosphites; alkaline earth metal salts of phosphites; alkali metal salts of phosphates; and alkaline earth metal salts of phosphates. Exemplary transesterification catalysts include, lithium hydroxide, sodium hydroxide, potassium hydroxide, cesium hydroxide, magnesium hydroxide, calcium hydroxide, barium hydroxide, lithium formate, sodium formate, potassium formate, cesium formate, lithium acetate, sodium acetate, potassium acetate, lithium carbonate, sodium carbonate, potassium carbonate, lithium methoxide, sodium methoxide, potassium methoxide, lithium ethoxide, sodium ethoxide, potassium ethoxide, lithium phenoxide, sodium phenoxide, potassium phenoxide, sodium sulfate, potassium sulfate, NaH₂PO₃, NaH₂PO₄, Na₂H₂PO₃, KH₂PO₄, CsH₂PO₄, Cs₂H₂PO₄, Na₂SO₃, Na₂S₂O₅, sodium mesylate, potassium mesylate, sodium tosylate, potassium tosylate, magnesium disodium ethylenediamine tetraacetate (EDTA magnesium disodium salt), or a combination comprising at least one of the foregoing. It will be understood that the foregoing list is exemplary and should not be considered as limited thereto. In one aspect, the transesterification catalyst is an alpha catalyst comprising an alkali or alkaline earth salt. In an exemplary aspect, the transesterification catalyst comprises sodium hydroxide, potassium hydroxide, sodium carbonate, potassium carbonate, sodium methoxide, potassium methoxide, NaH₂PO₄, or a combination comprising at least one of the foregoing.

The amount of alpha catalyst can vary widely according to the conditions of the melt polymerization, and can be about 0.001 to about 500 μmol. In an aspect, the amount of alpha catalyst can be about 0.01 to about 20 μmol, specifically about 0.1 to about 10 μmol, more specifically about 0.5 to about 9 μmol, and still more specifically about 1 to about 7 μmol, per mole of aliphatic diol and any other dihydroxy compound present in the melt polymerization.

In another aspect, a second transesterification catalyst, also referred to herein as a beta catalyst, can optionally be included in the melt polymerization process, provided that the inclusion of such a second transesterification catalyst does not significantly adversely affect the desirable properties of the polycarbonate. Exemplary transesterification catalysts can further include a combination of a phase transfer catalyst of formula (R³)₄Q⁺X above, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalyst salts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing. Other melt transesterification catalysts include alkaline earth metal salts or alkali metal salts. In various aspects, where a beta catalyst is desired, the beta catalyst can be present in a molar ratio, relative to the alpha catalyst, of less than or equal to 10, specifically less than or equal to 5, more specifically less than or equal to 1, and still more specifically less than or equal to 0.5. In other aspects, the melt polymerization reaction disclosed herein uses only an alpha catalyst as described hereinabove, and is substantially free of any beta catalyst. As defined herein, “substantially free of” can mean where the beta catalyst has been excluded from the melt polymerization reaction. In one aspect, the beta catalyst is present in an amount of less than about 10 ppm, specifically less than 1 ppm, more specifically less than about 0.1 ppm, more specifically less than or equal to about 0.01 ppm, and more specifically less than or equal to about 0.001 ppm, based on the total weight of all components used in the melt polymerization reaction.

In one aspect, an end-capping agent (also referred to as a chain-stopper) can optionally be used to limit molecular weight growth rate, and so control molecular weight in the polycarbonate. End-capping may be achieved by various methods, for example, including the interfacial method. Exemplary chain-stoppers include certain monophenolic compounds (i.e., phenyl compounds having a single free hydroxy group), monocarboxylic acid chlorides, and/or monochloroformates. Phenolic chain-stoppers are exemplified by phenol and C₁-C₂₂ alkyl-substituted phenols such as p-cumyl-phenol, resorcinol monobenzoate, and p- and tertiary-butyl phenol, cresol, and monoethers of diphenols, such as p-methoxyphenol. Alkyl-substituted phenols with branched chain alkyl substituents having 8 to 9 carbon atoms can be specifically mentioned.

In another aspect, endgroups can be derived from the carbonyl source (i.e., the diaryl carbonate), from selection of monomer ratios, incomplete polymerization, chain scission, and the like, as well as any added end-capping groups, and can include derivatizable functional groups such as hydroxy groups, carboxylic acid groups, or the like. In one aspect, the endgroups of a polycarbonate, including a polycarbonate polymer as defined herein, can comprise a structural unit derived from a diaryl carbonate, where the structural unit can be an endgroups. In a further aspect, the endgroups is derived from an activated carbonate. Such endgroups can be derived from the transesterification reaction of the alkyl ester of an appropriately substituted activated carbonate, with a hydroxy group at the end of a polycarbonate polymer chain, under conditions in which the hydroxy group reacts with the ester carbonyl from the activated carbonate, instead of with the carbonate carbonyl of the activated carbonate. In this way, structural units derived from ester containing compounds or substructures derived from the activated carbonate and present in the melt polymerization reaction can form ester endgroups.

In one aspect, the melt polymerization reaction can be conducted by subjecting the reaction mixture to a series of temperature-pressure-time protocols. In some aspects, this involves gradually raising the reaction temperature in stages while gradually lowering the pressure in stages. In one aspect, the pressure is reduced from about atmospheric pressure at the start of the reaction to about 1 millibar (100 Pa) or lower, or in another aspect to 0.1 millibar (10 Pa) or lower in several steps as the reaction approaches completion. The temperature can be varied in a stepwise fashion beginning at a temperature of about the melting temperature of the reaction mixture and subsequently increased to final temperature. In one aspect, the reaction mixture is heated from room temperature to about 150° C. In such an aspect, the polymerization reaction starts at a temperature of about 150° C. to about 220° C. In another aspect, the polymerization temperature can be up to about 220° C. In other aspects, the polymerization reaction can then be increased to about 250° C. and then optionally further increased to a temperature of about 320° C., and all subranges there between. In one aspect, the total reaction time can be from about 30 minutes to about 200 minutes and all subranges there between. This procedure will generally ensure that the reactants react to give polycarbonates with the desired molecular weight, glass transition temperature and physical properties. The reaction proceeds to build the polycarbonate chain with production of ester-substituted alcohol by-product such as methyl salicylate. In one aspect, efficient removal of the by-product can be achieved by different techniques such as reducing the pressure. Generally the pressure starts relatively high in the beginning of the reaction and is lowered progressively throughout the reaction and temperature is raised throughout the reaction.

In one aspect, the progress of the reaction can be monitored by measuring the melt viscosity or the weight average molecular weight of the reaction mixture using techniques known in the art such as gel permeation chromatography. These properties can be measured by taking discrete samples or can be measured on-line. After the desired melt viscosity and/or molecular weight is reached, the final polycarbonate product can be isolated from the reactor in a solid or molten form. It will be appreciated by a person skilled in the art, that the method of making aliphatic homopolycarbonate and aliphatic-aromatic copolycarbonates as described in the preceding sections can be made in a batch or a continuous process and the process disclosed herein is preferably carried out in a solvent free mode. Reactors chosen should ideally be self-cleaning and should minimize any “hot spots.” However, vented extruders similar to those that are commercially available can be used.

Polycarbonates, including polyester-polycarbonates, can be also be manufactured by interfacial polymerization. Although the reaction conditions for interfacial polymerization can vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like.

Carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary aspect, an interfacial polymerization reaction to form carbonate linkages uses phosgene as a carbonate precursor, and is referred to as a phosgenation reaction.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Useful phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 wt. % based on the weight of bisphenol in the phosgenation mixture. In another aspect, an effective amount of phase transfer catalyst can be about 0.5 to about 2 wt. % based on the weight of bisphenol in the phosgenation mixture.

All types of polycarbonate end groups are contemplated as being useful in the polycarbonate composition, provided that such end groups do not significantly adversely affect desired properties of the compositions.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid. The branching agents can be added at a level of about 0.05 to about 2.0 wt. %. Mixtures comprising linear polycarbonates and branched polycarbonates can be used.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, mono-carboxylic acid chlorides, and/or mono-chloroformates. Mono-phenolic chain stoppers are exemplified by monocyclic phenols such as phenol and C₁-C₂₂ alkyl-substituted phenols such as p-cumyl-phenol, resorcinol monobenzoate, and p- and tertiary-butyl phenol; and monoethers of diphenols, such as p-methoxyphenol. Alkyl-substituted phenols with branched chain alkyl substituents having 8 to 9 carbon atom can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Specifically, polyester-polycarbonates, including the poly(aliphatic ester)-polycarbonates, can be prepared by interfacial polymerization. Rather than utilizing the dicarboxylic acid (such as the alpha, omega C₆₋₂₀ aliphatic dicarboxylic acid) per se, it is possible, and sometimes even preferred, to employ the reactive derivatives of the dicarboxylic acid, such as the corresponding dicarboxylic acid halides, and in particular the acid dichlorides and the acid dibromides. Thus, for example instead of using isophthalic acid, terephthalic acid, or a combination comprising at least one of the foregoing (for poly(arylate ester)-polycarbonates), it is possible to employ isophthaloyl dichloride, terephthaloyl dichloride, and a combination comprising at least one of the foregoing. Similarly, for the poly(aliphatic ester)-polycarbonates, it is possible, and even desirable, to use for example acid chloride derivatives such as a C₆ dicarboxylic acid chloride (adipoyl chloride), a C₁₀ dicarboxylic acid chloride (sebacoyl chloride), or a C₁₂ dicarboxylic acid chloride (dodecanedioyl chloride). The dicarboxylic acid or reactive derivative can be condensed with the dihydroxyaromatic compound in a first condensation, followed by in situ phosgenation to generate the carbonate linkages with the dihydroxyaromatic compound. Alternatively, the dicarboxylic acid or derivative can be condensed with the dihydroxyaromatic compound simultaneously with phosgenation.

In an aspect, where the melt volume rate of an otherwise compositionally suitable poly(aliphatic ester)-polycarbonate is not suitably high, i.e., where the MVR is less than 13 cc/10 min when measured at 250° C., under a load of 1.2 kg, the poly(aliphatic ester)-polycarbonate can be modified to provide a reaction product with a higher flow (i.e., greater than or equal to 13 cc/10 min when measured at 250° C., under a load of 1.2 kg), by treatment using a redistribution catalyst under conditions of reactive extrusion. During reactive extrusion, the redistribution catalyst is typically included in small amounts of less than or equal to 400 ppm by weight, by injecting a dilute aqueous solution of the redistribution catalyst into the extruder being fed with the poly(aliphatic ester)-polycarbonate.

In a further aspect, the redistribution-catalyst is a tetraalkylphosphonium hydroxide, tetraalkylphosphonium alkoxide, tetraalkylphosphonium aryloxide, a tetraalkylphosphonium carbonate, a tetraalkylammonium hydroxide, a tetraalkylammonium carbonate, a tetraalkylammonium phosphite, a tetraalkylammonium acetate, or a combination comprising at least one of the foregoing catalysts, wherein each alkyl is independently a C₁₋₆ alkyl. In a specific aspect, a useful redistribution catalyst is a tetra C₁₋₆ alkylphosphonium hydroxide, C₁₋₆ alkyl phosphonium phenoxide, or a combination comprising one or more of the foregoing catalysts. An exemplary redistribution catalyst is tetra-n-butylphosphonium hydroxide.

In a further aspect, the redistribution catalyst is present in an amount of 40 to 120 ppm, specifically 40 to 110 ppm, and more specifically 40 to 100 ppm, by weight based on the weight of the poly(aliphatic ester)-polycarbonate.

Polycarbonates as broadly defined above can further include blends of the above polycarbonates with polyesters. Useful polyesters can include, for example, polyesters having repeating units of formula (8), which include poly(alkylene dicarboxylates), liquid crystalline polyesters, and polyester copolymers. The polyesters described herein are generally completely miscible with the polycarbonates when blended.

Such polyesters generally include aromatic polyesters, poly(alkylene esters) including poly(alkylene arylates), and poly(cycloalkylene diesters). Aromatic polyesters can have a polyester structure according to formula (8), wherein D and T are each aromatic groups as described hereinabove. In an aspect, useful aromatic polyesters can include, for example, poly(isophthalate-terephthalate-resorcinol)esters, poly(isophthalate-terephthalate-bisphenol A)esters, poly[(isophthalate-terephthalate-resorcinol)ester-co-(isophthalate-terephthalate-bisphenol A)]ester, or a combination comprising at least one of these. Also contemplated are aromatic polyesters with a minor amount, e.g., about 0.5 to about 10 wt. %, based on the total weight of the polyester, of units derived from an aliphatic diacid and/or an aliphatic polyol to make copolyesters. Poly(alkylene arylates) can have a polyester structure according to formula (8), wherein T comprises groups derived from aromatic dicarboxylates, cycloaliphatic dicarboxylic acids, or derivatives thereof. Examples of specifically useful T groups include 1,2-, 1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups D include, for example, ethylene, 1,4-butylene, and bis-(alkylene-disubstituted cyclohexane) including cis- and/or trans-1,4-(cyclohexylene)dimethylene. Examples of poly(alkylene terephthalates) include poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations comprising at least one of the foregoing polyesters can also be used.

Copolymers comprising alkylene terephthalate repeating ester units with other ester groups can also be useful. Useful ester units can include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate).

Poly(cycloalkylene diester)s can also include poly(alkylene cyclohexanedicarboxylate)s. Of these, a specific example is poly(1,4-cyclohexane-dimethanol-1,4-cyclohexanedicarboxylate) (PCCD), having recurring units of formula (9):

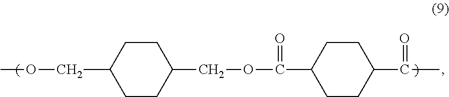

wherein, as described using formula (8), R² is a 1,4-cyclohexanedimethylene group derived from 1,4-cyclohexanedimethanol, and T is a cyclohexane ring derived from cyclohexanedicarboxylate or a chemical equivalent thereof, and can comprise the cis-isomer, the trans-isomer, or a combination comprising at least one of the foregoing isomers.

The polyesters can be obtained by interfacial polymerization or melt-process condensation as described above, by solution phase condensation, or by transesterification polymerization wherein, for example, a dialkyl ester such as dimethyl terephthalate can be transesterified with ethylene glycol using acid catalysis, to generate poly(ethylene terephthalate). It is possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

Polyester-polycarbonate copolymers generally can have a weight average molecular weight (Mw) of 1,500 to 100,000 g/mol, specifically 1,700 to 50,000 g/mol. In an aspect, poly(aliphatic ester)-polycarbonates have a molecular weight of 15,000 to 45,000 g/mol, specifically 17,000 to 40,000 g/mol, more specifically 20,000 to 30,000 g/mol, and still more specifically 20,000 to 25,000 g/mol. Molecular weight determinations are performed using gel permeation chromatography (GPC), using a crosslinked styrene-divinylbenzene column and calibrated to polycarbonate references.

A polyester-polycarbonate can in general have an MVR of about 5 to about 150 cc/10 min., specifically about 7 to about 125 cc/10 min, more specifically about 9 to about 110 cc/10 min, and still more specifically about 10 to about 100 cc/10 min., measured at 300° C. and a load of 1.2 kilograms according to ASTM D1238-04 or ISO 1133. Commercial polyester blends with polycarbonate are marketed under the trade name XYLEX®, including for example XYLEX® X7300, and commercial polyester-polycarbonates are marketed under the tradename LEXAN® SLX polymers, including for example LEXAN® SLX-9000, and are available from SABIC Innovative Plastics.

In an aspect, poly(aliphatic ester)-polycarbonates have an MVR of about 13 to about 25 cc/10 min, and more specifically about 15 to about 22 cc/10 min, measured at 250° C. and under a load of 1.2 kilograms and a dwell time of 6 minutes, according to ASTM D1238-04. Also in an aspect, poly(aliphatic ester)-polycarbonates have an MVR of about 13 to about 25 cc/10 min, and more specifically about 15 to about 22 cc/10 min, measured at 250° C. and under a load of 1.2 kilograms and a dwell time of 4 minutes, according to ISO 1133.

In an aspect, the thermoplastic composition comprises poly(aliphatic ester)-polycarbonate in an amount of 50 to 100 wt. %, based on the total weight of poly(aliphatic ester)-polycarbonate and any added polycarbonate. In a specific aspect, the polycarbonate component comprises only poly(aliphatic ester)-polycarbonate. Polycarbonates, as defined above, also include a polysiloxane-polycarbonate copolymer. The polysiloxane (also referred to herein as “polydiorganosiloxane”) blocks of the copolymer comprise repeating siloxane units (also referred to herein as “diorganosiloxane units”) of formula (10):

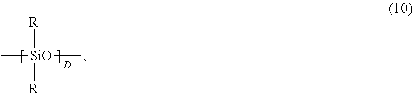

wherein each occurrence of R is same or different, and is a C₁₋₁₃ monovalent organic radical. For example, R can independently be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ arylalkyl group, C₇-C₁₃ arylalkoxy group, C₇-C₁₃ alkylaryl group, or C₇-C₁₃ alkylaryloxy group. The foregoing groups can be fully or partially halogenated with fluorine, chlorine, bromine, or iodine, or a combination thereof. Combinations of the foregoing R groups can be used in the same copolymer.

The value of D in formula (10) can vary widely depending on the type and relative amount of each component in the thermoplastic composition, the desired properties of the composition, and like considerations. Generally, D can have an average value of 2 to 1,000, specifically 2 to 500, more specifically 5 to 100. In some applications, D can have an average value of 30 to 60. An exemplary siloxane block can have an average D value of 45.

Where D is of a lower value, e.g., less than 40, it can be desirable to use a relatively larger amount of the polycarbonate-polysiloxane copolymer. Conversely, where D is of a higher value, e.g., greater than 40, it can be necessary to use a relatively lower amount of the polycarbonate-polysiloxane copolymer.

A combination of a first and a second (or more) polysiloxane-polycarbonate copolymer can be used, wherein the average value of D of the first copolymer is less than the average value of D of the second copolymer.

In one aspect, the polydiorganosiloxane blocks are provided by repeating structural units of formula (11):

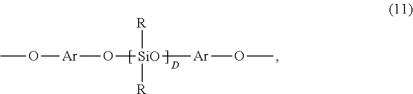

wherein D is as defined above; each R can independently be the same or different, and is as defined above; and each Ar can independently be the same or different, and is a substituted or unsubstituted C₆-C₃₀ arylene radical, wherein the bonds are directly connected to an aromatic moiety. Useful Ar groups in formula (11) can be derived from a C₆-C₃₀ dihydroxyarylene compound, for example a dihydroxyarylene compound of formula (3), (4), or (7) above. Combinations comprising at least one of the foregoing dihydroxyarylene compounds can also be used. Specific examples of dihydroxyarylene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxyphenyl)cyclohexane, bis(4-hydroxyphenyl sulphide), and 1,1-bis(4-hydroxy-t-butylphenyl)propane. Combinations comprising at least one of the foregoing dihydroxy compounds can also be used.

Units of formula (11) can be derived from the corresponding dihydroxy compound of formula (12):

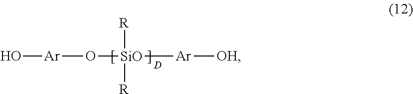

wherein R, Ar, and D are as described above. Compounds of formula (12) can be obtained by the reaction of a dihydroxyarylene compound with, for example, an alpha, omega-bisacetoxypolydiorangonosiloxane under phase transfer conditions.

In another aspect, polydiorganosiloxane blocks comprise units of formula (13):

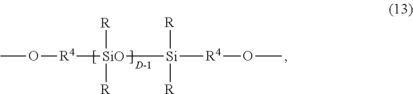

wherein R and D are as described above, and each occurrence of R⁴ is independently a divalent C₁-C₃₀ alkylene, and wherein the polymerized polysiloxane unit is the reaction residue of its corresponding dihydroxy compound. In a specific aspect, the polydiorganosiloxane blocks are provided by repeating structural units of formula (14):

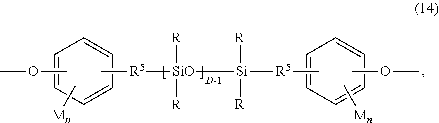

wherein R and D are as defined above. Each R⁵ in formula (14) is independently a divalent C₂-C₈ aliphatic group. Each M in formula (14) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ arylalkyl, C₂-C₁₂ arylalkoxy, C₂-C₁₂ alkylaryl, or C₂-C₁₂ alkylaryloxy, wherein each n is independently 0, 1, 2, 3, or 4.

In one aspect, M is bromo or chloro, an alkyl group such as methyl, ethyl, or propyl, an alkoxy group such as methoxy, ethoxy, or propoxy, or an aryl group such as phenyl, chlorophenyl, or tolyl; R⁵ is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another aspect, R is methyl, or a mixture of methyl and trifluoropropyl, or a mixture of methyl and phenyl. In still another aspect, M is methoxy, n is one, R⁵ is a divalent C₁-C₃ aliphatic group, and R is methyl.

Units of formula (14) can be derived from the corresponding dihydroxy polydiorganosiloxane (15):

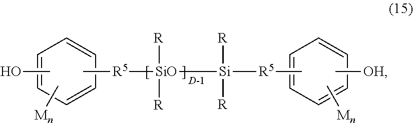

wherein R, D, M, R⁵, and n are as described above. Such dihydroxy polysiloxanes can be made by effecting a platinum catalyzed addition between a siloxane hydride of formula (16):

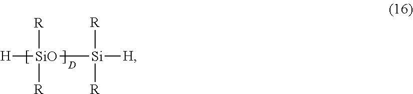

wherein R and D are as previously defined, and an aliphatically unsaturated monohydric phenol. Useful aliphatically unsaturated monohydric phenols included, for example, eugenol, 2-allylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing can also be used.

Polysiloxane-polycarbonates can comprise 50 to 99.9 wt. % of carbonate units and 0.1 to 50 wt. % siloxane units, based on the total weight of the polysiloxane-polycarbonate. Specific polysiloxane-polycarbonate copolymers comprise 90 to 99 wt. %, specifically 75 to 99 wt. %, of carbonate units and 1 to 25 wt. %, specifically 1 to 10 wt. %, siloxane units. An exemplary polysiloxane-polycarbonate copolymer can comprise about 6 wt. % siloxane units. Another exemplary polysiloxane-polycarbonate comprises about 20 wt. % siloxane units. All references to weight percent compositions in the polysiloxane-polycarbonate are based on the total weight of the polysiloxane-polycarbonate.

Exemplary polysiloxane-polycarbonates can comprise polysiloxane units derived from dimethylsiloxane units (e.g., formula (11) where R is methyl), and carbonate units derived from bisphenol A, e.g., the dihydroxy compound of formula (3) in which each of A¹ and A² is p-phenylene and Y¹ is isopropylidene. Polysiloxane-polycarbonates can have a weight average molecular weight of 2,000 to 100,000 g/mol, specifically 5,000 to 50,000 g/mol. Some specific polysiloxane-polycarbonates have, for example, a weigh average molecular weight of 15,000 to 45,000 g/mol. Molecular weights referred to herein are as measured by gel permeation chromatography using a crosslinked styrene-divinyl benzene column, at a sample concentration of about 1 milligram per milliliter, and as calibrated with polycarbonate standards.

The polysiloxane-polycarbonate can have a melt volume flow rate, measured at 300° C. under a load of 1.2 kg, of 1 to 50 cc/10 min, specifically 2 to 30 cc/10 min. Specific polysiloxane-polycarbonates can have a melt volume rate measured at 300° C. under a load of 1.2 kg, of 5 to 15 cc/10 min. Mixtures of polysiloxane-polycarbonates of different flow properties can be used to achieve the overall desired flow property. Commercial polysiloxane-polycarbonates are marketed under the trade name LEXAN® EXL polycarbonates, available from SABIC Innovative Plastics.

In one aspect, the polycarbonate component comprises a polysiloxane-polycarbonate copolymer, such as C9030P (SABIC). C9030P is a PC-Siloxane copolymer with 20% siloxane segments by weight. In one aspect, the polycarbonate component comprises a polysiloxane-polycarbonate in an amount effective to maintain at least one mechanical property of the thermoplastic composition prepared therefrom, in the presence of further components. The amount of polysiloxane-polycarbonate may range generally from about 1 wt. % by weight to about 30 wt. % by weight, specifically from about 2% by weight to about 29% by weight, and more specifically from about 3% by weight to about 28% by weight, based on the total weight of the blended polycarbonate composition.

Where included, the polycarbonate component can comprise polycarbonate, including blends of polycarbonate homo and/or copolymers, polyesters, polyester-polycarbonates other than the poly(aliphatic ester)-polycarbonates disclosed above, or polysiloxane-polycarbonate in an amount of less than or equal to 50 wt. %, specifically 1 to 50 wt. %, and more specifically 10 to 50 wt. %, based on the total weight of poly(aliphatic ester)-polycarbonate and any added polycarbonate, provided the addition of the polycarbonate does not significantly adversely affect the desired properties of the thermoplastic composition.

The polycarbonate component disclosed herein can comprise a poly(aliphatic ester)-polycarbonate. The thermoplastic composition can further include a polycarbonate different from the poly(aliphatic ester)-polycarbonate. In an aspect, the polycarbonate is a linear homopolymer containing bisphenol A carbonate units (BPA-PC); a branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name CFR from the Innovative Plastics division of SABIC.

In another aspect, the polycarbonate is a poly(carbonate-siloxane) comprising bisphenol A carbonate units and siloxane units, for example blocks containing 5 to 200 dimethylsiloxane units, such as those commercially available under the trade name EXL from the Innovative Plastics division of SABIC.

In a further aspect, the polycarbonate component comprises Bisphenol A residues. In another aspect, the polycarbonate component comprises polyethylene terephthalate (PET). In yet another aspect, the polycarbonate component comprises polybutylene terephthalate (PBT).

In one aspect, the polycarbonate component can comprise a polycarbonate. In one aspect, it should be understood that the polycarbonate polymer that is present within the polycarbonate component can be present in any desired amount relative to the total amount of the thermoplastic polymer matrix. For example, in an aspect wherein the polycarbonate component comprises at least one polymer that is selected from the group consisting of a polycarbonate, a polycarbonate copolymer, a polyamide (PA), a polyetherimide (PEI), a PBT, and a PET, and wherein the polymer is a polycarbonate polymer, the polycarbonate polymer can be present in an amount in the range of from greater than 0 weight % to about 100 weight % relative to the total weight of the thermoplastic polymer matrix.

In another aspect, the polycarbonate component comprises a polyester polycarbonate copolymer. In one aspect, it should be understood that the polyester polycarbonate copolymer that is present within the thermoplastic polymer matrix can be present in any desired amount relative to the total amount of the thermoplastic polymer matrix. For example, in an aspect wherein the polycarbonate component at least one polymer that is selected from the group consisting of a polycarbonate, a polycarbonate copolymer, a PA, a PEI, a PBT, and a PET, and wherein the polymer is a polyester polycarbonate copolymer, the polyester polycarbonate copolymer can be present in an amount in the range of from greater than 0 weight % to about 100 weight % relative to the total weight of the thermoplastic polymer matrix.

In a yet further aspect, the polycarbonate component comprises a polyamide. In one aspect, it should be understood that the polyamide that is present within the polycarbonate component can be present in any desired amount relative to the total amount of the polycarbonate component. For example, in an aspect wherein the polycarbonate component comprises at least one polymer that is selected from the group consisting of a polycarbonate, a polycarbonate copolymer, a PA, a PEI, a PBT, and a PET, and wherein the polymer is a polyamide, the polyamide can be present in an amount in the range of from greater than 0 weight % to about 100 weight % relative to the total weight of the thermoplastic polymer matrix.

In one aspect, the polycarbonate component comprises a polyetherimide. In one aspect, it should be understood that the polyetherimide that is present within the polycarbonate component can be present in any desired amount relative to the total amount of the polycarbonate component. For example, in an aspect wherein the thermoplastic polymer comprises at least one polymer that is selected from the group consisting of a polycarbonate, a polycarbonate copolymer, a PA, a PEI, a PBT, and a PET, and wherein the polymer is a polyetherimide, the polyetherimide can be present in an amount in the range of from greater than 0 weight % to about 100 weight % relative to the total weight of the polycarbonate component.

In another aspect, the polycarbonate component matrix comprises a polybutylene terephthalate (PBT). In one aspect, it should be understood that the polybutylene terephthalate that is present within the polycarbonate component can be present in any desired amount relative to the total amount of the polycarbonate component. For example, in an aspect wherein the polycarbonate component comprises at least one polymer that is selected from the group consisting of a polycarbonate, a polycarbonate copolymer, a PA, a PEI, a PBT, and a PET, and wherein the polymer is a polybutylene terephthalate, the polybutylene terephthalate can be present in an amount in the range of from greater than 0 weight % to about 100 weight % relative to the total weight of the polycarbonate component.

In another aspect, the polycarbonate component comprises a PET. In one aspect, it should be understood that the polyethylene terephthalate that is present within the polycarbonate component can be present in any desired amount relative to the total amount of the polycarbonate component. For example, in an aspect wherein the polycarbonate component comprises at least one polymer that is selected from the group consisting of a polycarbonate, a polycarbonate copolymer, a PA, a PEI, a PBT, and a PET, and wherein the polymer is a polyethylene terephthalate, the polyethylene terephthalate can be present in an amount in the range of from greater than 0 weight % to about 100 weight % relative to the total weight of the thermoplastic polymer matrix.

In a still further aspect, the polycarbonate component has a weight average molecular weight of from about 15,000 g/mol to about 100,000 g/mol on an absolute polycarbonate molecular weight scale. In a still further aspect, the polycarbonate component has a weight average molecular weight of from about 20,000 g/mol to about 50,000 g/mol on an absolute polycarbonate molecular weight scale. In one aspect, the polycarbonate component comprises a first polycarbonate polymer and a second polycarbonate polymer. In one aspect, the polycarbonate can comprise two or more polycarbonates. For example, the polycarbonate can comprise two polycarbonates. The two polycarbonates can be present in about equal or different amount. In one aspect, the polycarbonates can be a part of a co-polymer, wherein at least one part of the co-polymer is not a polycarbonate. In another aspect, the polycarbonate comprises Lexan® polycarbonate available from SABIC Innovative Plastics, USA.

In a further aspect, the first polycarbonate polymer can be present in an amount from about 20 wt % to about 50 wt %. In a still further aspect, the first polycarbonate polymer is present in an amount from about 20 wt % to about 45 wt %. In a yet further aspect, the first polycarbonate polymer is present in an amount from about 20 wt % to about 40 wt %. In an even further aspect, the first polycarbonate polymer is present in an amount from about 20 wt % to about 35 wt %. In a still further aspect, the first polycarbonate polymer is present in an amount from about 20 wt % to about 30 wt %.

In a further aspect, the first polycarbonate polymer can be present in an amount from about 24 wt % to about 50 wt %. In a still further aspect, the first polycarbonate polymer is present in an amount from about 24 wt % to about 45 wt %. In a yet further aspect, the first polycarbonate polymer is present in an amount from about 24 wt % to about 40 wt %. In an even further aspect, the first polycarbonate polymer is present in an amount from about 24 wt % to about 35 wt %. In a still further aspect, the first polycarbonate polymer is present in an amount from about 24 wt % to about 30 wt %.

In a further aspect, the first polycarbonate polymer is present in an amount from about 25 wt % to about 50 wt %. In a still further aspect, the first polycarbonate polymer is present in an amount from about 25 wt % to about 45 wt %. In a yet further aspect, the first polycarbonate polymer is present in an amount from about 25 wt % to about 40 wt %. In an even further aspect, the first polycarbonate polymer is present in an amount from about 25 wt % to about 35 wt %. In a still further aspect, the first polycarbonate polymer is present in an amount from about 25 wt % to about 30 wt %.

In a further aspect, the second polycarbonate polymer is present in an amount from about 12 wt % to about 45 wt %. In a still further aspect, the second polycarbonate polymer is present in an amount from about 12 wt % to about 40 wt %. In a yet further aspect, the second polycarbonate polymer is present in an amount from about 12 wt % to about 35 wt %.

In a further aspect, the second polycarbonate polymer is present in an amount from about 11 wt % to about 45 wt %. In a still further aspect, the second polycarbonate polymer is present in an amount from about 11 wt % to about 40 wt %. In a yet further aspect, the second polycarbonate polymer is present in an amount from about 11 wt % to about 35 wt %.

In aspects where the polycarbonate component comprises a blend of two or more polycarbonate polymers, it should be understood that each respect polycarbonate polymer present within the polycarbonate component can be present in any desired amount relative to the total amount of the polycarbonate polymer component. For example, in an aspect wherein the polycarbonate polymer component comprises at least a first and a second polycarbonate polymer, the first polycarbonate polymer can be present in an amount in the range of from greater than 0 weight % to less than 100 weight % relative to the total weight of the polycarbonate polymer component. Similarly, the second polycarbonate polymer can also be present in an amount in the range of from greater than 0 weight % to less than 100 weight % relative to the total weight of the polycarbonate polymer component.

In still further aspects, the polycarbonate component of the disclosed thermoplastic polymer blend compositions can comprise a polycarbonate-polysiloxane block copolymer component. As used herein, the term polycarbonate-polysiloxane copolymer is equivalent to polysiloxane-polycarbonate copolymer, polycarbonate-polysiloxane polymer, or polysiloxane-polycarbonate polymer. The polysiloxane-polycarbonate copolymer comprises polydiorganosiloxane blocks comprising structural units of the general formula (I) below:

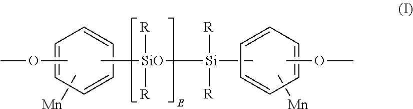

wherein the polydiorganosiloxane block length (E) is from about 20 to about 60; wherein each R group can be the same or different, and is selected from a C₁₋₁₃ monovalent organic group; wherein each M can be the same or different, and is selected from a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, and where each n is independently 0, 1, 2, 3, or 4. The polysiloxane-polycarbonate copolymer also comprises polycarbonate blocks comprising structural units of the general formula (II) below:

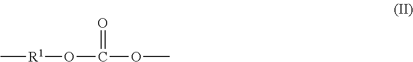

wherein at least 60 percent of the total number of R¹ groups comprise aromatic moieties and the balance thereof comprise aliphatic, alicyclic, or aromatic moieties.

According to exemplary non-limiting aspects of the disclosure, the polycarbonate-polysiloxane block copolymer comprises diorganopolysiloxane blocks of the general formula (III) below:

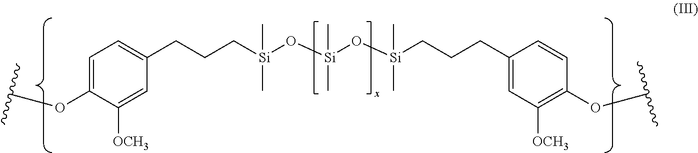

wherein x represents an integer from about 20 to about 60. The polycarbonate blocks according to these aspects can be derived from bisphenol-A monomers.

Diorganopolysiloxane blocks of formula (III) above can be derived from the corresponding dihydroxy compound of formula (IV):

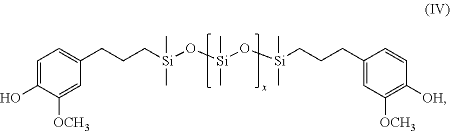

wherein x is as described above. Compounds of this type and others are further described in U.S. Pat. No. 4,746,701 to Kress, et al and U.S. Pat. No. 8,017,697 to Carrillo. Compounds of this formula can be obtained by the reaction of the appropriate dihydroxyarylene compound with, for example, an alpha, omega-bisacetoxypolydiorangonosiloxane under phase transfer conditions.

Such dihydroxy polysiloxanes can be made by effecting a platinum catalyzed addition between a siloxane hydride of the formula (V):

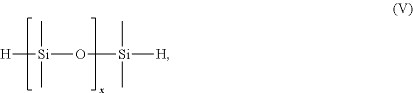

wherein x is a previously defined, and an aliphatically unsaturated monohydric phenol such as eugenol to yield a compound of formula (IV).

The polycarbonate-polysiloxane copolymer may be manufactured by reaction of a diphenolic polysiloxane, such as that depicted by formula (IV), with a carbonate source and a dihydroxy aromatic compound such as bisphenol-A, optionally in the presence of a phase transfer catalyst as described above. Suitable conditions are similar to those useful in forming polycarbonates. For example, the copolymers can be prepared by phosgenation at temperatures from below 0° C. to about 100° C., including for example, at temperatures from about 25° C. to about 50° C. Since the reaction is exothermic, the rate of phosgene addition can be used to control the reaction temperature. The amount of phosgene required will generally depend upon the amount of the dihydric reactants. Alternatively, the polycarbonate-polysiloxane copolymers can be prepared by co-reacting, in a molten state, the dihydroxy monomers and a diaryl carbonate ester, such as diphenyl carbonate, in the presence of a transesterification catalyst as described above.

In the production of the polycarbonate-polysiloxane copolymer, the amount of dihydroxy diorganopolysiloxane can be selected so as to provide the desired amount of diorganopolysiloxane units in the copolymer. The particular amounts used will therefore be determined depending on desired physical properties of the composition, the value of x (for example, within the range of about 20 to about 60), and the type and relative amount of each component in the composition, including the type and amount of polycarbonate, type and amount of polycarbonate-polysiloxane copolymer, and type and amount of any other additives. Suitable amounts of dihydroxy diorganopolysiloxane can be determined by one of ordinary skill in the art without undue experimentation using the guidelines taught herein.

For example, according to aspects of the disclosure, the polysiloxane-polycarbonate block copolymer can be provided having any desired level of siloxane content. For example, the siloxane content can be in the range of from 4 mole % to 20 mole %. In additional aspects, the siloxane content of the polysiloxane-polycarbonate block copolymer can be in the range of from 4 mole % to 10 mole %. In still further aspects, the siloxane content of the polysiloxane-polycarbonate block copolymer can be in the range of from 4 mole % to 8 mole %. In a further aspect, the polysiloxane-polycarbonate copolymer comprises a diorganosiloxane content in the range of from 5 to 7 mole wt. %. In still other aspects, the siloxane content of the polysiloxane-polycarbonate block copolymer can be about 6 mole %. Still further, the diorganopolysiloxane blocks can be randomly distributed in the polysiloxane-polycarbonate block copolymer.

The disclosed polysiloxane-polycarbonate block copolymers can also be end-capped as similarly described in connection with the manufacture of polycarbonates set forth herein. For example, according to aspects of the disclosure, a polysiloxane-polycarbonate block copolymer can be end capped with p-cumyl-phenol.

In one aspect, a non-limiting example of a polycarbonate-siloxane copolymer includes transparent EXL, available from SABIC Innovative Plastics. The transparent EXL from SABIC is a polycarbonate-polysiloxane (C9030T) copolymer, having been tested commercially and found to have about 6 mole % siloxane, a Mw of about 44,600, and a Mn of about 17,800 in a polystyrene standard using chloroform solvent.

The polysiloxane polycarbonate copolymer component can be present in the polycarbonate composition in any desired amount. In one aspect, the polycarbonate-polysiloxane copolymer component is a polycarbonate-polydimethylsiloxane copolymer. In another aspect, the polycarbonate portion of the polycarbonate-polysiloxane copolymer comprises residues derived from BPA. In still another aspect, the polycarbonate portion of the polycarbonate-polysiloxane copolymer comprising residues derived from BPA is a homopolymer. In still another aspect, the polycarbonate-polysiloxane copolymer component comprises a polycarbonate-polysiloxane block copolymer.

In one aspect, the polycarbonate-polysiloxane block copolymer comprises a polycarbonate-polydimethylsiloxane block copolymer. In another aspect, the polycarbonate block comprises residues derived from BPA. In still other aspect, the polycarbonate block comprising residues derived from BPA is a homopolymer.

### Flame Retardant

As noted above, it can be challenging to achieve a desired flame retardancy without adversely affecting the desirable physical properties of the compositions, such as, for example, maintaining molecular weight. In various aspects, the inventive compositions and methods disclosed herein can provide a desirable flame retardancy while maintaining physical properties of the composition. The blended polycarbonate composition of the present disclosure can comprise an optional flame retardant additive. In one aspect, the flame retardant additive can comprise an organic compound containing phosphorus, such as, for example, an organophosphorus compound. In still another aspect, the flame retardant comprises an organophosphorus compound comprising an aliphatic metal phosphinate. In yet another aspect, the flame retardant comprises a bis-phenol A diphenyl phosphonate (BPADP), for example, available from Supresta.

In one aspect, the flame retardant (FR) additive comprises a halogen. In yet another aspect, the flame retardant additive is free of or substantially free of any halogen such as bromine and/or chlorine. In still another aspect, at least a portion of the flame retardant additive is free of or substantially free of bromine and/or chlorine. In another aspect, the flame retardant additive comprises phosphorus such as phosphate (BPADP, RDP, Sol-DP), phosphine oxide (TPPO), phosphonate (FRX-100), phosphinate (DOPO), and phosphazene. In still other aspects, the phosphorus-containing FR is the primary FR. And in another aspect, the FR additive is PTFE-based, optionally provided with a phosphorus-containing FR. It is understood however that in facilities that process multiple products a certain amount of cross contamination can occur resulting in bromine and/or chlorine levels typically on the parts per million by weight scale. With this understanding it can be readily appreciated that essentially free of bromine and chlorine can be defined as having a bromine and/or chlorine content of less than or equal to about 100 parts per million by weight (ppm), less than or equal to about 75 ppm, or less than or equal to about 50 ppm. When this definition is applied to the fire retardant it is based on the total weight of the fire retardant. When this definition is applied to the thermoplastic composition it is based on the total weight of the composition, excluding any filler.

In one aspect, the flame retardant additive or a portion thereof comprises an organic phosphate and/or an organic compound containing a phosphorus-nitrogen bond. In one aspect, exemplary flame retardant compounds containing phosphorus-nitrogen bonds include phosphonitrilic chloride, phosphorus ester amides, phosphoric acid amides, phosphonic acid amides, phosphinic acid amides, tris(aziridinyl)phosphine oxide.

In another aspect, an exemplary organic phosphate is an aromatic phosphate of the formula (GO)₃P═O, wherein each G is independently an alkyl, cycloalkyl, aryl, alkylaryl, or aralkyl group, provided that at least one G is an aromatic group. Two of the G groups can be joined together to provide a cyclic group, for example, diphenyl pentaerythritol diphosphate. Exemplary aromatic phosphates include, phenyl bis(dodecyl)phosphate, phenyl bis(neopentyl)phosphate, phenyl bis(3,5,5′-trimethylhexyl)phosphate, ethyl diphenyl phosphate, 2-ethylhexyl di(p-tolyl)phosphate, bis(2-ethylhexyl)p-tolyl phosphate, tritolyl phosphate, bis(2-ethylhexyl)phenyl phosphate, tri(nonylphenyl)phosphate, bis(dodecyl)p-tolyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. In one aspect, the flame retardant of the present disclosure comprises BPADP. In still other aspects, the flame retardant can comprise a mixture of two or more individual flame retardant compositions.

While not wishing to be bound by theory, the addition of a flame retardant additive, such as, for example, a bis-phenol A diphenylphosphonate, can improve the flame retardancy of the resulting polycarbonate material, but can also result in a decreased molecular weight retention.

In some aspects, the flame retardants can be present in ranges bounded at the lower end by a value of 0, about 0.1 wt %, about 2 wt %, about 4 wt %, about 6 wt %, about 8 wt %, or about 10 wt %, and bounded at the upper end by a value of about 25 wt %, about 20 wt %, about 15 wt %, about 10 wt %, about 8 wt %, or about 6 wt %, relative to the total weight of the composition. One exemplary, non-limiting range is from about 0 to about 25 wt %, relative to the weight of the entire composition.

In various aspects, where present, the flame retardant, including the phosphorus-containing flame retardant of the present disclosure can be present in amounts of from about 10 wt. % to about 25 wt. % of the total composition, for example, about 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, or 25 wt. %; or from about 10 wt. % to about 15 wt. %, for example, about 10, 10.5, 11, 11.5, 12, 12.5, 13, 13.5, 14, 14.5, or 15 wt. %. In another aspect, the phosphorus-containing flame retardant of the present disclosure can be present at about 20 wt. % of the composition. In other aspects, the amount of flame retardant present in the compositions of the present disclosure can be less than about 10 wt. % or greater than about 25 wt. %, and the present disclosure is not intended to be limited to any particular concentration.

### Fillers

The blended polycarbonate composition further comprises one or more fillers. The filler can be selected to impart additional impact strength and/or provide additional characteristics that can be based on the final selected characteristics of the polymer composition. The specific composition of a filler can vary, provided that the filler is chemically compatible with the remaining components of the polymer composition. In some aspects, the filler(s) comprise inorganic materials.

In another aspect, the filler comprises, for example, clay; TiO₂; fibers comprising asbestos or the like fibers; silicates and silica powders, aluminum silicate (mullite), synthetic calcium silicate, zirconium silicate, fused silica, crystalline silica graphite, natural silica sand, or the like; boron powders, boron-nitride powder, boron-silicate powders, or the like; alumina; magnesium oxide (magnesia); calcium sulfate (as its anhydride, dihydrate or trihydrate); calcium carbonates, chalk, limestone, marble, synthetic precipitated calcium carbonates, or the like; talc, including but not limited to fibrous, modular, needle shaped, lamellar talc, or the like; wollastonite; surface-treated wollastonite; glass spheres including but not limited to hollow and solid glass spheres, silicate spheres, cenospheres, aluminosilicate (armospheres), or the like; kaolin, including but not limited to hard kaolin, soft kaolin, calcined kaolin, kaolin including various coatings known in the art to facilitate compatibility with the polymeric matrix resin, or the like; single crystal fibers or “whiskers” including but not limited to silicon carbide, alumina, boron carbide, iron, nickel, copper, or the like; glass fibers, (including continuous and chopped fibers), including but not limited to E, A, C, ECR, R, S, D, and NE glasses and quartz, or the like; sulfides including but not limited to molybdenum sulfide, zinc sulfide or the like; barium compounds including but not limited to barium titanate, barium ferrite, barium sulfate, heavy spar, or the like; metals and metal oxides including but not limited to particulate or fibrous aluminum, bronze, zinc, copper and nickel or the like; flaked fillers including but not limited to as glass flakes, flaked silicon carbide, aluminum diboride, aluminum flakes, steel flakes or the like; fibrous fillers, for example short inorganic fibers including but not limited to those derived from blends including at least one of aluminum silicates, aluminum oxides, magnesium oxides, and calcium sulfate hemihydrate or the like; natural fillers and reinforcements, including but not limited to wood flour obtained by pulverizing wood, fibrous products such as cellulose, cotton, sisal, jute, starch, cork flour, lignin, ground nut shells, corn, rice grain husks or the like; reinforcing organic fibrous fillers formed from organic polymers capable of forming fibers including but not limited to poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents including but not limited to mica, clay, feldspar, flue dust, fillite, quartz, quartzite, perlite, tripoli, diatomaceous earth, carbon black, or the like, or combinations including at least one of the foregoing fillers or reinforcing agents.

In one aspect, the filler comprises an inorganic filler. In one aspect, the disclosed wear resistant polymer composition further comprises an inorganic filler comprising a carbon fiber, carbon black, glass fiber, aramid fiber, talc, clay or a combination thereof.

In a yet further aspect, the inorganic filler comprises a glass fiber, wherein the glass fiber has a cross section that can be round or flat. In another aspect, the glass fiber, for example, can be Nittobo (flat) glass fiber, CSG3PA820. In an even further aspect, the glass bead has a cross section that is round or flat.

The inorganic filler can be present in the polymer composition in an amount in the range of from about 2% by weight to about 50% by weight, including exemplary values of 2% by weight, 3% by weight, 4% by weight, 5% by weight, 6% by weight, 7% by weight, 8% by weight, 9% by weight, 10% by weight, 11% by weight, 12% by weight, 13% by weight, 14% by weight, 15% by weight, 16% by weight, 17% by weight, 18% by weight, 19% by weight, 20% by weight, 21% by weight, 22% by weight, 23% by weight, 24% by weight, 25% by weight, 26% by weight, 27% by weight, 28% by weight, 29% by weight, 30% by weight, 31% by weight, 32% by weight, 33% by weight, 34% by weight, 35% by weight, 36% by weight, 37% by weight, 38% by weight, 39% by weight, 40% by weight, 41% by weight, 42% by weight, 43% by weight, 44% by weight, 45% by weight, 46% by weight, 47% by weight, 48% by weight, 49% by weight, and 50% by weight. In still further aspects, the composition can comprise the inorganic filler in any range derived from any two values set forth above. For example, the inorganic filler can be present from about 5% by weight to about 25% by weight, from about 10% by weight to about 20% by weight, or from about 15% by weight to about 20% by weight.

### Impact Modifier

The blended polycarbonate composition of the present disclosure comprises one or more impact modifying agents, or impact modifiers. In one aspect, suitable impact modifiers can be high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. In another aspect, a combination of any two or more individual impact modifiers can be used.

An exemplary type of impact modifier is an elastomer-modified graft copolymer comprising an elastomeric (i.e., rubbery) polymer substrate having a T_{g} less than about 10° C., less than about −10° C., or about −40° C. to −80° C., or about −40° C. to −112° C. and a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than about 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl(meth)acrylates; elastomeric copolymers of C₁₋₈ alkyl(meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁₋₆ esters of acrylic acid and methacrylic acid, specifically methyl methacrylate.

Specific exemplary elastomer-modified graft copolymers include those formed from ASA (acrylate-styrene-acrylonitrile), styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). In another aspect, an impact modifier can comprise an acrylic impact modifier, such as, for example, a DURASTRENGTH® impact modifier, available from Arkema Inc., Philadelphia, Pa., USA. In another aspect, an impact modifier can comprise an ABS and/or bulk ABS material. In yet another aspect, an impact modifer can comprise a polysiloxane-polycarbonate copolymer (PC-ST), for example, comprising units derived from BPA and dimethylsiloxane. In another aspect, an impact modifer can comprise a core-shell impact modifier, such as, for example, a silicone-acrylic rubber compound (e.g., silicone elastomer core and MMA copolymer shell; METABLEN® S-2001, available from Mitsubishi Rayon Co., Ltd.). In yet another aspect, an impact modifier can comprise two or more individual impact modifying compounds, such as, for example, PC-ST and METABLEN®.

In another aspect, polyethylene (PE) copolymers may be used, and are shown in the examples to provide a higher efficiency than ABS, MBS, acrylic (PMMA shell and PBA core), acrylic-silicone type (S-2001 type in examples) modifiers.

In one aspect, an impact modifiers can comprise from about 1 wt. % to 25 wt. %, for example, about 1, 2, 4, 6, 8, 10, 12, 14, 18, 20, 22, 24 or 25 wt. %, or a combination thereof, based on the total weight of the blended polycarbonate composition, and any additional polymer including impact modifier, in the composition. In another aspect, an impact modifier or combination of impact modifiers can comprise from about 1 wt. % to about 15 wt. %, for example, about 1, 3, 5, 7, 9, 11, 13, or 15 wt. %, from about 1 wt. % to about 10 wt. %, for example, about 1, 2, 3, 4, 5, 6, 7, 8, 9, or 10 wt. %, or from about 1 wt. % to about 7 wt. %, for example, about 2, 2.5, 3, 3.5, or 4 wt. %. In one aspect the blended polycarbonate composition comprises approximately equal amounts (i.e., by wt. %) of a EXL impact modifier and a METABLEN® impact modifier. In one aspect, a thermoplastic composition can comprise from about 2 wt. % to about 5 wt. % of EXL and from about 1 wt. % to about 5 wt. % of METABLEN®. In a specific aspect, a polycarbonate composition comprises about 3 wt. % EXL and about 2.5 wt. % METABLEN® impact modifier. In other aspects, the a specific amount of any one or more impact modifiers can vary, based on the remaining components in the system and desired properties of the resulting polymer. One of skill in the art, in possession of this disclosure, could readily select an appropriate amount of any one or more impact modifiers to use in a polymer composition.

In one aspect, the addition of a single impact modifier can provide modest improvements to the impact performance of a flame retardant polycarbonate. While not wishing to be bound by theory, it is believed that the combination of multiple impact modifiers can provide a synergistic improvement over conventional systems. In a specific aspect, addition of both EXL and METABLEN® impact modifiers can provide a synergistic improvement of up to, for example, a three-fold increase in impact properties.

### Polymer Compatibilizer

In one aspect, the blended polymer composition comprises polymer compatibilizers. In one aspect, suitable compatibilizers can be polyolefins functionalized with glycidyl groups. In another aspect, suitable polymer compatibilizers can be polyolefins functionalized with maleic anhydride.

In another aspect, polyolefins functionalized with maleic anhydride (MAH) can comprise maleic anhydride grafting polyethylene or polypropylene polymers. In still a further aspect, maleic anhydride grafting polyethylene copolymer may be ethylene-propylene polymer, ethylene-propylene-diene terpolymer (MAH-g-EPDM), ethylene-octene copolymer (MAH-g-POE), ethylene-butene copolymer (MAH-g-EBR), ethylene-acrylic ester copolymer (MAH-g-EAE). In yet another aspect, the maleic anhydride grafting polyethylene copolymer may be styrene-ethylene/butadiene-styrene (MAH-g-SEBS), Acrylonitrile-butadiene-styrene (MAH-g-ABS).

In another aspect, the blended polycarbonate/polyester composition comprises about 0.5 wt. % to about 8 wt. % of a polymer compatibilizer. In still another aspect, the blended polycarbonate/polyester composition comprises about 1 wt. % to about 4 wt. % of a polymer compatibilizer. In still another aspect, the polycarbonate and/or polyester blended composition comprises about 1 wt. % to about 2 wt. % of a polymer compatibilizer.

In one aspect, the blended polycarbonate and/or polyester composition comprises about 0.5 wt. % to about 8 wt. % of an ethylene-propylene polymer (MAH-g-EPM). In still another aspect, the polycarbonate and/or polyester blend composition comprises about 1 wt. % to about 4 wt. % of a MAH-g-EPM. In still another aspect, the polycarbonate and/or polyester blended composition comprises about 1 wt. % to about 2 wt. % of a MAH-g-EPM.

In one aspect, the blended polycarbonate and/or polyester composition comprises about 0.5 wt. % to about 8 wt. % of ethylene-propylene-diene terpolymer (MAH-g-EPDM). In still another aspect, the polycarbonate and/or polyester blend composition comprises about 1 wt. % to about 4 wt. % of a MAH-g-EPDM. In still another aspect, the polycarbonate and/or polyester blended composition comprises about 1 wt. % to about 2 wt. % of a MAH-g-EPDM.

In one aspect, the blended polycarbonate and/or polyester composition comprises about 0.5 wt. % to about 8 wt. % of ethylene-octene copolymer (MAH-g-POE). In still another aspect, the polycarbonate and/or polyester blend composition comprises about 1 wt. % to about 4 wt. % of a MAH-g-POE. In still another aspect, the polycarbonate and/or polyester blended composition comprises about 1 wt. % to about 2 wt. % of a MAH-g-POE.

In one aspect, the blended polycarbonate and/or polyester composition comprises about 0.5 wt. % to about 8 wt. % of ethylene-butene copolymer (MAH-g-EBR). In still another aspect, the polycarbonate and/or polyester blend composition comprises about 1 wt. % to about 4 wt. % of a MAH-g-EBR. In still another aspect, the polycarbonate and/or polyester blended composition comprises about 1 wt. % to about 2 wt. % of a MAH-g-EBR.

In one aspect, the blended polycarbonate and/or polyester composition comprises about 0.5 wt. % to about 8 wt. % of styrene-ethylene/butadiene-styrene (MAH-g-SEBS). In still another aspect, the polycarbonate and/or polyester blend composition comprises about 1 wt. % to about 4 wt. % of a MAH-g-SEBS. In still another aspect, the polycarbonate and/or polyester blended composition comprises about 1 wt. % to about 2 wt. % of a MAH-g-SEBS.

In one aspect, the blended polycarbonate and/or polyester composition comprises about 0.5 wt. % to about 8 wt. % of MAH-g-EAE In still another aspect, the polycarbonate and/or polyester blend composition comprises about 1 wt. % to about 4 wt. % of a MAH-g-EAE. In still another aspect, the polycarbonate and/or polyester blended composition comprises about 1 wt. % to about 2 wt. % of a MAH-g-EAE.

In one aspect, the blended polycarbonate and/or polyester composition comprises about 0.5 wt. % to about 8 wt. % of MAH-g-ABS In still another aspect, the polycarbonate and/or polyester blend composition comprises about 1 wt. % to about 4 wt. % of a MAH-g-ABS. In still another aspect, the polycarbonate and/or polyester blended composition comprises about 1 wt. % to about 2 wt. % of a MAH-g-ABS.

### Other Additives

In addition to the foregoing components, the disclosed blended polycarbonate and/or polyester composition can optionally comprise a balance amount of one or more additive materials ordinarily incorporated in polycarbonate and/or polyester resin compositions of this type, with the proviso that the additives are selected so as to not significantly adversely affect the desired properties of the blended polycarbonate and/or polyester composition. Combinations of additives can be used. Such additives can be mixed at a suitable time during the mixing of the components for forming the composition. Exemplary and non-limiting examples of additive materials that can be present in the disclosed polycarbonate and/or polyester compositions include an antioxidant, a stabilizer (including for example a heat stabilizer, a hydrolytic stabilizer, or a light stabilizer), UV absorbing additive, plasticizer, lubricant, mold release agent, processing aid, antistatic agent, colorant (e.g., pigment and/or dye), or any combination thereof.

In a further aspect, the disclosed blended polycarbonate and/or polyester composition can further comprise a primary antioxidant or “stabilizer” (e.g., a hindered phenol) and, optionally, a secondary antioxidant (e.g., a phosphate and/or thioester). Suitable antioxidant additives include, for example, organic phosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants are generally used in amounts of about 0.01 wt % to about 1 wt %, optionally about 0.05 wt % to about 0.5 wt % of the polycarbonate and/or polyester blend composition.

In various aspects, the disclosed blended polycarbonate and/or polyester composition further comprises a hydrolytic stabilizer, wherein the hydrolytic stabilizer comprises a hydrotalcite and an inorganic buffer salt. In a further aspect, the disclosed blended polycarbonate and/or polyester composition comprises a hydrolytic stabilizer, wherein the hydrolytic stabilizer comprises one or more hydrotalcites and an inorganic buffer salt comprising one or more inorganic salts capable of pH buffering. Either synthetic hydrotalcites or natural hydrotalcites can be used as the hydrotalcite compound in the present disclosure. Exemplary hydrotalcites that are useful in the compositions of the present are commercially available and include, but are not limited to, magnesium hydrotalcites such as DHT-4C (available from Kyowa Chemical Co.); Hysafe 539 and Hysafe 530 (available from J.M. Huber Corporation).

In a further aspect, suitable heat stabilizer additives include, for example, organic phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, organic phosphates such as trimethyl phosphate, thioesters such as pentaerythritol betalaurylthiopropionate, and the like, or combinations comprising at least one of the foregoing heat stabilizers. Heat stabilizers are generally used in amounts of about 0.01 wt % to about 5 wt %, optionally about 0.05 wt % to about 0.3 wt % of the polycarbonate blend composition.

In a further aspect, light stabilizers and/or ultraviolet light (UV) absorbing additives can also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and benzophenones such as 2-hydroxy-4-n-octoxy benzophenone, or the like, or combinations comprising at least one of the foregoing light stabilizers. Light stabilizers are generally used in amounts of about 0.01 wt % to about 10 wt %, optionally about 0.1 wt % to about 1 wt % of the blended polycarbonate and/or polyester composition.

In a further aspect, suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenyl-acryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers. UV absorbers are generally used in amounts of about 0.1 wt % to about 5 wt % of the blended polycarbonate and/or polyester composition.

In one aspect, the inventive blended polycarbonate and/or polyester composition comprises an epoxy, such as, for example, a dime acid diglycidyl ester epoxy (DADGE®, available from Aldrich), a 3,4-epoxy cyclohexyl methyl-3,4-epoxy cyclohexane carboxylate (ERL-4221, available from Aldrich), a modified styrene acrylic polymer (ADR-4368F, available from Aldrich), or a combination thereof. In other aspects, the inventive blended polycarbonate and/or polyester composition can comprise an epoxy material not specifically recited herein, provided that such an epoxy material is chemically compatible with the remaining components of the composition and that the epoxy material does not adversely affect the desired properties of the composition. In one aspect, the inventive polycarbonate and/or polyester comprises DADGE. In another aspect, the inventive blended polycarbonate and/or polyester composition comprises ERL-4221. In yet another aspect, the inventive blended polycarbonate and/or polyester composition comprises ADR-4368F. In another aspect, the inventive polycarbonate and/or polyester does not comprise an epoxy. An epoxy material, if present, can be present at any concentration that can maintain or improve the properties of the resulting material. In various aspects, an epoxy material can be present in an amount of from about 0.1 wt. % to about 5 wt. %, for example, about 0.1, 0.3, 0.5, 0.7, 0.9, 1, 1.2, 1.4, 1.6, 1.8, 2, 2.5, 3, 3.5, 4, 4.5, or 5 wt. %; or from about 0.5 wt. % to about 1.0 wt. %, for example, about 0.5, 0.6, 0.7, 0.8, 0.9, or 1 wt. %. In other aspects, an epoxy material can be present in an amount less than about 0.1 wt. % or greater than about 5 wt. %, and the present disclosure is not intended to be limited to any particular epoxy concentration. In one aspect, a polycarbonate and/or polyester material comprises about 0.5% of an epoxy material, such as, for example, ADR-4368F. In another aspect, a polycarbonate and/or polyester material comprises about 1.0 wt. % of an epoxy material, such as, for example, ADR-4368F.

In one aspect, the presence of an epoxy material can provide improved flame retardancy, improved retention of molecular weight, or a combination thereof. In a specific aspect, a polycarbonate and/or polyester composition comprising ADR-4368F can exhibit an improved molecular weight retention of up to about 85%, while also improving the flame retardancy properties of the material.

In another aspect, the inventive blended polycarbonate and/or polyester composition can comprise one or more anti-drip agents. In various aspects, an anti-drip agent, if present, can comprise a fibril forming or non-fibril forming fluoropolymer, such as, for example, polytetrafluoroethylene (PTFE). In another aspect, an anti-drip agent, if present, can be encapsulated by a rigid copolymer, such as, for example, a styrene-acrylonitrile copolymer (SAN). In one aspect, the inventive polycarbonate and/or polyester composition comprises PTFE encapsulated in SAN (TSAN). In various aspects, encapsulated fluoropolymers can be made by polymerizing the encapsulating polymer in the presence of the fluoropolymer, for example, in an aqueous dispersion.

In one aspect, TSAN can provide significant advantages over PTFE, in that TSAN can be more readily dispersed in the composition. An exemplary TSAN can comprise about 50 wt. % PTFE and about 50 wt. % SAN, based on the total weight of the encapsulated fluoropolymer. The SAN can comprise, for example, about 75 wt. % styrene and about 25 wt. % acrylonitrile based on the total weight of the copolymer. Alternatively, the fluoropolymer can be pre-blended in some manner with a second polymer, such as for, example, an aromatic polycarbonate resin or SAN to form an agglomerated material for use as an anti-drip agent. Either method can be used to produce an encapsulated fluoropolymer. In one aspect, the inventive blended polycarbonate and/or polyester composition can comprise from about 0.1 wt. % to about 10 wt. %, for example, about 0.1, 0.2, 0.3, 0.5, 0.7, 0.9, 1, 3, 5, 7, 9, or 10 wt. % of an anti-drip agent, based on 100 percent by weight of isosorbide-based polycarbonate, and any additional polymer that can optionally be present. In another aspect, the inventive blended polycarbonate and/or polyester composition can comprise from about 0.1 wt. % to about 1 wt. %, for example, about 0.1, 0.2, 0.3, 0.4, 0.5, 0.6, 0.7, 0.8, 0.9, or 1 wt. %, or from about 0.5 wt. % to about 1.5 wt. %, for example, about 0.5, 0.6, 0.7, 0.8, 0.9, 1, 1.1, 1.2, 1.3, 1.4, or 1.5 wt. % of an anti-drip agent, based on 100 percent by weight of isosorbide-based polycarbonate, and any additional polymer that can optionally be present. In one aspect, the inventive polycarbonate and/or polyester composition comprises about 0.5 wt. % TSAN. Anti-drip agents are commercially available, and one of skill in the art, in possession of this disclosure, could readily select an appropriate anti-drip agent, if desired.

In various aspects, an anti-drip agent, if present, can provide at least one of improved flame retardancy, increased HDT, improved molecular weight retention, or a combination thereof. In one aspect, an inventive blended polycarbonate composition comprising a TSAN anti-drip agent can exhibit improved flame retardance, increased HDT, and improved molecular weight retention.

Manufacture of Blended Polycarbonate and/or Polyester Compositions

In various aspects, the blended polycarbonate and/or polyester composition can be manufactured by various methods. The compositions of the present disclosure can be blended, compounded, or otherwise combined with the aforementioned ingredients by a variety of methods involving intimate admixing of the materials with any additional additives desired in the formulation. Because of the availability of melt blending equipment in commercial polymer processing facilities, melt processing methods can be used. In various further aspects, the equipment used in such melt processing methods includes, but is not limited to, the following: co-rotating and counter-rotating extruders, single screw extruders, co-kneaders, disc-pack processors and various other types of extrusion equipment. In a further aspect, the extruder is a twin-screw extruder. In various further aspects, the melt processed composition exits processing equipment such as an extruder through small exit holes in a die. The resulting strands of molten resin are cooled by passing the strands through a water bath. The cooled strands can be chopped into small pellets for packaging and further handling.

The temperature of the melt is minimized in order to avoid excessive degradation of the resins. For example, it can be desirable to maintain the melt temperature between about 230° C. and about 350° C. in the molten resin composition, although higher temperatures can be used provided that the residence time of the resin in the processing equipment is kept short. In a still further aspect, the extruder is typically operated at a temperature of about 180° C. to about 385° C. In a yet further aspect, the extruder is typically operated at a temperature of about 200° C. to about 330° C. In an even further aspect, the extruder is typically operated at a temperature of about 220° C. to about 300° C.

In various aspects, the blended polycarbonate and/or polyester compositions of the present disclosure can be prepared by blending the polycarbonate and/or polyester component powder or pellets, flame retardant, impact modifier, other additives in mixer e.g., a HENSCHEL-Mixer® high speed mixer or other suitable mixer/blender. Other low shear processes, including but not limited to hand mixing, can also accomplish this blending. The mixture can then be fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch desired polymeric resin and fed into the extruder. The extruder is generally operated at a temperature higher than that necessary to cause the composition to flow. The extrudate is immediately quenched in a water bath and pelletized. The pellets, so prepared, when cutting the extrudate can be one-fourth inch long or less as desired. Such pellets can be used for subsequent molding, shaping, or forming.

### Articles of Manufacture

In various aspects, the disclosed blended polycarbonate and/or polyester compositions of the present disclosure can be used in making articles. The disclosed blended polycarbonate and/or polyester compositions can be formed into useful shaped articles by a variety of means such as; injection molding, extrusion, rotational molding, compression molding, blow molding, sheet or film extrusion, profile extrusion, gas assist molding, structural foam molding and thermoforming. The blended polycarbonate and/or polyester compositions described herein resins can also be made into film and sheet as well as components of laminate systems. In a further aspect, in an embodiment, a method of manufacturing an article comprises melt blending the polycarbonate and/or polyester polymer composition, the recycled polymer, the acid melt flow stabilizer and optionally the flame retardant and molding the extruded composition into an article. In a still further aspect, the extruding is done with a twin-screw extruder.

Formed articles include, for example, computer and business machine housings, home appliances, trays, plates, handles, helmets, automotive parts such as instrument panels, cup holders, glove boxes, interior coverings and the like. In various further aspects, formed articles include, but are not limited to, food service items, medical devices, animal cages, electrical connectors, enclosures for electrical equipment, electric motor parts, power distribution equipment, communication equipment, computers and the like, including devices that have molded in snap fit connectors. In a further aspect, articles of the present disclosure comprise exterior body panels and parts for outdoor vehicles and devices including automobiles, protected graphics such as signs, outdoor enclosures such as telecommunication and electrical connection boxes, and construction applications such as roof sections, wall panels and glazing. Multilayer articles made of the disclosed polycarbonates and/or polyester particularly include articles which will be exposed to UV-light, whether natural or artificial, during their lifetimes, and most particularly outdoor articles; i.e., those intended for outdoor use. Suitable articles are exemplified by enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; articles made from plastic-wood combinations; golf course markers; utility pit covers; computer housings; desk-top computer housings; portable computer housings; lap-top computer housings; palm-held computer housings; monitor housings; printer housings; keyboards; facsimile machine housings; copier housings; telephone housings; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications.

In one aspect, the present disclosure pertains to articles comprising the disclosed blended polycarbonate and/or polyester compositions. In a further aspect, the article comprising the disclosed blended polycarbonate and/or polyester compositions is used in automotive applications. In a yet further aspect, the article used in automotive applications is selected from instrument panels, overhead consoles, interior trim, center consoles, panels, quarter panels, rocker panels, trim, fenders, doors, deck lids, trunk lids, hoods, bonnets, roofs, bumpers, fascia, grilles, minor housings, pillar appliqués, cladding, body side moldings, wheel covers, hubcaps, door handles, spoilers, window frames, headlamp bezels, headlamps, tail lamps, tail lamp housings, tail lamp bezels, license plate enclosures, roof racks, and running boards. In an even further aspect, the article comprising the disclosed blended polycarbonate and/or polyester compositions is selected from mobile device exteriors, mobile device covers, enclosures for electrical and electronic assemblies, protective headgear, buffer edging for furniture and joinery panels, luggage and protective carrying cases, small kitchen appliances, and toys.

In one aspect, the present disclosure pertains to electrical or electronic devices comprising the disclosed blended polycarbonate and/or polyester compositions. In a further aspect, the electrical or electronic device comprising the disclosed blended polycarbonate and/or polyester compositions is a cellphone, a MP3 player, a computer, a laptop, a camera, a video recorder, an electronic tablet, a pager, a hand receiver, a video game, a calculator, a wireless car entry device, an automotive part, a filter housing, a luggage cart, an office chair, a kitchen appliance, an electrical housing, an electrical connector, a lighting fixture, a light emitting diode, an electrical part, or a telecommunications part.

Without further elaboration, it is believed that one skilled in the art can, using the description herein, utilize the present disclosure. The following examples are included to provide addition guidance to those skilled in the art of practicing the claimed disclosure. The examples provided are merely representative of the work and contribute to the teaching of the present disclosure. Accordingly, these examples are not intended to limit the disclosure in any manner.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior disclosure. Further, the dates of publication provided herein can be different from the actual publication dates, which can require independent confirmation.

### ASPECTS

The present disclosure comprises at least the following aspects.

Aspect 1: A blended polymer composition with improved impact performance, comprising: a polymer component comprising from about 0.1 wt. % to about 90 wt. % of a polycarbonate or from about 0.1 wt. % to about 90 wt. % of a polyester, or a combination of both; a filler component present in an amount ranging from about 2 wt. % to about 50 wt. % of; an impact modifier present in an amount ranging from about 0.5 wt. % to about 25 wt. %; a polymer compatibilizer present in an amount ranging from about 0.5 wt. % to about 8 wt. %; wherein the combined weight percent value of all components does not exceed about 100 wt. %, wherein all weight percent values are based on the total weight of the composition; and wherein the blended polymer composition exhibits greater impact performance compared to a reference composition consisting essentially of substantially the same proportions of the same polymer component, the same filler component, and the same impact modifier, in the absence of the polymer compatibilizer component.

Aspect 2: The blended polymer composition of aspect 1, wherein the polymer component comprises from about 3 wt. % to about 77 wt. % of a polycarbonate.

Aspect 3: The blended polymer composition of claim 1, wherein the polymer component comprises from about 15 wt. % to about 90 wt. % of a polyester.

Aspect 4: The blended polymer composition of aspect 1, wherein the polymer component comprises a bisphenol A polycarbonate polymer.

Aspect 5: The blended polymer composition of aspect 1, wherein the polymer component comprises at least two different bisphenol A polycarbonate polymers.

Aspect 6: The blended polymer composition of aspect 1, wherein the polymer component comprises a polyester carbonate polymer.

Aspect 7: The blended polymer composition of aspect 1, wherein the polycarbonate component is present and comprises a polycarbonate-polysiloxane copolymer.

Aspect 8: The blended polymer composition of aspect 1, further comprising a flame retardant present in an amount ranging from greater than 0% to about 25 wt. %.

Aspect 9: The blended polymer composition of aspect 8, wherein the flame retardant comprises an organic compound comprising phosphorous.

Aspect 10: The blended polymer composition of aspect 8, wherein the flame retardant is present and comprises a halogen containing compound.

Aspect 11: The blended polymer composition of aspect 1, wherein the filler component comprises an inorganic compound.

Aspect 12: The blended polymer composition of aspect 1, further comprising stabilizer additives in an amount in the range from greater than 0 wt. % to about 1.5 wt. %.

Aspect 13: The blended polymer composition of aspect 12, wherein the stabilizer additives comprise antioxidants, heat stabilizers, UV stabilizers, or a combination thereof.

Aspect 14: The blended polymer composition of aspect 1, wherein the impact modifier component comprises elastomer-modified graft copolymers.

Aspect 15: The blended polymer composition of aspect 14, wherein the impact modifier component comprises one or more of an acrylonitrile-butadiene-styrene polymer component, a methyl methacrylate-butadiene-styrene component, a methyl methacrylate-butadiene-styrene polymer component, a bulk polymerized acrylonitrile-butadiene-styrene polymer, a styrene-acrylonitrile copolymer, a styrene acrylonitrile grafted acrylonitrile-butadiene-styrene component, or any combination thereof.

Aspect 16: The blended polymer composition of aspect 14, wherein the impact modifier component comprises one or more of the styrene acrylonitrile grafted acrylonitrile-butadiene-styrene component, the methyl acrylate butadiene styrene component, or the styrene-acrylonitrile copolymer.

Aspect 17: The blended polymer composition of aspect 1, wherein the polymer compatibilizer comprises functionalized polyolefins.

Aspect 18: The blended polymer composition of aspect 17, wherein the polymer compatibilizer comprises glycidyl group grafting polyolefin polymer.

Aspect 19: The blended polymer composition of aspect 17, wherein the polymer compatibilizer comprises maleic anhydride grafting polyethylene copolymer.

Aspect 20: The blended polymer composition of aspect 19, wherein the maleic anhydride grafting polyethylene copolymer comprises ethylene-propylene polymer, ethylene-propylene-diene terpolymer, ethylene-octene copolymer, ethylene-butene copolymer, or a styrene-ethylene/butadiene-styrene copolymer.

Aspect 21: The blended polymer composition of aspect 1, wherein the blended polycarbonate composition exhibits a notched Izod impact that is greater than that of an identical reference polymer blend composition in the absence of the polymer compatibilizer.

Aspect 22: An article made from the blended polymer composition of aspect 1.

Aspect 23: A method comprising generating a mixture by blending together: a polymer component comprising from about 0.1 wt. % to about 90 wt. % of a polycarbonate or from about 0.1 wt. % to about 90 wt. % of a polyester, or a combination of both; a filler component present in an amount ranging from about 2 wt. % to about 50 wt. % of; an impact modifier component present in an amount ranging from about 0.5 wt. % to about 25 wt. %; a polymer compatibilizer component present in an amount ranging from about 0.5 wt. % to about 8 wt. %; wherein the combined weight percent value of all components does not exceed about 100 wt. %, wherein all weight percent values are based on the total weight of the mixture; and wherein the mixture exhibits greater impact performance compared to a reference composition consisting essentially of substantially the same proportions of the same polymer component, the same filler component, and the same impact modifier, in the absence of the polymer compatibilizer component.

Aspect 24: The method of aspect 23, further comprising blending stabilizer additives into the mixture.

Aspect 25: The method of aspect 24, wherein the stabilizer additives comprise heat and UV stabilizers.

Aspect 26: The method of aspect 23, further comprising blending anti-drip agents into the mixture.

Aspect 27: The method of aspect 26, wherein the anti-drip agents comprise fibrile-forming or non-fibril-forming compounds.

Aspect 28: The method of aspect 26, wherein the anti-drip agents comprise styrene-acrylonitrile copolymer.

Aspect 29: The method of aspect 23, wherein the presence of the polymer compatibilizer has substantially no impact on the mechanical and physical properties.

Aspect 30: The method of aspect 23, wherein at least one of the components is blended into the mixture during an extrusion process.

### EXAMPLES

The following examples are put forth so as to provide those of ordinary skill in the art with a complete disclosure and description of how the methods, devices, and systems disclosed and claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in degrees Celsius (° C.) or is at ambient temperature, and pressure is at or near atmospheric.

### General Materials and Methods

The heat deflection temperature (“HDT”) was determined using the ASTM D648 standard at 1.82 MPa. The HDT is reported in units of ° C.

The notched Izod impact (“NII”) test and unnotched Izod impact were carried out on 3.2 mm bars according to ASTM D 256 at −30° C., 0° C. and 23° C.

Flexural properties (modulus and strength) were measured using 6.4 mm or 3.2 mm bars in accordance with ASTM 790. Flexural strength at yield (“FS”) and flexural modulus (“FM”) are reported in units of MPa.

Tensile properties (strength at yield and elongation at break) were measured on 3.2 mm bars in accordance with ASTM D638. Tensile strength at yield (“T/S”) is reported in units of MPa and tensile elongation at break (“T/E”) is reported in %.

The melt flow rate (“MFR”) was measured at a 260° C./2.16 kgf load or 265° C./2.16 kgf load in accordance with ASTM D1238. The MFR is reported in units of g/10 min.

The melt viscosity (“MV) was measured at 260° C. or 265° C. and 1500 s⁻¹ shear rate or in accordance with ISO 11443.

Flammability resistance (“FR”) tests are described in Example Set 6.

As used herein below, the following are abbreviated as follows:

PC is polycarbonate;
PEs is polyester;
IM is impact modifier

### F is Filler

ADD is additive
CO is copolymer
CC is polymer compatibilizer; while most are copolymers, this is not necessarily the case, such as in MAH grafted Polypropylene
FR is flame retardant

### Flammability Testing

Flammability tests were performed following the procedure of Underwriter's Laboratory Bulletin 94 entitled “Tests for Flammability of Plastic Materials, UL94”, which is incorporated herein by reference. According to this procedure, the materials were classified as either UL94 V0, UL94 V1, or UL94 V2 on the basis of the test results obtained for five samples. The procedure and criteria for each of these flammability classifications according to UL94 are, briefly, as follows. Multiple specimens (e.g., 5 or 10) were tested per thickness. Some specimens were tested after conditioning for 48 hours at 23° C., 50% relative humidity. The other specimens were tested after conditioning for 168 hours at 70° C. The bar was mounted with the long axis vertical for flammability testing. The specimen was supported such that its lower end was 9.5 mm above the Bunsen burner tube. A blue 19 mm high flame was applied to the center of the lower edge of the specimen for 10 seconds. The time until the flaming of the bar ceases was recorded (t1). If burning ceased, the flame was re-applied for an additional 10 seconds. Again, the time until the flaming of the bar ceased was recorded (t2). If the specimen dripped particles, these were allowed to fall onto a layer of untreated surgical cotton placed 305 mm below the specimen.

V0: In a sample placed so that its long axis is 180 degrees to the flame, the maximum period of flaming and/or smoldering after removing the igniting flame does not exceed 10 seconds and none of the vertically placed samples produces drips of burning particles that ignite absorbent cotton, and no specimen burns up to the holding clamp after flame or after glow.

The data were also analyzed by calculating the average flame out time, standard deviation of the flame out time and the total number of drips, and by using statistical methods to convert that data to a prediction of the probability of first time pass, or “p(FTP)”, that a particular sample formulation would achieve a “pass” rating in the conventional UL94 V0 or V1 testing of 5 bars. The probability of a first time pass on a first submission (pFTP) was determined according to the formula:

p(FTP)−(P_{t1>mbt, n=0}×P_{t2>mbt, n=0}×P_{total<=mtbt}×P_{drip, n=0}),

where P_{t1>mbt, n=0} is the probability that no first burn time exceeds a maximum burn time value, P_{t2>mbt, n=0} is the probability that no second burn time exceeds a maximum burn time value, P_{total<=mtbt} is the probability that the sum of the burn times is less than or equal to a maximum total burn time value, and P_{drip, n=0} is the probability that no specimen exhibits dripping during the flame test. First and second burn time refer to burn times after a first and second application of the flame, respectively.

The probability that no first burn time exceeds a maximum burn time value, P_{t1>>mbt, n=0}, was determined the formula:

P_{t1>mbt, n=0}=(1−P_{t1>mbt})⁵,

where P_{t1>mbt} is the area under the log normal distribution curve for t1>mbt, and where the exponent “5” relates to the number of bars tested. The probability that no second burn time exceeds a maximum burn time value may be determined from the formula:

P_{t2>mbt, n=0}=(1−P_{t2>mbt}),

where P_{t2>mbt} is the area under the normal distribution curve for t2>mbt. As above, the mean and standard deviation of the burn time data set were used to calculate the normal distribution curve. For the UL-94 V0 rating, the maximum burn time was 10 seconds. For a V1 or V2 rating the maximum burn time was 30 seconds. The probability P_{drip, n=0} that no specimen exhibits dripping during the flame test was an attribute function, estimated by:

P_{drip, n=0}=(1−P_{drip})⁵,

where P_{drip}=(the number of bars that drip/the number of bars tested).

The probability P_{total<=mtbt} that the sum of the burn times was less than or equal to a maximum total burn time value may be determined from a normal distribution curve of simulated 5-bar total burn times. The distribution may be generated from a Monte Carlo simulation of 1000 sets of five bars using the distribution for the burn time data determined above. Techniques for Monte Carlo simulation are well known in the art. A normal distribution curve for 5-bar total burn times may be generated using the mean and standard deviation of the simulated 1000 sets. Therefore, P_{total<=mtbt} may be determined from the area under a log normal distribution curve of a set of 1000 Monte Carlo simulated 5-bar total burn time for total≦maximum total burn time. For the UL-94 V0 rating, the maximum total burn time was 50 seconds. For a VI or V2 rating, the maximum total burn time was 250 seconds.

FOT2 is the average flame time t2 of 10 bars.

### Raw Materials

The compositions in the Examples below were prepared from the components described in Table 1. The performance of the blended polycarbonate and/or polyester composition was tested with and without the addition of a polymer compatibilizer as described below.

TABLE 1

| No. | Item | Description | Supplier | Trade name |
|---|---|---|---|---|
| | PC1 | BPA polycarbonate resin made by an interfacial | SABIC Innovative Plastics | LEXAN ™ |
| | | process with MVR at 300° C./1.2 kg of about 5 to | (“SABIC I.P.”) | |
| | | about 7 mL/10 min and Mw of about 29,900. CAS | | |
| | | No. 111211-39-3 | | |
| | PC2 | BPA polycarbonate resin made by an interfacial | SABIC I.P | LEXAN ™ |
| | | process with MVR at 300° C./1.2 kg of about 23 to | | |
| | | about 30 mL/10 min and Mw of about 21,800. | | |
| | | CAS No. 111211-39-3 | | |
| | PC3 | BPA polycarbonate resin made by an interfacial | SABIC I.P | LEXAN ™ |
| | | process with MVR at 300° C./1.2 kg of about 1 to | | |
| | | about 4 mL/10 min and Mw of about 36500. CAS | | |
| | | No. 111211-39-3 | | |
| | PC4 | BPA polycarbonate-polysiloxane copolymer | SABIC I.P | LEXAN ™-EXL |
| | | comprising about 20% by weight of siloxane, 80% | | |
| | | by weigh BPA and encapped with paracumyl | | |
| | | phenol. CAS No. 202483-49-6 | | |
| | PEs1 | 315 grade Poly(butylene terephthalate)(PBT) resin | SABIC I.P | Valox 315 |
| | | with Intrinsic Viscosity about 0.854 dL/g. CAS | | |
| | | No. 30965-26-5 | | |
| | PEs2 | Poly(ethylene terephthalate)(PET) resin with | Foshan Honghua | PET |
| | | Intrinsic Viscosity about 0.8 dL/g. CAS No. | | |
| | | 25038-59-9 | | |
| | IM1 | Methyl methacrylate polymer with butyl acrylate | Mitsubishi Rayon | METABLEN S- |
| | | and dimethylsiloxane; available under the trade | | 2001 |
| | | name Metablen S-2001. CAS 143106-82-5 | | |
| | IM2 | Bulk acrylonitrile-butadiene-styrene comprising | SABIC I.P | BABS/C29449 |
| | | about 16-17 wt % butadiene content (Grade | | |
| | | C29449). CAS No. 9003-56-9 | | |
| | IM3 | Methacrylate-butadiene- styrene impact modifier: | Dow Chemical | Paraloid EXL |
| | | CAS No. 25053-09-2 | | 2691A |
| | IM4 | High rubber graft emulsion polymerized ABS | SABIC I.P | ABS |
| | | comprising about 50 weight % polybutadiene. | | |
| | | CAS No. 9003-56-9 | | |
| | IM5 | Acrylic polymer impact modifier. CAS No. 25852- | Dow Chemical | Paraloid EXL |
| | | 37-3 | | 3330 |
| | F1 | Fine Talc inorganic filler. CAS No. 14807-96-6 | Luzenac Europe SAS | JETFINE ® 3CA |
| | F2 | Talc inorganic filler. CAS No. 14807-96-6 | HAYASI KASEI | UPN HS-T 0.5 |
| | F3 | Non-bonding chopped glass fiber. CAS No. | Owens Corning (China) | 415A-14C |
| | | 65997-17-3 | investment Co., Ltd. | |
| | F4 | ‘Flat’ Glass Chopped Strand CAS No. 65997-17-3 | Nittobo | CSG 3PA-820 |
| | F5 | ‘Flat’ Glass Chopped Strand CAS No. 65997-17-3 | Nittobo | CSG 3PA-830 |
| | F6 | Clay: Uncalcined hydrated aluminum silicate. | BASF | ASP 400 |
| | | CAS No. 1332-58-7 | | |
| | ADD1 | Polytetrafluoroethylene (PTFE) encapsulated by a | SABIC I.P | TSAN |
| | | styrene-acrylonitrile copolymer (SAN). Anti-drip | | |
| | | agent. CAS No. 9002-84-0 | | |
| | ADD2 | Pentaerythritol tetrastearate, a mold release agent. | FACI Farasco Genova, Italy | PETS |
| | | CAS No. 115-83-3 | | |
| | ADD3 | Hindered phenol, Irganox 1076. CAS No. 2082- | BASF | Irganox 1076 |
| | | 79-3 | | |
| | ADD4 | Tris(2,4-di-tert-butylphenyl)phosphite, stabilizer. | BASF | Irgafos 168 |
| | | CAS No. 31570-04-4 | | |
| | ADD5 | SAPP, sodium acid pyrophosphate. CAS No. | Mishan Chemical | SAPP |
| | | 7758-16-9 | | |
| | CO1 | Copolymer of Styrene/Maleic Anhydride. CAS | NOVA Chemicals | SMA Dylark 332 |
| | | No. 9011-13-6 | | |
| | CO2 | 2-methyl-2-propenoic acid oxiranylmethyl ester | Sumitomo Chemical | Igetabond 2C |
| | | polymer with ethylene. CAS No. 26061-90-5 | | |
| | CO3 | Ethylene-octene copolymer. CAS No. 26221-73-8 | ExxonMobil | Exact 8210 |
| | IM6/CO4 | Ethylene-propylene-ethylidene-norbornene | Dow Chemical | Nordel 4725P |
| | | hydrocarbon elastomer. CAS No. 25038-36-2 | | |
| | IM7/CO5 | Copolymer EMAGMA Ethylene-terpolymer of | Arkema | ATOFINA |
| | | ethylene-methyl acrylate-glycidyl methacrylate. | | Lotader AX8900/ |
| | | CAS No. 51541-08-3 | | |
| | CC1 | Terpolymer of ethylene-butyl acrylate-maleic | Arkema | ATOFINA |
| | | anhydride. CAS No. 64652-60-4 | | Lotader 4700 |
| | CC2 | Maleic anhydride grafted styrene- | Asahi Kasei Chemical | Tuftec M1913 |
| | | ethylene/butadiene-styrene (SEBS). CAS No. | | |
| | | 113569-15-6 | | |
| | CC3 | Maleic anhydride grafted polypropylene with | ExxonMobil | Exxelor VA1020 |
| | | MAH content 0.5-1%. CAS No. 25722-45-6 | | |
| | CC4 | Maleic anhydride modified ethylene-propylene- | Crompton | Royaltuf 485 |
| | | ethylidene norbonene rubber (EPDM) with MAH | | |
| | | content about 0.5 wt. %, E/P ratio 75:25. CAS No. | | |
| | | 31069-12-2 | | |
| | CC5 | Maleic anhydride modified ethylene-propylene | ExxonMobil | Exxelor VA1840 |
| | | (EP) with MAH content about 0.2-0.5 wt. %. CAS | | |
| | | No. 31069-12-2 | | |
| | CC6 | Maleic anhydride modified ethylene-propylene | ExxonMobil | Exxelor VA1801 |
| | | (EP) with MAH content about 0.5-1 wt. % and | | |
| | | low flow. CAS No. 31069-12-2 | | |
| | CC7 | Maleic anhydride modified ethylene-propylene | ExxonMobil | Exxelor VA 1803 |
| | | (EP) with MAH content about 0.5-1 wt. % and | | |
| | | high flow. CAS No. 31069-12-2 | | |
| | CC8 | Maleic anhydride modified ethylene-octene | DuPont | Fusabond MN- |
| | | copolymer. CAS No. 01-09-2. | | 493D |
| | CC9 | Maleic anhydride modified ethylene-butene | Mitsubishi Chemicals | TAFMER MA |
| | | rubber. CAS No. 63625-36-5 | | 8510 |
| | FR | Bisphenol A bis(diphenylphosphate). CAS No. | Dahaichi Chemical Industry Co., | BPA-DP low acid/ |
| | | 5945-33-5 | Ltd. | CR-741 |

As shown below, Tables 2-10 illustrate various comparative examples (e.g., Comp 1A, Comp 1B, Comp 1C . . . Comp 1I) and working examples (e.g., Work 1A, Work 2A . . . Work 1I) having various formulations and properties.

TABLE 2

| | | | | | | | | |
|---|---|---|---|---|---|---|---|---|
| | Comp | Comp | Comp | Comp | Comp | Comp | Work | Work |
| Unit | 1A | 2A | 3A | 4A | 5A | 6A | 1A | 2A |

Formulation

| | | | | | | | | | | |
|---|---|---|---|---|---|---|---|---|---|---|
| 1 | PC1 | % | 36.6 | 35.6 | 35.6 | 35.6 | 35.6 | 35.6 | 35.6 | 35.6 |
| 2 | PC2 | % | 26.6 | 25.6 | 25.6 | 25.6 | 25.6 | 25.6 | 25.6 | 25.6 |
| 3 | PC4 | % | 3 | 3 | 3 | 3 | 3 | 3 | 3 | 3 |
| 4 | IM1 | % | 2.5 | 2.5 | 2.5 | 2.5 | 2.5 | 2.5 | 2.5 | 2.5 |
| 5 | F1 | % | 20 | 20 | 20 | 20 | 20 | 20 | 20 | 20 |
| 6 | ADD1 | % | 0.5 | 0.5 | 0.5 | 0.5 | 0.5 | 0.5 | 0.5 | 0.5 |
| 7 | ADD2 | % | 0.2 | 0.2 | 0.2 | 0.2 | 0.2 | 0.2 | 0.2 | 0.2 |
| 8 | ADD3 | % | 0.08 | 0.08 | 0.08 | 0.08 | 0.08 | 0.08 | 0.08 | 0.08 |
| 9 | ADD4 | % | 0.08 | 0.08 | 0.08 | 0.08 | 0.08 | 0.08 | 0.08 | 0.08 |
| 10 | CO1 | % | 0 | 2 | 0 | 0 | 0 | 0 | 0 | 0 |
| 11 | CO2 | % | 0 | 0 | 2 | 0 | 0 | 0 | 0 | 0 |
| 12 | CO3 | % | 0 | 0 | 0 | 2 | 0 | 0 | 0 | 0 |
| 13 | CO4 | % | 0 | 0 | 0 | 0 | 2 | 0 | 0 | 0 |
| 14 | CO5 | % | 0 | 0 | 0 | 0 | 0 | 2 | 0 | 0 |
| 16 | CC1 | % | 0 | 0 | 0 | 0 | 0 | 0 | 2 | 0 |
| 15 | CC2 | % | 0 | 0 | 0 | 0 | 0 | 0 | 0 | 2 |
| 17 | CC3 | % | 0 | 0 | 0 | 0 | 0 | 0 | 0 | 0 |
| 18 | CC4 | % | 0 | 0 | 0 | 0 | 0 | 0 | 0 | 0 |
| 19 | CC5 | % | 0 | 0 | 0 | 0 | 0 | 0 | 0 | 0 |
| 20 | CC6 | % | 0 | 0 | 0 | 0 | 0 | 0 | 0 | 0 |
| 21 | CC7 | % | 0 | 0 | 0 | 0 | 0 | 0 | 0 | 0 |
| 22 | CC8 | % | 0 | 0 | 0 | 0 | 0 | 0 | 0 | 0 |
| 23 | CC9 | % | 0 | 0 | 0 | 0 | 0 | 0 | 0 | 0 |
| 24 | FR | % | 10.4 | 10.4 | 10.4 | 10.4 | 10.4 | 10.4 | 10.4 | 10.4 |
| | Total | % | 100 | 100 | 100 | 100 | 100 | 100 | 100 | 100 |

Properties

| Flexural Modulus- | | MPa | 5310 | 5330 | 4080 | 4930 | 5150 | 3890 | 4250 | 3950 |
|---|---|---|---|---|---|---|---|---|---|---|
| Avg | | | | | | | | | | |
| Flexural Stress at | | MPa | 106 | 110 | 92.7 | 98.8 | 98.8 | 95.3 | 95.3 | 96.8 |
| Yield-Avg | | | | | | | | | | |
| HDT, 1.82 MPa/6.4 mm | | ° C. | 94.5 | 96.6 | 92.2 | 94.1 | 93.7 | 93.4 | 93.4 | 95 |
| Notched Izod Impact, | | J/m | 52 | 51.3 | 60.2 | 63.1 | 68.1 | 72.7 | 127 | 103 |
| 23° C. | | | | | | | | | | |
| Notched Izod Impact | | % | 0 | 0 | 0 | 0 | 60 | 0 | 0 | 0 |
| Ductility, 23° C. | | | | | | | | | | |
| Notched Izod Impact, | | J/m | 44.6 | 44 | 43 | 47.9 | 53.1 | 52.3 | 70.4 | 65.6 |
| 0° C. | | | | | | | | | | |
| Notched Izod Impact, | | J/m | 43.4 | 41.5 | 37 | 40.9 | 43.9 | 41.3 | 55.2 | 55.2 |
| −30° C. | | | | | | | | | | |
| Unnotched Izod | | J/m | 822 | 1030 | 1370 | 1270 | 1140 | 1840 | 2120 | 2120 |
| Impact, 23° C. | | | | | | | | | | |
| Unnotched Izod | | % | 100 | 100 | 100 | 100 | 100 | 100 | 100 | 100 |
| Impact Ductility, 23° C. | | | | | | | | | | |
| MAI, Energy, Total- | | J | 51.8 | 54.6 | 45.5 | 51 | 52.7 | 41.2 | 55.7 | 55.9 |
| Avg | | | | | | | | | | |
| Tens. Stress at Yield- | | MPa | 0 | 64.5 | 52.7 | 57.3 | 57.4 | 54.3 | 54.8 | 54.8 |
| Avg | | | | | | | | | | |
| Tens. Elongation at | | % | 4.85 | 8.84 | 7.84 | 5.62 | 5.8 | 13.1 | 35.8 | 19.4 |
| Break-Avg | | | | | | | | | | |
| MFR-Avg (260° C./ | | min | 9.34 | 7.25 | 0 | 10.9 | 8.28 | 0 | 7.1 | 5.79 |
| 2.16 kg/300 s) | | | | | | | | | | |
| App. viscosity- | | Pa-s | 223 | 254 | 245 | 254 | 269 | 385 | 245 | 278 |
| Avg (260° C., 1500 s⁻¹) | | | | | | | | | | |
| V0 @ | FOT2 | s | 4.28 | 3.34 | 26.9 | 3.99 | 5.75 | 27.1 | 2.7 | 3.22 |
| 1.0 mm | pFTP | | 0.98 | 0.98 | 0 | 1 | 0.55 | 0 | 1 | 1 |
| | Drip | | 0 | 0 | 1 | 0 | 0 | 0 | 0 | 0 |

| | | Work | Work | Work | Work | Work | Work | Work |
|---|---|---|---|---|---|---|---|---|
| | | 3A | 4A | 5A | 6A | 7A | 8A | 9A |
| Formulation | | | | | | | | |
| 1 | PC1 | 35.6 | 35.6 | 35.6 | 35.6 | 35.6 | 35.6 | 35.6 |
| 2 | PC2 | 25.6 | 25.6 | 25.6 | 25.6 | 25.6 | 25.6 | 25.6 |
| 3 | PC4 | 3 | 3 | 3 | 3 | 3 | 3 | 3 |
| 4 | IM1 | 2.5 | 2.5 | 2.5 | 2.5 | 2.5 | 2.5 | 2.5 |
| 5 | F1 | 20 | 20 | 20 | 20 | 20 | 20 | 20 |
| 6 | ADD1 | 0.5 | 0.5 | 0.5 | 0.5 | 0.5 | 0.5 | 0.5 |
| 7 | ADD2 | 0.2 | 0.2 | 0.2 | 0.2 | 0.2 | 0.2 | 0.2 |
| 8 | ADD3 | 0.08 | 0.08 | 0.08 | 0.08 | 0.08 | 0.08 | 0.08 |
| 9 | ADD4 | 0.08 | 0.08 | 0.08 | 0.08 | 0.08 | 0.08 | 0.08 |
| 10 | CO1 | 0 | 0 | 0 | 0 | 0 | 0 | 0 |
| 11 | CO2 | 0 | 0 | 0 | 0 | 0 | 0 | 0 |
| 12 | CO3 | 0 | 0 | 0 | 0 | 0 | 0 | 0 |
| 13 | CO4 | 0 | 0 | 0 | 0 | 0 | 0 | 0 |
| 14 | CO5 | 0 | 0 | 0 | 0 | 0 | 0 | 0 |
| 16 | CC1 | 0 | 0 | 0 | 0 | 0 | 0 | 0 |
| 15 | CC2 | 0 | 0 | 0 | 0 | 0 | 0 | 0 |
| 17 | CC3 | 2 | 0 | 0 | 0 | 0 | 0 | 0 |
| 18 | CC4 | 0 | 2 | 0 | 0 | 0 | 0 | 0 |
| 19 | CC5 | 0 | 0 | 2 | 0 | 0 | 0 | 0 |
| 20 | CC6 | 0 | 0 | 0 | 2 | 0 | 0 | 0 |
| 21 | CC7 | 0 | 0 | 0 | 0 | 2 | 0 | 0 |
| 22 | CC8 | 0 | 0 | 0 | 0 | 0 | 2 | 0 |
| 23 | CC9 | 0 | 0 | 0 | 0 | 0 | 0 | 2 |
| 24 | FR | 10.4 | 10.4 | 10.4 | 10.4 | 10.4 | 10.4 | 10.4 |
| | Total | 100 | 100 | 100 | 100 | 100 | 100 | 100 |

| Properties | | | | | | | | |
|---|---|---|---|---|---|---|---|---|
| Flexural Modulus- | | 5140 | 4190 | 4000 | 4080 | 4310 | 3870 | 4050 |
| Avg | | | | | | | | |
| Flexural Stress at | | 98.3 | 90.5 | 91.7 | 91.7 | 90.7 | 91 | 92 |
| Yield-Avg | | | | | | | | |
| HDT, 1.82 MPa/6.4 mm | | 94.4 | 92.3 | 92.7 | 94.2 | 92.8 | 93.2 | 93.6 |
| Notched Izod Impact, | | 105 | 251 | 264 | 436 | 450 | 406 | 419 |
| 23° C. | | | | | | | | |
| Notched Izod Impact | | 100 | 60 | 60 | 100 | 100 | 100 | 100 |
| Ductility, 23° C. | | | | | | | | |
| Notched Izod Impact, | | 63.4 | 83.3 | 78.1 | 96.2 | 105 | 92.8 | 91.3 |
| 0° C. | | | | | | | | |
| Notched Izod Impact, | | 51.6 | 58.5 | 59.4 | 64.4 | 66.7 | 62.1 | 62.3 |
| −30° C. | | | | | | | | |
| Unnotched Izod | | 1910 | 2150 | 2150 | 2120 | 2150 | 2150 | 2150 |
| Impact, 23° C. | | | | | | | | |
| Unnotched Izod | | 100 | 100 | 100 | 100 | 100 | 100 | 100 |
| Impact Ductility, 23° C. | | | | | | | | |
| MAI, Energy, Total- | | 55.7 | 54.1 | 55.1 | 52.7 | 50.3 | 54.2 | 50.6 |
| Avg | | | | | | | | |
| Tens. Stress at Yield- | | 56.3 | 52.4 | 52.9 | 52.6 | 53.4 | 52.3 | 53.1 |
| Avg | | | | | | | | |
| Tens. Elongation at | | 12.3 | 8.36 | 17.1 | 13.7 | 32.5 | 55.6 | 53 |
| Break-Avg | | | | | | | | |
| MFR-Avg (260° C./ | | 6.91 | 4.94 | 5.59 | 5.24 | 8.26 | 5.71 | 4.81 |
| 2.16 kg/300 s) | | | | | | | | |
| App. viscosity- | | 269 | 223 | 245 | 269 | 223 | 278 | 385 |
| Avg (260° C., 1500 s⁻¹) | | | | | | | | |
| V0 @ | FOT2 | 3.31 | 4.2 | 3.95 | 3.48 | 3.31 | 4.17 | 5.67 |
| 1.0 mm | pFTP | 1 | 1 | 0.98 | 0.98 | 1 | 0.95 | 0.62 |
| | Drip | 0 | 0 | 0 | 0 | 0 | 0 | 0 |

### Example Set A

Six reference samples (Comparative Example 1A through Comparative Example 6A, shown as Comp 1A, Comp 2A, Comp 3A, Comp 4A, Comp 5A, Comp 6A) and nine working samples (Working Example 1A through Working Example 9A, shown as Work 1A, Work 2A, Work 3A, Work 4A, Work 5A, Work 6A, Work 7, Work 8, Work 9) were prepared according to the procedures described above. The formulations of these samples are shown in Table 2. Table 2 also shows the performance results of the polycarbonate blend composites which were tested with and without the addition of a polymer (e.g., copolymer) compatibilizer component.

Comparative Example 1A (without glycidyl polyethylene copolymer or maleic anhydride—MAH grafted polyethylene copolymer compatibilizer) has a NII at 52 J/m and totally brittle failure type. Comparative Example 2A (with styrene maleic anhydride), Comparative Example 3A (with ethylene-EGMA copolymer), Comparative Example 4A (with copolymer POE), Comparative Example 5A (with copolymer EPDM), and Comparative Example 6A (with copolymer EMAGMA) have a slightly improved NII compared to Comparative Example 1A. Working Examples 1A-9A (with maleic anhydride or glycidyl grafting polyethylene copolymer represented by CC1-CC9) have notched Izod impact and unnotched Izod impact that are significantly improved to at least greater than 100 J/m.

Notched and unnotched Izod impact performances were improved for Working Examples 6A-9A where there are higher maleic anhydride content polyethylene copolymer compatibilizers.

Working Example 1A has a better NII performance than Comparative example 6A. These results demonstrate that maleic anhydride grafting compatibilizer improves impact performance more so than the glycidyl grafting compatibilizer and further indicates that the maleic anhydride type copolymer is the preferred graft in this formulation. The addition of a high maleic anhydride content polyethylene copolymer compared to a low maleic anhydride content polyethylene copolymer provides a greater improvement in the impact performance of the blended polycarbonate composition (Working Examples 6A and 7A vs. Working Example 5A). Although both high and low maleic anhydride content yield improved impact performance, Working Examples 6A and 7A increased NII performance to over 400 J/m, whereas the low maleic anhydride content Working Example 5A increased performance to 267 J/m.

It has also been found that the addition or increase of the copolymer compatibilizer component decreases the melt mass flow rate (MFR) properties of the blended polycarbonate composition (Working Examples 6A and 7A). However, higher flow in Working Example 7A demonstrates that MFR can be maintained while impact performance increases.

Generally, the results also demonstrate that flame retardant (FR) performance can be maintained with a polymer compatibilizer determined at V0 at 1.0 mm (Working Examples 1A-9A vs. Comparative Example 1A).

Flexural modulus however decreases with the addition of a polymer compatibilizer to the blended polycarbonate composition (Working Examples 1A-9A).

TABLE 3

| | | | | | | | | | | |
|---|---|---|---|---|---|---|---|---|---|---|
| | Comp | Comp | Comp | Work | Comp | Comp | Work | Comp | Comp | Work |
| Unit | 1B-1 | 1B-2 | 1B-3 | 1B | 2B-1 | 2B-2 | 2B | 3B-1 | 3B-2 | 3B |

Formulation

| | | | | | | | | | | | | |
|---|---|---|---|---|---|---|---|---|---|---|---|---|
| 1 | PC1 | % | 36.628 | 34.13 | 35.9 | 35.6 | 31.6 | 35.4 | 35.6 | 24.1 | 33.4 | 34.1 |
| 2 | PC2 | % | 26.612 | 24.11 | 26.1 | 26.6 | 21.6 | 25.4 | 25.6 | 14.1 | 23.6 | 24.1 |
| 3 | PC4 | % | 3 | 8 | 3 | 3 | 13 | 3 | 3 | 28 | 3 | 3 |
| 4 | IM1 | % | 2.5 | 2.5 | 3.75 | 2.5 | 2.5 | 5 | 2.5 | 2.5 | 8.75 | 2.5 |
| 5 | F1 | % | 20 | 20 | 20 | 20 | 20 | 20 | 20 | 20 | 20 | 20 |
| 6 | ADD1 | % | 0.5 | 0.5 | 0.5 | 0.5 | 0.5 | 0.5 | 0.5 | 0.5 | 0.5 | 0.5 |
| 7 | ADD2 | % | 0.2 | 0.2 | 0.2 | 0.2 | 0.2 | 0.2 | 0.2 | 0.2 | 0.2 | 0.2 |
| 8 | ADD3 | % | 0.08 | 0.08 | 0.08 | 0.08 | 0.08 | 0.08 | 0.08 | 0.08 | 0.08 | 0.08 |
| 9 | ADD4 | % | 0.08 | 0.08 | 0.08 | 0.08 | 0.08 | 0.08 | 0.08 | 0.08 | 0.08 | 0.08 |
| 10 | CC6 | % | 0 | 0 | 0 | 1 | 0 | 0 | 2 | 0 | 0 | 5 |
| 11 | FR | % | 10.4 | 10.4 | 10.4 | 10.4 | 10.4 | 10.4 | 10.4 | 10.4 | 10.4 | 10.4 |
| | Total | % | 100 | 100 | 100 | 100 | 100 | 100 | 100 | 100 | 100 | 100 |

Properties

| Notched IZOD Impact, | | J/m | 52 | 58.3 | 54 | 151 | 69.6 | 75 | 436 | 104 | 329 | 521 |
|---|---|---|---|---|---|---|---|---|---|---|---|---|
| 23° C. | | | | | | | | | | | | |
| Notched Izod Impact | | % | 0 | 0 | 0 | 100 | 0 | 80 | 100 | 40 | 100 | 100 |
| Ductility, 23° C. | | | | | | | | | | | | |
| Notched IZOD | | J/m | 46.9 | 45.3 | 50 | 67.3 | 50.9 | 60.3 | 96 | 67 | 85.1 | 128 |
| Impact, 0° C. | | | | | | | | | | | | |
| Notched Izod Impact | | % | 0 | 0 | 0 | 0 | 0 | 0 | 0 | 0 | 0 | 0 |
| Ductility, 0° C. | | | | | | | | | | | | |
| Unnotched IZOD | | J/m | 822 | 1360 | 1450 | 1670 | 1600 | 1810 | 2120 | 2150 | 2130 | 2120 |
| Impact, 23° C., | | | | | | | | | | | | |
| Unnotched Izod Impact | | % | 100 | 100 | 100 | 100 | 100 | 100 | 100 | 100 | 100 | 100 |
| Ductility, 23° C. | | | | | | | | | | | | |
| MAI, Energy, Total- | | J | 51.8 | 53.1 | 53.8 | 52.2 | 38.2 | 52.1 | 52.7 | 26.7 | 53.4 | 42.4 |
| Avg, 23° C. | | | | | | | | | | | | |
| MAI Ductility, 23° C. | | % | 100 | 100 | 100 | 100 | 100 | 100 | 100 | 100 | 100 | 100 |
| Tens. Stress at Yield- | | MPa | 0 | 60.8 | 61 | 57.7 | 0 | 59.4 | 52.6 | 54.2 | 52.4 | 45.1 |
| Avg | | | | | | | | | | | | |
| Tens. Elongation at | | % | 4.85 | 10.1 | 10.1 | 13.1 | 3.86 | 8.33 | 13.7 | 8.81 | 15.3 | 15.1 |
| Break-Avg | | | | | | | | | | | | |
| Flexural Modulus-Avg | | MPa | 5310 | 5010 | 5180 | 4660 | 4830 | 5160 | 4080 | 4510 | 4770 | 3180 |
| Flexural Stress at Yield- | | MPa | 106 | 103 | 103 | 97.4 | 98.5 | 101 | 91.7 | 91.4 | 91.2 | 78.4 |
| Avg | | | | | | | | | | | | |
| MFR-Avg (260° C./ | | g/10 min | 9.34 | 8.18 | 6.19 | 5.34 | 9 | 4.3 | 5.24 | 8.58 | 1.42 | 3.95 |
| 2.16 kg/300 s) | | | | | | | | | | | | |
| App. viscosity-Avg | | Pa · s | 222.8 | 226.9 | 245.7 | 264.4 | 235.7 | 265.6 | 269.4 | 195.4 | 261.4 | 264.7 |
| (260° C., 1500 s⁻¹) | | | | | | | | | | | | |
| HDT, 1.82 MPa/6.4 mm | | ° C. | 94.5 | 94.1 | 94.7 | 93.3 | 93 | 94 | 94.2 | 90.7 | 92.3 | 92.2 |
| V0 @ 1.5 mm | FOT2 | s | 1.7 | 2.21 | 2.42 | 1.52 | 2.22 | 2.41 | 3.48 | 2.48 | 7.18 | 4.49 |
| | pFTP | | 1 | 1 | 1 | 1 | 1 | 1 | 1 | 1 | 0.24 | 0.99 |
| | Drip | | 0 | 0 | 0 | 0 | 0 | 0 | 0 | 0 | 0 | 0 |
| V0 @ 1.0 mm | FOT2 | s | 4.28 | 3.53 | 5.06 | 4.11 | 2.69 | 5.26 | 3.48 | 2.45 | 49.6 | 9.92 |
| | Pftp | | 0.9754 | 0.983 | 0.65 | 0.93 | 1 | 0.69 | 0.98 | 1 | 0 | 0.03 |
| | Drip | | 0 | 0 | 0 | 0 | 0 | 0 | 0 | 0 | 0 | 0 |

### Example Set B

Additional compositions containing a blended polycarbonate composition were prepared. The formulations of the blended polycarbonate composition and their performance are shown in Table 3. The blended polycarbonate compositions of Example Set B contain copolymer compatibilizer MAH-g-EP(D)M at different percentages of the total composition, namely 0%, 1%, 2%, and 5%. The addition of MAH-g-EP(D)M improves the impact performance of the blended polycarbonate composition greater than the increase achieved through the addition of an modifier in the absence of copolymer compatibilizer (Working Examples 1B vs. Comparative Examples 1B-2, 1B-3; Working Examples 2B vs. Comparative Examples 2B-1, 2B-2; Working Examples 3B vs. Comparative Examples 3B-1, 3B-2). The addition of the copolymer compatibilizer improved the notched Izod impact and unnotched Izod impact as well as the tensile elongation, while maintaining FR performance (Working Examples 1B, 2B, 3B). The addition of the copolymer compatibilizer also successfully maintains FR at lower loading of 1% and 2% (Working Examples 1B and 2B).

Generally, the impact performance varies directly with the weight percent of added copolymer compatibilizer. The addition of the copolymer compatibilizer MAH-g-EP(D)M at 1% significantly increased notched Izod impact to 151 J/m and 100% ductile failure type (Working Example 1B), whereas without the MAH-g-EP(D)M compatibilizer (Comparative Example 1B-1), notched Izod impact is 52 J/m.

Where the amount of the PC-siloxane or S-2001 impact modifiers in the blended polycarbonate composition is increased, the notched Izod impact does not exhibit a similar improvement (Comparative Examples 1B-2 and 1B-3). The increase of impact modifier PC-siloxane to 8% (Comparative Example 1B-2) or impact modifier S-2001 to 3.75% (Comparative Example 1B-3) does not significantly increase impact performance.

Increase of the compatibilizer amount to 2% also produces a significant improvement in impact performance. Copolymer compatibilizer MAH-g-EP(D)M at 2% improves impact performance further to 436 J/m (Working Example 2B). A similar increase in PC-siloxane to 13% (Comparative Example 2B -1) or S-2001 to 5% (Comparative Example 2B-2) improved notched Izod impact to 69.6 J/m and 75 J/m respectively. Increasing the MAH-g-EP(D)M copolymer compatibilizer to 5% improves the notched Izod impact further to 521 J/m (Working Example 3B). Increases in the impact modifiers produce significantly smaller improvements in the notched Izod impact performance. An increase in PC-siloxane to 28% (Comparative Example 3B-1) or S-2001 to 8.75% (Comparative Example 3B-2) improved notched impact to 104 J/m and 329 J/m, respectively.

Increased copolymer compatibilizer loading also improves unnotched Izod impact with an efficiency higher than the two kinds of traditional impact modifier in the blended polycarbonate composition PC-siloxane copolymer and S-2001. At lower copolymer compatibilizer loading (Working Examples 1B and 2B), FR is maintained. The addition of copolymer compatibilizer MAH-g-EP(D)M does decrease flexural modulus. Typically, as the amount of compatibilizer is increased, flexural modulus tends decreases. At 1% MAH-g-EP(D)M loading, flexural modulus decreased 12% while impact performance (notched Izod) increased by 300% and 100% ductile from 100% brittle failure type (Working Example 1B).

TABLE 4

| | | | | | |
|---|---|---|---|---|---|
| Unit | Comp 1C-1 | Comp 1C-2 | Work 1C | Comp 2C-1 | Work 2C |

Formulation

| | | | | | | | |
|---|---|---|---|---|---|---|---|
| 1 | PC1 | % | 26.27 | 25.645 | 25.77 | 25.02 | 25.27 |
| 2 | PC2 | % | 26.27 | 25.645 | 25.77 | 25.02 | 25.27 |
| 3 | PC4 | % | 3 | 3 | 3 | 3 | 3 |
| 4 | IM1 | % | 1.2 | 2.45 | 1.2 | 3.7 | 1.2 |
| 5 | F2 | % | 25 | 25 | 25 | 25 | 25 |
| 6 | ADD1 | % | 0.5 | 0.5 | 0.5 | 0.5 | 0.5 |
| 7 | ADD3 | % | 0.08 | 0.08 | 0.08 | 0.08 | 0.08 |
| 8 | ADD4 | % | 0.08 | 0.08 | 0.08 | 0.08 | 0.08 |
| 9 | CC6 | % | 0 | 0 | 1 | 0 | 2 |
| 10 | IM2 | % | 6.6 | 6.6 | 6.6 | 6.6 | 6.6 |
| 11 | FR | % | 11 | 11 | 11 | 11 | 11 |
| | Total | % | 100 | 100 | 100 | 100 | 100 |

Properties

| Notched Izod Impact, | | J/m | 34.7 | 40.9 | 53.2 | 49.1 | 75.5 |
|---|---|---|---|---|---|---|---|
| 23° C. | | | | | | | |
| Notched Izod Impact | | % | 0 | 0 | 0 | 0 | 0 |
| Ductility, 23° C. | | | | | | | |
| Notched Izod Impact, | | J/m | 36 | 34.9 | 46.3 | 39.3 | 56.5 |
| 0° C. | | | | | | | |
| Notched Izod Impact | | % | 0 | 0 | 0 | 0 | 0 |
| Ductility, 0° C. | | | | | | | |
| Unnotched Izod Impact, | | J/m | 579 | 746 | 1020 | 810 | 1630 |
| 23° C. | | | | | | | |
| Unnotched Izod Impact | | % | 0 | 0 | 100 | 80 | 100 |
| Ductility, 23° C. | | | | | | | |
| Unnotched Izod Impact, | | J/m | 514 | 598 | 762 | 651 | 1040 |
| 0° C. | | | | | | | |
| Unnotched Izod Impact | | % | 0 | 0 | 0 | 0 | 0 |
| Ductility, 0° C. | | | | | | | |
| MAI, Energy, Total-Avg, | | J | 9.26 | 20.1 | 30.6 | 33 | 42 |
| 23° C. | | | | | | | |
| MAI Ductility, 23° C. | | % | 0 | 0 | 0 | 0 | 0 |
| Flexural Modulus-Avg | | MPa | 5520 | 5260 | 4760 | 5230 | 4170 |
| Flexural Stress at Yield- | | MPa | 104 | 100 | 95.6 | 96.7 | 89.4 |
| Avg | | | | | | | |
| Tens. Stress at Yield- | | MPa | 35.8 | 57.3 | 53.9 | 54.8 | 50 |
| Avg | | | | | | | |
| Tens. Elongation at | | % | 6.19 | 7.02 | 8.74 | 7.66 | 10.71 |
| Break-Avg | | | | | | | |
| Tens. Elongation at yld- | | % | 1.58 | 2.69 | 2.88 | 2.62 | 2.96 |
| Avg | | | | | | | |
| MFR-Avg (260° C./ | | g/10 min | 13.7 | 9.15 | 6.96 | 7.21 | 6.06 |
| 2.16 kg/300 s) | | | | | | | |
| HDT, 1.82 MPa/3.2 mm | | ° C. | 83 | 84.9 | 83.5 | 83.7 | 81.5 |
| V0@ 1.2 mm | FOT2 | s | 2.51 | 7.79 | 3.33 | 11.85 | 4.9 |
| | pFTP | | 0.9976 | 0.1879 | 0.9403 | 0.0606 | 0.9337 |
| | Drip | | 0 | 0 | 0 | 0 | 0 |

### Example Set C

The mechanical properties of the blended polycarbonate compositions containing a maleic anhydride grafted copolymer compatibilizer MAH-g-EP(D)M were further evaluated by comparing samples which the MAH grafted compatibilizer and increased amounts of flame retardant and filler for high modulus. Flame retardant was increased to 11% and filler used in this example set is Talc HST at 25%. ABS and acrylate-silicone materials were used as an impact modifier. The formulations of the blended polycarbonate composition and their performance are shown in Table 4.

Without the maleic anhydride grafted compatibilizer MAH-g-EP(D)M, notched Izod impact is 34.7 J/m (Comparative Example 1C-1). At 1% MAH compatibilizer, notched Izod increases to 53.2 J/m (Working Example 1C). Noticeably, in the absence of the MAH compatibilizer, the increase of impact modifier S-2001 from 1.2% to 2.45% improves notched Izod impact to 40.9 J/m (Comparative Example 1C-2).

The same trend is seen for the unnotched Izod impact. In the absence of the MAH-g-EP(D)M compatibilizer (Comparative Example 1C-1), unnotched Izod impact is 579 J/m and total brittle failure type. At 1% MAH-g-EPDM (Working Example 1C), unnotched Izod impact increases to 1020 J/m and 100% ductile. Where only the impact modifier S-2001 is increased to 2.45%, the unnotched Izod impact improves to 746 J/m (Comparative Example 1C-2).

The greater efficiency of the MAH compatibilizer is seen in the significant increase in the impact performance compared to the identical polycarbonate composition with increased S-2001 impact modifier in the absence of the MAH compatibilizer. At 2% MAH-g-EP(D)M loading (Working Example 2C), notched Izod impact improves to 75.5 J/m. An increase in S-2001 from 1.2% to 3.7% improves the notched Izod impact to 49.1 J/m (Comparative Example 2C-1). A similar trend arises for the unnotched Izod impact performance. Without the MAH-g-EP(D)M compatibilizer (Comparative Example 1C), unnotched Izod impact is 579 J/m and total brittle failure type. The addition of the MAH-g-EP(D)M compatibilizer at 2% (Working Example 2C) increases the unnotched Izod impact to 1630 J/m and 100% ductility. Where the impact modifier S-2001 is increased from 1.2% to 3.7%, unnotched Izod impact improves to 810 J/m and 80% ductility (Comparative Example 2C-1).

Generally, the results demonstrate that the MAH-g-EP(D)M increase yields a greater improvement in impact performance than a significant increase in the general impact modifier. This trend is also observed in terms of MAI.

Flame retardance was also maintained with increased MAH-g-EP(D)M (Working Examples 1C and 2C), where MAH-g-EP(D)M is increased from 1% to 2% maintained an FR close to the performance of the identical blended polycarbonate composition in the absence of the MAH-g-EP(D)M copolymer compatibilizer (Comparative Example 1C).

Consistent with other examples, MFR and flexural modulus decrease as the amount of MAH-g-EP(D)M increases. The tolerance depends upon the application.

TABLE 5

| | | | | | | | |
|---|---|---|---|---|---|---|---|
| Unit | Comp 1D-1 | Comp 1D-2 | Comp 1D-3 | Work 1D | Comp 2D-1 | Comp 2D-2 | Work 2D |

Formulation

| | | | | | | | | | |
|---|---|---|---|---|---|---|---|---|---|
| 1 | PC1 | % | 30.42 | 27.92 | 29.795 | 29.92 | 25.42 | 29.17 | 29.42 |
| 2 | PC2 | % | 30.42 | 27.92 | 29.795 | 29.92 | 25.42 | 29.17 | 29.42 |
| 3 | PC4 | % | 3 | 8 | 3 | 3 | 13 | 3 | 3 |
| 4 | IM3 | % | 3 | 3 | 4.25 | 3 | 3 | 5.5 | 3 |
| 5 | F2 | % | 20 | 20 | 20 | 20 | 20 | 20 | 20 |
| 6 | ADD1 | % | 0.5 | 0.5 | 0.5 | 0.5 | 0.5 | 0.5 | 0.5 |
| 7 | ADD2 | % | 0.5 | 0.5 | 0.5 | 0.5 | 0.5 | 0.5 | 0.5 |
| 8 | ADD3 | % | 0.08 | 0.08 | 0.08 | 0.08 | 0.08 | 0.08 | 0.08 |
| 9 | ADD4 | % | 0.08 | 0.08 | 0.08 | 0.08 | 0.08 | 0.08 | 0.08 |
| 10 | CC6 | % | 0 | 0 | 0 | 1 | 0 | 0 | 2 |
| 11 | FR | % | 12 | 12 | 12 | 12 | 12 | 12 | 12 |
| | Total | % | 100 | 100 | 100 | 100 | 100 | 100 | 100 |

Properties

| Notched Izod Impact, 23° C. | | J/m | 45.5 | 55.1 | 54.4 | 69.4 | 64.3 | 65.5 | 85.8 |
|---|---|---|---|---|---|---|---|---|---|
| Notched Izod Impact | | % | 0 | 0 | 0 | 0 | 0 | 0 | 0 |
| Ductility, 23° C. | | | | | | | | | |
| Notched Izod Imapct, 0° C. | | J/m | 38.8 | 43.2 | 45.3 | 57.8 | 51.8 | 52.8 | 65.2 |
| Notched Izod Impact | | % | 0 | 0 | 0 | 0 | 0 | 0 | 0 |
| Ductility, 0° C. | | | | | | | | | |
| Unnotched Izod Impact, | | J/m | 762 | 901 | 901 | 1580 | 1040 | 1060 | 2130 |
| 23° C. | | | | | | | | | |
| Unnotched Izod Impact | | % | 60 | 100 | 100 | 100 | 100 | 100 | 100 |
| Ductility, 23° C. | | | | | | | | | |
| Unnotched Izod Impact, 0° C. | | J/m | 630 | 693 | 692 | 993 | 774 | 772 | 1340 |
| Unnotched Izod Impact | | % | 0 | 0 | 0 | 0 | 0 | 0 | 100 |
| Ductility, 0° C. | | | | | | | | | |
| MAI, Energy, Total-Avg, | | J | 32 | 51 | 46.5 | 49.8 | 47.5 | 43.4 | 46 |
| 23° C. | | | | | | | | | |
| MAI Ductility, 23° C. | | % | 20 | 100 | 40 | 100 | 100 | 100 | 100 |
| Flexural Modulus-Avg | | MPa | 5040 | 4670 | 4920 | 4260 | 4720 | 4760 | 3730 |
| Flexural Stress at Yield- | | MPa | 102 | 95.4 | 99.6 | 94.6 | 95.7 | 95.8 | 89 |
| Avg | | | | | | | | | |
| Tens. Stress at Yield-Avg | | MPa | 59 | 54.9 | 56.8 | 53.7 | 55 | 54.5 | 50.5 |
| Tens. Elongation at Break- | | % | 8.16 | 6.91 | 8.16 | 18.65 | 6.9 | 10.15 | 12.16 |
| Avg | | | | | | | | | |
| Tens. Elongation at yld- | | % | 2.79 | 2.69 | 2.76 | 3.06 | 2.69 | 2.74 | 3.15 |
| Avg | | | | | | | | | |
| MFR-Avg (260° C./2.16 kg/ | | g/10 min | 14.2 | 12.9 | 11.9 | 9.48 | 12.3 | 10.5 | 7.98 |
| 300 s) | | | | | | | | | |
| HDT, 1.82 MPa/3.2 mm | | ° C. | 83.2 | 82.5 | 83.9 | 81.9 | 82 | 83.3 | 80.7 |
| V0@1.2 mm | FOT2 | s | 3.15 | 3.41 | 3.15 | 3.57 | 2.86 | 4.2 | 2.92 |
| | pFTP | | 1 | 1 | 1 | 1 | 1 | 1 | 1 |
| | Drip | | 0 | 0 | 0 | 0 | 0 | 0 | 0 |

### Example Set D

Examples were prepared to further evaluate the mechanical properties and FR performance at different MAH compatibilizer amounts and with impact modifier MBS. The formulations of the prepared thermoplastic polymer blends are shown in Table 5. The performance properties evaluated for the thermoplastic polymer blend compositions are also shown in Table 5. Flame retardant is increased to 12% and filler used in this example set is Talc HST at 20%. The impact modifiers were EXL and MBS. The addition of the MAH compatibilizer increased impact performance more substantially than an increase in both impact modifier components as compared to an identical blended polymer composition in the absence of the MAH compatibilizer.

Without the MAH compatibilizer (Comparative Example 1D-1), notched Izod impact at 23° C. is 45.5 J/m. At 1% MAH-g-EP(D)M compatibilizer, notched Izod impact improves to 69.4 J/m (Working Example 1D). Where EXL is increased from 3% to 8% (Comparative Example 1D-2) in the absence of the MAH-g-EP(D)M compatibilizer, notched Izod improves to 55.1 J/m. Similarly, an increase of MBS from 3% to 4.25%, notched Izod impact increases to 54.4 J/m (Comparative Example 2D-2).

As the percentage of compatibilizer increases, as does the impact performance. At 2% MAH-g-EP(D)M (Working Example 2D), notched Izod impact improves to 85.8 J/m The increase in EXL or MBS percentages is not as efficient in increasing impact performance to the same extent (Working Example 2D vs. Comparative Example 2D-1 and Comparative Example 2D-2). Notched IZOD impact improves to 64.3 J/m where EXL is increased from 3% to 13% (Comparative Example 2D-1) and to 65.5 J/m where MBS is increased from 3% to 5.5% (Comparative Example 2D-2). The same trend is observed in notched IZOD impact at 0° C. and unnotched IZOD impact at 23° C. and 0° C.

With respect to other properties of the blended polycarbonate composition, FR performance was maintained at V0 at 1.2 mm. Consistent with other example sets, MFR and flexural modulus decrease with the addition of the MAH-g-EP(D)M (Working Examples 1D-2).

TABLE 6

| | | | | | | | | | |
|---|---|---|---|---|---|---|---|---|---|
| Comp | Comp | Work | Comp | Work | Comp | Comp | Work | Comp | Work |
| 1E-1 | 1E-2 | 1E | 2E | 2E | 3E-1 | 3E-2 | 3E | 4E | 4E |

Formulation

| | | | | | | | | | | | | |
|---|---|---|---|---|---|---|---|---|---|---|---|---|
| 1 | PC1 | % | 31.92 | 31.295 | 31.42 | 30.67 | 30.92 | 31.02 | 30.02 | 30.52 | 29.02 | 30.02 |
| 2 | PC2 | % | 31.92 | 31.295 | 31.42 | 30.67 | 30.92 | 31.02 | 30.02 | 30.52 | 29.02 | 30.02 |
| 4 | ADD1 | % | 0.5 | 0.5 | 0.5 | 0.5 | 0.5 | 0.5 | 0.5 | 0.5 | 0.5 | 0.5 |
| 5 | ADD2 | % | 0.5 | 0.5 | 0.5 | 0.5 | 0.5 | 0.5 | 0.5 | 0.5 | 0.5 | 0.5 |
| 6 | ADD3 | % | 0.08 | 0.08 | 0.08 | 0.08 | 0.08 | 0.08 | 0.08 | 0.08 | 0.08 | 0.08 |
| 7 | ADD4 | % | 0.08 | 0.08 | 0.08 | 0.08 | 0.08 | 0.08 | 0.08 | 0.08 | 0.08 | 0.08 |
| 8 | CC6 | % | 0 | 0 | 1 | 0 | 2 | 0 | 0 | 1 | 0 | 2 |
| 9 | IM3 | % | 3 | 4.25 | 3 | 5.5 | 3 | 0 | 0 | 0 | 0 | 0 |
| 10 | F2 | % | 20 | 20 | 20 | 20 | 20 | 20 | 20 | 20 | 20 | 20 |
| 11 | IM4 | % | 0 | 0 | 0 | 0 | 0 | 4.8 | 6.8 | 4.8 | 8.8 | 4.8 |
| 12 | FR | % | 12 | 12 | 12 | 12 | 12 | 12 | 12 | 12 | 12 | 12 |
| | Total | % | 100 | 100 | 100 | 100 | 100 | 100 | 100 | 100 | 100 | 100 |

Properties

| Notched Izod | | J/m | 39.4 | 43 | 60 | 50.3 | 93.8 | 37.1 | 41 | 69.7 | 47.7 | 86.5 |
|---|---|---|---|---|---|---|---|---|---|---|---|---|
| Impact, 23° C. | | | | | | | | | | | | |
| Notched Izod | | % | 0 | 0 | 0 | 0 | 0 | 0 | 0 | 0 | 0 | 0 |
| Impact Ductility, | | | | | | | | | | | | |
| 23° C. | | | | | | | | | | | | |
| Unnotched Izod | | J/m | 733 | 820 | 1740 | 889 | 2130 | 737 | 770 | 1560 | 857 | 2060 |
| Impact, 23° C. | | | | | | | | | | | | |
| Unnotched Izod | | % | 0 | 100 | 100 | 100 | 100 | 0 | 40 | 100 | 100 | 100 |
| Impact Ductility, | | | | | | | | | | | | |
| 23° C. | | | | | | | | | | | | |
| Unnotched Izod | | J/m | 661 | 719 | 1120 | 777 | 1590 | 666 | 663 | 1090 | 677 | 1310 |
| Impact, 0° C. | | | | | | | | | | | | |
| Unnotched Izod | | % | 0 | 0 | 20 | 0 | 100 | 0 | 0 | 0 | 0 | 60 |
| Impact Ductility, | | | | | | | | | | | | |
| 0° C. | | | | | | | | | | | | |
| MAI, Energy, | | J | 37.7 | 37 | 27.3 | 56.4 | 51.6 | 33.1 | 41.3 | 46.9 | 26.7 | 48.1 |
| Total-Avg, 23° C. | | | | | | | | | | | | |
| MAI Ductility, | | % | 20 | 20 | 40 | 100 | 100 | 0 | 20 | 20 | 0 | 80 |
| 23° C. | | | | | | | | | | | | |
| Flexural Modulus- | | MPa | 5160 | 4750 | 4310 | 4960 | 3810 | 5100 | 4920 | 4620 | 4760 | 4070 |
| Avg | | | | | | | | | | | | |
| Flexural Stress at | | MPa | 109 | 98.4 | 101 | 104 | 94.6 | 108 | 104 | 99.5 | 100 | 94.7 |
| Yield-Avg | | | | | | | | | | | | |
| Tens. Stress at | | MPa | 64.4 | 58.8 | 58.8 | 60.9 | 55 | 64.3 | 61.3 | 58 | 59.6 | 54.7 |
| Yield-Avg | | | | | | | | | | | | |
| Tens. Elongation at | | % | 8.91 | 5.91 | 10.81 | 8.42 | 11.47 | 6.48 | 7.16 | 10.29 | 6.03 | 12.93 |
| Break-Avg | | | | | | | | | | | | |
| Tens. Elongation at | | % | 2.94 | 2.77 | 3.16 | 2.8 | 3.27 | 2.83 | 2.77 | 3.03 | 2.69 | 3.18 |
| yld-Avg | | | | | | | | | | | | |
| MFR-Avg (260° C./ | | g/10 min | 15.6 | 13.1 | 9.07 | 11.8 | 7.59 | 12.5 | 9.72 | 8.37 | 9.02 | 7.88 |
| 2.16 kg/300 s) | | | | | | | | | | | | |
| HDT, 1.82 MPa/ | | ° C. | 85.2 | 84.2 | 83.9 | 83.9 | 82.7 | 84.7 | 84.2 | 83.1 | 83.4 | 81.8 |
| 3.2 mm | | | | | | | | | | | | |
| V0 @ | FOT2 | s | 2.34 | 2.68 | 1.9 | 3.45 | 2.15 | 2.7 | 4.27 | 2.24 | 4.15 | 2.14 |
| 1.2 mm | pFTP | | 1 | 1 | 1 | 1 | 1 | 1 | 1 | 1 | 1 | 1 |
| | Drip | | 0 | 0 | 0 | 0 | 0 | 0 | 0 | 0 | 0 | 0 |

### Example Set E

Examples were prepared to further evaluate the mechanical properties and FR performance at different MAH compatibilizer amounts and with different impact modifiers, MBS and ABS. The formulations of the prepared blended polycarbonate compositions are shown in Table 6. The performance properties evaluated for the blended polycarbonate compositions are also shown in Table 6. The impact modifiers MBS or ABS are used independently. The addition of MAH-g-EP(D)M compatibilizer improves impact performance in the blended polycarbonate composition to a greater extent than an identical composition having impact modifiers MBS or ABS and in the absence of MAH compatibilizer.

Without MAH-g-EP(D)M (Comparative Example 1E-1), notched Izod impact at 23° C. is 39.4 J/m. At 1% MAH compatibilizer, notched impact improves to 60 J/m (Working Example 1E). Where MBS is increased from 3% to 4.25%, notched Izod impact improves slightly to 43 J/m (Comparative Example 1E-2). At 2% MAH compatibilizer (Working Example 2E) adding composition, notched Izod increases to 93.8 J/m. Where MBS is increased from 3% to 5.5%, notched Izod impact improves to 50.3 J/m (Comparative Example 2E).

The results indicate a similar trend for unnotched Izod impact at 23° C. and 0° C. At 1% or 2% MAH-g-EP(D)M compatibilizer (Working Examples 1E-4E), unnotched Izod impact also increase.

Without MAH-g-EP(D)M (Comparative Example 3E-1), notched Izod impact at 23° C. is 37.1 J/m. With 1% MAH-g-EP(D)M loading (Working Example 3E), notched IZOD impact is improved to 69.7 J/m. However, the notched Izod impact improves to 41 J/m if MBS loading increases from 4.8% to 6.8% (Comparative Example 3E-2). At 2% MAH-g-EP(D)M (Working Example 4E), notched Izod impact improves to 86.5 J/m. Where impact modifier ABS increases from 4.8% to 8.8%, notched Izod impact improves to 47.7 J/m (Comparative Example 4E). Results for unnotched Izod impact at 23° C. and 0° C. also demonstrate similar improvements for the blended polycarbonate composition at 1% or 2% MAH-g-EP(D)M. Overall, these results show that the extent of improvement achieved through the addition and loading of the MAH-g-EP(D)M is greater than that achieved with significant increases in MBS or ABS addition. Furthermore, with respect to ABS addition, increases in MAH-g-EP(D)M produces greater improvements in ductility percentage and ductility/brittle transition temperature than an identical composition having an increased amount of ABS in the absence of the MAH compatibilizer (Working Examples 3E and 4E vs. Comparative Examples 3E-2 and 4E)

FR performance of MAH-g-EP(D)M samples is higher than MBS and ABS samples as well The average flame time of the MAH-g-EP(D)M is shorter than that of the MBS sample. Consistent with all results, MFR and flexural modulus decrease with the addition of MAH-g-EP(D)M. The tolerance depends upon the application.

TABLE 7

| | | | | | | |
|---|---|---|---|---|---|---|
| Unit | Comp 1F | Work 1F | Comp 2F | Work 2F | Comp 3F | Work 3F |

Formulation

| | | | | | | | | |
|---|---|---|---|---|---|---|---|---|
| 1 | PC1 | % | 36.62 | 35.62 | 36.62 | 35.62 | 36.62 | 35.62 |
| 2 | PC2 | % | 36.62 | 35562 | 36.62 | 35.62 | 36.62 | 35.62 |
| 3 | PC4 | % | 3 | 3 | 3 | 3 | 3 | 3 |
| 4 | IM1 | % | 2.5 | 2.5 | 2.5 | 2.5 | 2.5 | 2.5 |
| 5 | F3 | % | 10 | 10 | | | | |
| 6 | F4 | % | | | 10 | 10 | | |
| 7 | F5 | % | | | | | 10 | 10 |
| 8 | ADD1 | % | 0.5 | 0.5 | 0.5 | 0.5 | 0.5 | 0.5 |
| 9 | ADD2 | % | 0.2 | 0.2 | 0.2 | 0.2 | 0.2 | 0.2 |
| 10 | ADD3 | % | 0.08 | 0.08 | 0.08 | 0.08 | 0.08 | 0.08 |
| 11 | ADD4 | % | 0.08 | 0.08 | 0.08 | 0.08 | 0.08 | 0.08 |
| 12 | CC6 | % | 0 | 2 | 0 | 2 | 0 | 2 |
| 13 | FR | % | 10.4 | 10.4 | 10.4 | 10.4 | 10.4 | 10.4 |
| | Total | % | 100 | 100 | 100 | 100 | 100 | 100 |

Properties

| Notched Izod Impact, 23° C. | | J/m | 81.8 | 188 | 92.4 | 199 | 87.6 | 165 |
|---|---|---|---|---|---|---|---|---|
| Notched Izod Impact Ductility, 23° C. | | % | 0 | 100 | 0 | 100 | 0 | 100 |
| Notched Izod Impact, 0° C. | | J/m | 66.5 | 88.9 | 56.6 | 96.3 | 73.8 | 95 |
| Notched Izod Impact Ductility, 0° C. | | % | 0 | 0 | 0 | 0 | 0 | 0 |
| Unnotched Izod Impact, 23° C. | | J/m | 1170 | 1490 | 451 | 959 | 541 | 735 |
| Unnotched Izod Impact Ductility, | | % | 100 | 100 | 100 | 100 | 0 | 100 |
| 23° C. | | | | | | | | |
| Tens. Stress at Yield-Avg | | MPa | 57.8 | 52.5 | 0 | 52.6 | 0 | 55.5 |
| Tens. Elongation at Break-Avg | | % | 8.25 | 9.56 | 2.69 | 8.24 | 2.95 | 6.53 |
| Flexural Modulus-Avg | | MPa | 3920 | 3400 | 4220 | 3490 | 4160 | 3540 |
| Flexural Stress at Yield-Avg | | MPa | 99.3 | 90.5 | 119 | 89.3 | 126 | 92.7 |
| HDT, 1.82 MPa/6.4 mm | | ° C. | 101 | 97.5 | 103 | 97.4 | 103 | 98.6 |
| MFR-Avg (260° C./2.16 kg/300 s) | | g/10 min | 11 | 9.82 | 10.8 | 8.67 | 10.4 | 9 |
| App. viscosity-Avg (260° C., 1500 s⁻¹) | | Pa · s | 307.1 | 280.8 | 299 | 274.3 | 314.2 | 278 |
| V0 @ 1.0 mm | FOT2 | s | 2.8 | 4.52 | 3.98 | 5.72 | 4.88 | 4.14 |
| | pFTP | | 1 | 0.9901 | 1 | 0.7450 | 0.7941 | 0.9924 |
| | Drip | | 0 | 0 | 0 | 0 | 0 | 0 |

### Example Set F

Additional formulations were prepared to demonstrate the properties of glass fiber filled polycarbonate compositions with and without MAH-grafting copolymer compatibilizer. Table 7 shows the mechanical properties and FR performance with and without MAH-g-EP(D)M in glass fiber filled PC compositions. BPADP was loaded to achieve V0 UL listing. Different types of glass fibers were loaded to achieve a high modulus. EXL and S-2001 combination were used as impact modifiers.

In 415A-14C type glass fiber filled PC composition, without MAH-g-EP(D)M (Comparative Example 1F), notched Izod impact at 23° C. is 81.8 J/m and totally brittle failure type. With 2% MAH-g-EP(D)M loading (Working Example 1F), notched Izod impact was improved to 188 J/m and 100% ductile failure type. Other toughness index, NII at 0° C., Unnotched IZOD impact at 23° C. and tensile elongation at break were also improved.

In CSG 3PA-820 flat type glass strand filled PC composition, without MAH-g-EP(D)M (Comparative Example 2F), notched Izod impact at 23° C. is 92.4 J/m and totally brittle failure type. With 2% MAH-g-EP(D)M loading (Working Example 2F), notched Izod impact was improved to 199 J/m and 100% ductile failure type. Other toughness index, NII at 0° C., Unnotched Izod impact at 23° C. and tensile elongation at break were also improved.

In CSG 3PA-830 flat type glass strand filled PC composition, without MAH-g-EP(D)M (Comparative Example 3F), notched Izod impact at 23° C. is 87.6 J/m and totally brittle failure type. With 2% MAH-g-EP(D)M loading (Working Example 3F), notched Izod impact was improved to 165 J/m and 100% ductile failure type. Other toughness index, NII at 0° C., Unnotched Izod impact at 23° C. and tensile elongation at break were also improved.

MFR dropped with MAH-g-EP(D)M introduction, which is similar with the behavior in talc filled PC blends. However, the melt viscosity at shear rate 1500 s⁻¹ also decreased, which is different from the behavior in talc filled PC composition. The indicated that MAH-g-EP(D)M can improve the actual flowability in molding (usually at high shear rate) while improving the impact.

TABLE 8

| | | | | |
|---|---|---|---|---|
| Unit | Comp 1G | Work 1G | Comp 2G | Work 2G |

Formulation

| | | | | | | |
|---|---|---|---|---|---|---|
| 1 | PEs1 | % | 50.5 | 50.5 | 50.5 | 50.5 |
| 2 | PC3 | % | 39.05 | 37.05 | 35.05 | 33.05 |
| 3 | IM5 | % | 0 | 0 | 4 | 4 |
| 4 | F3 | % | 10 | 10 | 10 | 10 |
| 5 | ADD5 | % | 0.3 | 0.3 | 0.3 | 0.3 |
| 6 | ADD3 | % | 0.1 | 0.1 | 0.1 | 0.1 |
| 7 | ADD4 | % | 0.05 | 0.05 | 0.05 | 0.05 |
| 8 | CC7 | % | 0 | 2 | 0 | 2 |
| | Total | % | 100 | 100 | 100 | 100 |

Properties

| | | | | | |
|---|---|---|---|---|---|
| Notched Izod Impact, 23° C. | J/m | 40.2 | 71.2 | 64.6 | 109 |
| Notched Izod Impact Ductility, 23° C. | % | 0 | 0 | 0 | 0 |
| Unnotched Izod Impact, 23° C. | J/m | 1080 | 1790 | 602 | 2170 |
| Unnotched Izod Impact Ductility, 23° C. | % | 20 | 100 | 0 | 100 |
| Tens. Stress at Yield-Avg | MPa | 59.1 | 49.7 | 59.6 | 48.5 |
| Tens. Elongation at Break-Avg | % | 5.58 | 18.61 | 3.21 | 10.19 |
| Flexural Modulus-Avg | MPa | 3700 | 3440 | 3480 | 3260 |
| Flexural Stress at Yield-Avg | MPa | 97.5 | 83.5 | 93.2 | 78.3 |
| HDT, 1.82 MPa/3.2 mm | ° C. | 112 | 85.3 | 99.8 | 81.6 |
| MFR-Avg (265° C./2.16 kg/300 s) | g/10 min | 7.23 | 6.77 | 5.16 | 5.27 |
| App. viscosity-Avg (265° C., 1500 s⁻¹) | Pa · s | 309 | 228.6 | 323.9 | 266.8 |

### Example Set G

Table 8 shows the mechanical properties with and without MAH-g-EP(D)M in glass fiber filled PBT/PC compositions. In an aspect, 10% glass fibers were loaded to achieve a high modulus. MAH-g-EP(D)M was used as the sole impact modifier in Comparative Example 1G and Working Example 1G, or in some cases, acrylate EXL3330 from DOW was also used as impact modifier in Comparative Example 2G and Working Example 2G.

In Comparative Example 1G and Working Example 1G formulations, there is not any other impact modifier. Without MAH-g-EP(D)M (Comparative Example 1G), notched Izod impact at 23° C. is 40.2 J/m. With 2% MAH-g-EP(D)M loading (Working Example 1G), notched Izod impact was improved to 71.2 J/m. Without MAH-g-EP(D)M (Comparative Example 1G), unnotched Izod impact at 23° C. is 1080 J/m and 20% ductility. With 2% MAH-g-EP(D)M loading (Working Example 1G), notched Izod impact was improved to 1790 J/m and 100% ductility.

In Comparative Example 2G and Working Example 2G formulations, EXL3330 was added as impact modifier. Without MAH-g-EP(D)M (Comparative Example 2G), notched Izod impact at 23° C. is 64.6 J/m. With 2% MAH-g-EP(D)M loading (Working Example 2G), notched Izod impact was improved to 109 J/m. Without MAH-g-EP(D)M (Comparative Example 2G), unnotched Izod impact at 23° C. is 602 J/m and 0% ductility. With 2% MAH-g-EP(D)M loading (Working Example 2G), notched Izod impact was improved to 2170 J/m and 100% ductility.

In PBT/PC blends, modulus is maintained as compared to the results in PC composition. Using this technology, one would expect to achieve PBT or PBT/PC materials with improved impact while maintaining modulus and flow.

Table 8 shows the examples without any FR, which indicated that the technology worked in non-FR polyester and/or polycarbonate compositions.

TABLE 9

| | | | | | | |
|---|---|---|---|---|---|---|
| Unit | Comp 1H | Work 1H | Comp 2H | Work 2H | Comp 3H | Work 3H |

Formulation

| | | | | | | | | |
|---|---|---|---|---|---|---|---|---|
| 1 | PC1 | % | 36.62 | 35.62 | 36.62 | 35.62 | 31.62 | 30.62 |
| 2 | PC2 | % | 36.62 | 35.62 | 36.62 | 35.62 | 21.62 | 20.62 |
| 3 | PC4 | % | 3 | 3 | 3 | 3 | 3 | 3 |
| 4 | PEs2 | % | | | | | 15 | 15 |
| 5 | IM1 | % | 2.5 | 2.5 | 2.5 | 2.5 | 2.5 | 2.5 |
| 6 | F1 | % | | | 10 | 10 | 15 | 15 |
| 7 | F6 | % | 20 | 20 | 10 | 10 | | |
| 8 | ADD1 | % | 0.5 | 0.5 | 0.5 | 0.5 | 0.5 | 0.5 |
| 9 | ADD2 | % | 0.2 | 0.2 | 0.2 | 0.2 | 0.2 | 0.2 |
| 10 | ADD3 | % | 0.08 | 0.08 | 0.08 | 0.08 | 0.08 | 0.08 |
| 11 | ADD4 | % | 0.08 | 0.08 | 0.08 | 0.08 | 0.08 | 0.08 |
| 12 | CC7 | % | 0 | 2 | 0 | 2 | 0 | 2 |
| 13 | FR | % | 10.4 | 10.4 | 10.4 | 10.4 | 10.4 | 10.4 |
| | Total | % | 100 | 100 | 100 | 100 | 100 | 100 |

Properties

| Notched Izod Impact, 23° C. | | J/m | 72.6 | 234 | 61 | 244 | 48 | 82.9 |
|---|---|---|---|---|---|---|---|---|
| Notched Izod Impact | | % | 0 | 100 | 0 | 100 | 0 | 0 |
| Ductility, 23° C. | | | | | | | | |
| Notched Izod Impact, 0° C. | | J/m | 59.8 | 107 | 57.1 | 116 | 43.5 | 68.3 |
| Notched Izod Impact | | % | 0 | 0 | 0 | 0 | 0 | 0 |
| Ductility, 0° C. | | | | | | | | |
| Unnotched Izod Impact, 23° C. | | J/m | 1220 | 1440 | 1070 | 2010 | 1280 | 2060 |
| Unnotched Izod Impact | | % | 100 | 100 | 100 | 100 | 40 | 100 |
| Ductility, 23° C. | | | | | | | | |
| Unnotched Izod Impact, 0° C., | | J/m | 924 | 1170 | 762 | 1400 | 1180 | 1770 |
| Unnotched Izod Impact | | % | 0 | 80 | 0 | 100 | 0 | 60 |
| Ductility, 0° C. | | | | | | | | |
| Tens. Stress at Yield-Avg | | MPa | 58 | 51.6 | 60.7 | 53.5 | 61.9 | 54.9 |
| Tens. Elongation at Break- | | % | 7.19 | 23 | 7.61 | 13.76 | 5.9 | 22.32 |
| Avg | | | | | | | | |
| Flexural Modulus-Avg | | MPa | 4000 | 3390 | 4740 | 3850 | 4270 | 3730 |
| Flexural Stress at Yield-Avg | | MPa | 99.4 | 87.7 | 104 | 90.4 | 103 | 92.5 |
| HDT, 1.82 MPa/3.2 mm | | ° C. | 86.4 | 84.2 | 89.7 | 86.7 | 84.1 | 80.8 |
| MFR-Avg (260° C./2.16 kg/ | | g/10 min | 11.1 | 8.04 | 7.59 | 6.53 | 13.9 | 10.4 |
| 300 s) | | | | | | | | |
| App. viscosity-Avg (260° C., | | Pa · s | 225.6 | 223.7 | 258.2 | 235.4 | 195.6 | 168 |
| 1500 s⁻¹) | | | | | | | | |
| V0 @ 1.5 mm | FOT2 | s | 1.28 | 2.27 | 1.36 | 1.42 | 1.61 | 2.08 |
| | pFTP | | 1 | 0.9761 | 1 | 1 | 0 | 0.9994 |
| | Drip | | 0 | 0 | 0 | 0 | 0 | 0 |

### Example Set H

Table 9 shows the mechanical properties with and without MAH-g-EP(D)M in clay, clay and talc combination filled PC composition, and talc filled PC/PET composition.

In 20% clay filled PC composition without MAH-g-EP(D)M (Comparative Example 1H), notched Izod impact at 23° C. is 72.6 J/m and total brittle failure type. With 2% MAH-g-EP(D)M loading (Working Example 1H), notched Izod impact was improved to 234 J/m and 100% ductile failure type. Other toughness index, NII at 0° C., Unnotched Izod impact at 23° C. and tensile elongation at break were also improved.

In 10% clay and 10% fine talc combination filled PC composition without MAH-g-EP(D)M (Comparative Example 2H), notched Izod impact at 23° C. is 61 J/m and total brittle failure type. With 2% MAH-g-EP(D)M loading (Working Example 2H), notched Izod impact was improved to 244 J/m and 100% ductile failure type. Other toughness index, NII at 0° C., Unnotched Izod impact at 23° C. and tensile elongation at break were also improved.

In 15% fine talc filled PC/PET composition without MAH-g-EP(D)M (Comparative Example 3H), notched Izod impact at 23° C. is 48 J/m. With 2% MAH-g-EP(D)M loading (Working Example 3H), notched Izod impact was improved to 82.9 J/m. Without MAH-g-EP(D)M (Comparative Example 3H), unnotched Izod impact at 23° C. is 1280 J/m and 40% ductility. With 2% MAH-g-EP(D)M loading (Working Example 3H), unnotched Izod impact was improved to 2060 J/m and 100% ductility. Other toughness index, NII at 0° C., Unnotched IZOD impact at 23° C. and tensile elongation at break were also improved.

TABLE 10

| | | | | |
|---|---|---|---|---|
| Unit | Comp 1I | Work 1I | Comp 2I | Work 2I |

Formulation

| | | | | | | |
|---|---|---|---|---|---|---|
| 1 | PC1 | % | 37.82 | 36.82 | 24.57 | 23.57 |
| 2 | PC2 | % | 37.82 | 36.82 | 24.57 | 23.57 |
| 3 | ADD2 | % | 0.2 | 0.2 | 0.2 | 0.2 |
| 4 | ADD3 | % | 0.08 | 0.08 | 0.08 | 0.08 |
| 5 | ADD4 | % | 0.08 | 0.08 | 0.08 | 0.08 |
| 6 | IM1 | % | | | 2.5 | 2.5 |
| 7 | PC4 | % | | | 8 | 8 |
| 8 | IM5 | % | 4 | 4 | | |
| 9 | CC6 | % | | 2 | | 2 |
| 10 | F4 | % | 20 | 20 | 40 | 40 |

| | | | | | |
|---|---|---|---|---|---|
| Formulation Total | % | 100 | 100 | 100 | 100 |

Properties

| | | | | | |
|---|---|---|---|---|---|
| Flexural Modulus-Avg | MPa | 5490 | 4540 | 9790 | 5930 |
| Flexural Stress at Yield-Avg | MPa | 130 | 75.6 | 156 | 65 |
| HDT, 1.82 MPa/6.4 mm | ° C. | 137 | 131 | 138 | 129 |
| Notched Izod Impact, 23° C. | J/m | 125 | 266 | 114 | 157 |
| Notched Izod Impact Ductility, 23° C. | % | 0 | 100 | 0 | 0 |
| Notched Izod Impact, 0° C. | J/m | 103 | 213 | 108 | 121 |
| Notched Izod Impact Ductility, 0° C. | % | 0 | 100 | 0 | 40 |
| Unnotched Izod Impact, 23° C. | J/m | 565 | 833 | 337 | 370 |
| Unnotched Izod Impact Ductility, 23° C. | % | 0 | 100 | 0 | 100 |
| Tens. Stress at Yield-Avg | MPa | 0 | 40.8 | 0 | 32.9 |
| Tens. Elongation at Break-Avg | % | 2.6 | 10.86 | 1.59 | 6.14 |
| MFR-Avg (260° C./2.16 kg) | g/10 min | 5.18 | 3.1 | 2.79 | 2.16 |
| App. viscosity-Avg (260° C. 1500 s⁻¹) | Pa · s | 550 | 488.4 | 673 | 482.9 |

### Example Set I

Table 10 illustrates example formulations with higher glass fiber loading, as well as, mechanical properties and FR performance for such formulations.

In 20% GF filled PC composition with acrylate type impact modifier and without MAH-g-EP(D)M (Comparative Example 1I), notched Izod impact at 23° C. is 125 J/m and total brittle failure type. With 2% MAH-g-EP(D)M loading (Working Example 1I), notched Izod impact was improved to 266 J/m and 100% ductile failure type. Other toughness index, NII at 0° C., Unnotched IZOD impact at 23° C. and tensile elongation at break were also improved greatly.

In 40% GF filled PC composition with S-2001 as impact modifier and without MAH-g-EP(D)M (Comparative Example 21), notched Izod impact at 23° C. is 114 J/m. With 2% MAH-g-EP(D)M loading (Working Example 21), notched Izod impact was improved to 157 J/m. Other toughness index, NII at 0° C., Unnotched IZOD impact at 23° C. and tensile elongation at break were also improved greatly.

The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A blended polymer composition with improved impact performance, comprising:
a) a polymer component comprising from about 0.1 wt. % to about 90 wt. % of a polycarbonate or from about 0.1 wt. % to about 90 wt. % of a polyester, or a combination of both;
b) a filler component present in an amount ranging from about 2 wt. % to about 50 wt. % of;
c) an impact modifier present in an amount ranging from about 0.5 wt. % to about 25 wt. %; and
d) a polymer compatibilizer comprising a polyolefin functionalized with maleic anhydride, the polymer compatibilizer present in an amount ranging from about 0.5 wt. % to about 8 wt. %;
wherein the combined weight percent value of all components does not exceed about 100 wt. %, wherein all weight percent values are based on the total weight of the composition; and
wherein the blended polymer composition exhibits greater impact performance compared to a reference composition consisting essentially of substantially the same proportions of the same polymer component, the same filler component, and the same impact modifier, in the absence of the polymer compatibilizer component.

2. The blended polymer composition of claim 1, wherein the polymer component comprises from about 3 wt. % to about 77 wt. % of a polycarbonate.

3. The blended polymer composition of claim 1, wherein the polymer component comprises from about 15 wt. % to about 90 wt. % of a polyester.

4. The blended polymer composition of claim 1, wherein the polymer component comprises a bisphenol A polycarbonate polymer.

5. The blended polymer composition of claim 1, wherein the polymer component comprises at least two different bisphenol A polycarbonate polymers.

6. The blended polymer composition of claim 1, wherein the polymer component comprises a polyester carbonate polymer.

7. The blended polymer composition of claim 1, wherein the polycarbonate component is present and comprises a polycarbonate-polysiloxane copolymer.

8. The blended polymer composition of claim 1, further comprising a flame retardant present in an amount ranging from greater than 0 wt. % to about 25 wt. %.

9. The blended polymer composition of claim 8, wherein the flame retardant comprises an organic compound comprising phosphorous.

10. The blended polymer composition of claim 8, wherein the flame retardant is present and comprises a halogen containing compound.

11. The blended polymer composition of claim 1, wherein the filler component comprises an inorganic compound.

12. The blended polymer composition of claim 1, further comprising stabilizer additives in an amount in the range from greater than 0 wt. % to about 1.5 wt. %.

13. The blended polymer composition of claim 12, wherein the stabilizer additives comprise antioxidants, heat stabilizers, UV stabilizers, or a combination thereof.

14. The blended polymer composition of claim 1, wherein the impact modifier component comprises elastomer-modified graft copolymers.

15. The blended polymer composition of claim 14, wherein the impact modifier component comprises one or more of an acrylonitrile-butadiene-styrene polymer component, a methyl methacrylate-butadiene-styrene component, a methyl methacrylate-butadiene-styrene polymer component, a bulk polymerized acrylonitrile-butadiene-styrene polymer, a styrene-acrylonitrile copolymer, a styrene acrylonitrile grafted acrylonitrile-butadiene-styrene component, or any combination thereof.

16. The blended polymer composition of claim 14, wherein the impact modifier component comprises one or more of the styrene acrylonitrile grafted acrylonitrile-butadiene-styrene component, the methyl acrylate butadiene styrene component, or the styrene-acrylonitrile copolymer.

17. The blended polymer composition of claim 1, wherein the polymer compatibilizer comprises functionalized polyolefins.

18. The blended polymer composition of claim 17, wherein the polymer compatibilizer comprises glycidyl group grafting polyolefin polymer.

19. The blended polymer composition of claim 17, wherein the polymer compatibilizer comprises maleic anhydride grafting polyethylene copolymer.

20. The blended polymer composition of claim 19, wherein the maleic anhydride grafting polyethylene copolymer comprises ethylene-propylene polymer, ethylene-propylene-diene terpolymer, ethylene-octene copolymer, ethylene-butene copolymer, or a styrene-ethylene/butadiene-styrene copolymer.

21. The blended polymer composition of claim 1, wherein the blended polycarbonate composition exhibits a notched Izod impact that is greater than that of an identical reference polymer blend composition in the absence of the polymer compatibilizer.

22. An article made from the blended polymer composition of claim 1.

23. A method comprising generating a mixture by blending together:
a) a polymer component comprising from about 0.1 wt. % to about 90 wt. % of a polycarbonate or from about 0.1 wt. % to about 90 wt. % of a polyester, or a combination of both;
b) a filler component present in an amount ranging from about 2 wt. % to about 50 wt. % of;
c) an impact modifier component present in an amount ranging from about 0.5 wt. % to about 25 wt. %; and
d) a polymer compatibilizer component comprising a polyolefin functionalized with maleic anhydride, the polymer compatibilizer component present in an amount ranging from about 0.5 wt. % to about 8 wt. %;
wherein the combined weight percent value of all components does not exceed about 100 wt. %, wherein all weight percent values are based on the total weight of the mixture; and
wherein the mixture exhibits greater impact performance compared to a reference composition consisting essentially of substantially the same proportions of the same polymer component, the same filler component, and the same impact modifier, in the absence of the polymer compatibilizer component.

24. The method of claim 23, further comprising blending stabilizer additives into the mixture.

25. The method of claim 24, wherein the stabilizer additives comprise heat and UV stabilizers.

26. The method of claim 23, further comprising blending anti-drip agents into the mixture.

27. The method of claim 26, wherein the anti-drip agents comprise fibrile-forming or non-fibril-forming compounds.

28. The method of claim 26, wherein the anti-drip agents comprise styrene-acrylonitrile copolymer.

29. (canceled)

30. The method of claim 23, wherein at least one of the components is blended into the mixture during an extrusion process.

31. The blended polymer composition of claim 1, wherein the polyolefin functionalized with maleic anhydride comprises a high maleic anhydride content.

32. The blended polymer composition of claim 1, wherein the polyolefin functionalized with maleic anhydride comprises a maleic anhydride content of about 0.5-1 wt. % and wherein the composition exhibits at least about a 65% greater impact performance compared to a reference composition consisting essentially of substantially the same proportions of the same polymer component, the same filler component, and the same impact modifier, but with a polyolefin functionalized with maleic anhydride comprising a lower maleic anhydride content.

33. The method of claim 23, wherein the polyolefin functionalized with maleic anhydride comprises a high maleic anhydride content.

34. The method of claim 23, wherein the polyolefin functionalized with maleic anhydride comprises a maleic anhydride content of about 0.5-1 wt. % and wherein the composition exhibits at least about a 65% greater impact performance compared to a reference composition consisting essentially of substantially the same proportions of the same polymer component, the same filler component, and the same impact modifier, but with a polyolefin functionalized with maleic anhydride comprising a lower maleic anhydride content.
